(19) United States
(12) Patent Application Publication
(10) Pub. No.: US 2019/0057354 A1
(43) Pub. Date: Feb. 21, 2019

(54) LABOR MANAGEMENT SYSTEM

(71) Applicant: Mark E. McKenzie, Bakersfield, CA (US)

(72) Inventor: Mark E. McKenzie, Bakersfield, CA (US)

(21) Appl. No.: 16/101,292

(22) Filed: Aug. 10, 2018

Related U.S. Application Data
(60) Provisional application No. 62/546,625, filed on Aug. 17, 2017.

(51) Int. Cl. G06Q 10/10; G06Q 10/06; G06Q 50/08

(52) U.S. Cl. CPC G06Q 10/103; G06Q 50/08; G06Q 10/06311

(57) ABSTRACT

Disclosed is a system designed to improve construction crew safety, quality, productivity, planning effectiveness and scheduling reliability. A back office system facilitates short interval planning, constraint removal, hazard identification and mitigation, and field crew labor performance reporting. The work package centric system will accommodate the smallest of organizations and projects, yet is scalable to meet the requirements of very large construction companies that execute complex, mega projects. Dashboards and reports can be customized by individual and the role they play within the organization. A frontline system has dynamic user interface graphics that displays crew performance for the tasks being executed that, combined, constitute a work package. The frontline system simplifies the reporting typically required by a frontline supervisor and encourages compliance with an interesting, easy to use interface. Among other features and functions, the system introduces a measurement that enables a game-like ranking of company frontline supervisor performance.

### RELATED APPLICATIONS

This application claims the benefit of priority to U.S. Provisional Patent Application Ser. No. 62/546,625, filed Aug. 17, 2017, currently co-pending, and fully incorporated herein by this reference.

### BACKGROUND OF THE INVENTION

Frontline supervisors exist in many industries, including the construction industry, and are primarily responsible for monitoring and directing the activities of a crew to ensure the construction activities of the crew are accomplished properly, timely, and safely. Too often in the construction industry, craft persons are promoted to a leadership role as a frontline supervisor without having the necessary skills to effectively manage the work and deal with the challenges associated with the position. On a daily basis, these men and women are asked to marshal and manage resources, meet safety, environmental, quality, productivity, and schedule requirements in an extremely dynamic environment.

In addition, these frontline supervisors are required to motivate their crews, deal with employee and customer issues, manage an ever-increasing amount of paperwork, while being asked to protect the company's interests. With a scarcity of skilled craft persons, and the situation predicted to worsen, having competent field supervisors is critical. With the tremendous responsibility placed on these individuals, their development should be a key component of any construction company's risk management plan.

The $1.5 trillion dollar U.S. construction industry is plagued with poor productivity. Over the last 30 years construction productivity has declined. The optimization of efficient, effective planning process and tools, along with strong leadership skills, can dramatically reverse this trend.

Productivity loss can result from a wide variety of common problems on a construction site, including idle time, rework time, and crew inefficiency. Idle time often results from crews simply waiting for material, equipment, tools, or direction on how to proceed. Idle work also can result from safety issues causing temporary work shut downs. Rework time results from the crew having to spend time correcting mistakes made by the crew or others, such as the designers of the project. Productivity is also often lost as a result of damages inflicted on preexisting structures. Often productivity is lost simply because the crew is not working efficiently.

With labor cost accounting for approximately 35% of the $1.5 trillion U.S. construction industry, this productivity loss is costing end users in the range of $180 billion-$260 billion annually. The leading contributing factors of poor construction productivity include, delays in engineering deliverables, engineering errors and omissions, scope growth and associated schedule compression, poor planning and scheduling at the front end and at the work face, poor material management, a disconnect between management and what is occurring in the field (poor communication, lack of collaboration), and lack of qualified field frontline supervisors.

The frontline supervisor, supported by the right planning processes and tools, combined with effective leadership development can greatly reduce the impact of these conditions. Frontline supervisors can have the single largest impact on a construction organization. A good (or bad) frontline supervisor affects employee performance and satisfaction, safety, quality, productivity, turnover, and the overall health of any organization.

The reason frontline supervisors play such a crucial role in the well-being of an organization is that they are the ones who interact daily with the people that do the work. If quality work completed safely, on time and on budget are the goals, the people doing the work must be motivated along those lines. Frontline supervisors have the most influence over employee morale, engagement, and performance.

Construction frontline supervisors are often promoted to their positions because they were a good producer or individual contributor. These “battle field” promotions are oftentimes based on the individual's knowledge or technical skills. For these valuable folks to be effective leaders, new tools are required. The risk of loss related to safety incidents, poor quality resulting in rework, low productivity, schedule slippages, disgruntled employees, and dissatisfied customers are too great.

Construction software systems exist to help reduce some of the above noted problems, however, they are not designed to directly benefit and improve the work product of the frontline supervisor. Existing construction management systems provide no incentivization to the frontline supervisor to utilize the existing software to its full potential, if at all. Moreover, existing construction management software systems fail to provide simple real time and easy to follow metrics to enable the frontline supervisor to track his or her performance on the task at hand.

Similarly, existing construction software systems fail to provide real time data on the performance of individual frontline supervisors or history data on the long-term performance of an individual frontline supervisor over the course of multiple projects. Given the importance of the frontline supervisor to the successful, timely and safe completion of construction activities, it is important for upper management of a construction company to be able to quickly and easily evaluate the current and long-term performance of the various frontline supervisors employed with the company. Current construction management software systems fail to provide any such metrics for use by upper management or other company executives who are often removed from the physical location of construction activities.

Thus, there is a need for a construction software management system that has both back office and frontline dashboards that provide real time data on the progress, timeliness, and efficiency of a project. There is a further need for a construction software management software that organizes a construction project in order to maximize construction productivity and provides real time and long-term productivity data. There is a further need for a construction software management system that incentivizes frontline supervisors to fully engage with the construction software management system. There is a further need for a construction software management system that tracks multiple performance metrics of the frontline supervisors and ranks the frontline supervisors for the benefit of upper company management.

### SUMMARY OF THE INVENTION

The present invention overcomes the problems of the prior art through a construction software management system focused on maximizing the performance, productivity and participation of the frontline supervisors and the crews they supervise. The present invention further overcomes the prior art by providing real time data on the progress, timeliness, efficiency and productivity of the construction of a project both to the frontline supervisors on the project as well as to the project manager, project planners and other corporate executives. The present invention further overcomes the prior art through use of game like graphical interfaces that encourage the full participation of the frontline supervisor using the TLMS system. The TLMS system stores this data and ranks the performance of the company frontline supervisors to enable upper company management to immediately identify high quality frontline supervisors as well as those frontline supervisors that are underperforming.

More specifically, the present invention is directed at a TLMS system that includes a mobile software application with back-end functionality and requisite hardware. The TLMS system facilitates the detailed planning and organization of a project and the communication of that detailed planning and organization to the frontline supervisor in order to maximize the performance of the frontline supervisor.

The TLMS system has a back office system, a frontline system and a central computer system that are each in digital communication with one another. The back office system is designed primarily for use in a physical office environment during system setup and configuration and project planning performed by administrator users, project planner users, and project manager users. The frontline system is designed primarily for use by frontline supervisor users in the field during actual project construction.

The back office system is divided into setup and configuration and project planning. The setup and configuration is not project specific, and enables a high level administrator user, such as a company owner, corporate officer, or manager to setup the TLMS system for the particular needs of their company. However, the setup and configuration user interface in the back office system guides the user to organize the TLMS system in a predetermined manner.

The back office system requires the creation and setup of a work breakdown structure (WBS) in the TLMS system that is specific to the user's company's needs. The TLMS system is designed to work with projects that are organized and divided into a series of work packages wherein each work package is further divided into a manageable set of tasks. The back office system requires the setup of a work breakdown structure to have work packages and tasks as the lowest level segmentations in the work breakdown structure to ensure that the core functionality of the TLMS system is achieved.

Once the WBS is created, the back office system guides the user through the setup and configuration process that facilitates the creation of requisite databases, including an employee record database, training and certifications database, a standard hazards and mitigation classifications database, a schedule slippage reasons database, a cost codes database and a customer criteria database. These detailed databases serve as tools for use in the back office system during project planning.

The TLMS system contemplates that project planning in the back office system will be conducted by project planner and or project manager users. The back office system is divided into a series of graphical interfaces that are each accessible through selection of corresponding tabs. The back office graphical interfaces are divided to correspond with specific aspects of project planning, including work package estimates, work package setup, short interval schedule, job safety analysis, and constraints checklist. The back office system of the TLMS system guides the user through each of these different planning tabs in order to plan individual work packages for a project prior to the construction of those work packages in the field.

Project planning begins with the creation of one or more work packages in the back office system during the work package estimates process. The project planner or project manager is prompted to provide specific information relating to a newly created work package, including work package description, the list of tasks to be performed for the work package, the estimated man hours to complete the work package, and the selection of crew positions required to construct the work package. The TLMS system stores this information for use in various TLMS data calculations, the results of which provide important metrics regarding progress, timeliness, efficiency and productivity of the work package when it is later constructed. The work package estimating process inputs are derived from traditional construction project documents typically utilized when planning the construction of a project, including the project estimate and project master schedule. In addition, upon completion of the work package estimates inputs, the TLMS system calculates an estimated budget for the work package.

Project planning continues with the completion of the remaining planning steps of work package setup, short interval schedule setup, job safety analysis planning, and constraint checklist creation. These remaining project planning tasks can occur in any order preferred by the project planner or project manager user.

The work package setup process includes the linking of the newly created work package to the company WBS previously created during setup and configuration. Work package setup also includes the inputting of the planned work package start date and planned work package end date.

The short interval schedule setup for a work package is preferably performed approximately six weeks prior to the planned work package start date. Short interval schedule setup includes selection of the actual crew from the employee record database created during setup and configuration. Short interval schedule setup also requires, as additional inputs in the back office system, the work schedule for the work package, the planned percentage completion for each task in the work package and the planned average crew size for each work packaged planned day. Upon the completion of these inputs, the TLMS system calculates a planned budget and compares the planned budget to the previously calculated estimated budget. This comparison enables the project planner and/or project manager to immediately evaluate whether the project as planned is within the budget. This comparison step enables project planners to revisit schedules and allocation of resources as needed to ensure that the plan for the project, if implemented in the field by the frontline supervisor, will enable the frontline supervisor to deliver a constructed work package that is timely and within budget.

The job safety analysis planning in the back office system enables the user to input identified hazards and hazard mitigations for those identified hazards for each task to be performed in connection with the work package. Moreover, the job safety analysis planning enables the user to assign a person responsible in the field for ensuring that a job safety meeting occurs and that all crew personnel present attend the job safety meeting. The identified hazards and hazard mitigations may be selected from the databases created during setup and configuration. The person responsible may be selected from the employee record database, also previously created during setup and configuration.

Project planning also includes the creation of a constraints checklist in the back office system. The constraints checklist facilitates the creation of a working list of constraints that need to be completed before work can begin on construction of the work package. The constraints checklist can include links to important documents, as well as timing requirements for the start and completion of specific constraint items. Such timing component is useful to ensure that long lead items are properly addressed before the work package as planned is actually released to the frontline supervisor.

The constraints listed in the constraints checklist, once created, can then be marked completed in the TLMS back office system or the TLMS frontline system when the constraints are completed. The constraints checklist provides the project manager and frontline supervisor with an immediate list of items that need to be performed before commencing with construction and helps avoid the problems of idle labor time.

The project planning tools of the TLMS back office system ensure that by the time a work package is released to the frontline supervisor for construction, the frontline supervisor will have a work package designed to be immediately constructed productively, timely and within budget.

When a work package is ready for construction, the frontline supervisor utilizes the frontline system to ensure that he or she is building the work package according to the work package plan.

The frontline system is designed to provide the frontline supervisor with an easy to use application styled interface on a mobile device such as a tablet. The frontline system has tabs that enable the frontline supervisor to quickly and easily access different features of the frontline system, including a WP progress tab, a crew and JSA tab, a work package tab, a reporting tab, and a notes tab.

The WP progress tab serves as a progress and performance dashboard to provided immediate feedback to the frontline supervisor about the status of the work package. The WP progress page has a graphical interface featuring a dynamic user interface graphic, a planned progress graphic display, an actual progress graphic display and a productivity index display. These displays enable the frontline supervisor to immediately discern whether the work package is being performed according to schedule and productively. The data supporting these displays arises from the data inputted by the frontline supervisor into the frontline system during construction as well as the data inputted during the work package planning to provide feedback to the frontline supervisor. This real time comparison of planned versus actual provides much needed feedback to the frontline supervisor to enable him or her to make adjustments in the field to ensure that productivity and progress are within plan and ultimately on budget.

The dynamic user interface graphic is selected from a list of optional dynamic user interface graphics and provides a game like interface to make use of the frontline system more entertaining. The dynamic user interface graphic depicts a graphic, such as an Egyptian pyramid scene or dam, that is under construction. The graphic then updates to depict progress in which reflects actual progress in the real construction. For example, at 20 percent actual project completion, the Egyptian pyramid scene would appear only 20 percent constructed. At 80 percent actual project completion, the Egyptian pyramid scene would appear 80 percent constructed. A variety of available dynamic user interface graphics enable frontline supervisors to select different dynamic user interface graphics for different work packages, keeping the frontline system interesting for the frontline supervisor in order to further motivate the frontline supervisor to use the frontline system.

The crew and JSA tab of the frontline system has a crew page and a job safety analysis page. The crew page enables the frontline supervisor to input the crew members present for a shift. The job safety analysis page summarizes the identified hazards and mitigations for the shift and enables the frontline supervisor to obtain digital signatures or pin number inputs from the crew in order to verify crew attendance at the safety meeting.

The work package tab of the frontline system has a short interval schedule page and a constraints checklist page. The short interval schedule page has provides key metrics of the project planning for the work package, including applicable cost codes, tasks, scope, list of crew members, and total planned man hours. These key metrics provide the frontline supervisor with important work package plan details itemized down to the task level. The constraints checklist page provides the detailed information pertaining to the constraints for the work package, including whether or not the constraints are completed.

The Reporting tab of the frontline system has a daily work time page, a daily progress record page, a reliability record page and a client critique page. The Reporting tab is the primary interface wherein the frontline supervisor provides inputs pertaining to actual construction. The daily work time page provides an easy to use interface enabling the frontline supervisor to input the hours worked by each crew member and allocate those hours per task. The daily progress record page enables the frontline supervisor to input the actual percentage complete for each task upon the conclusion of the shift and includes data fields for planned percentage completion for each task. Based on the inputs of the frontline supervisor, the frontline system calculates the cumulative progress for each task and displays the same as feedback to the frontline supervisor. Such feedback provides an immediate basis of comparison to the frontline supervisor to evaluate progress and quickly identify specific tasks that are falling behind schedule. The reliability record page enables the frontline supervisor to select reasons for schedule slippage in the event the work package was not completed as planned. The client critique page enables a customer representative to provide feedback on the performance of the frontline supervisor and crew based upon the framework established during setup and configuration.

The Notes tab provides an interface for the frontline supervisor to complete his or her more traditional daily reporting, such as documenting specific events such as a safety violation.

The data inputted during project planning and construction enables the TLMS system to provide a wide variety of calculated outputs that can be published back office dashboards, frontline dashboards, or both. These outputs include earned hours, productivity index, actual crew composite rates, aggregate labor efficiency rate (LEI), the Trestles Labor Management index, frontline supervisor reliability, and frontline supervisor ranking. These outputs further enable TLMS to provide a wide variety of performance charts pertaining to these outputs over time. Such long term data allows companies utilizing the TLMS system to evaluate the performance of the company over time as well as track impact of changes in company policies on company performance and frontline supervisor performance.

### BRIEF DESCRIPTION OF THE DRAWINGS

The nature, objects, and advantages of the present invention will become more apparent to those skilled in the art after considering the following detailed description in connection with the accompanying drawings, in which like reference numerals designate like parts throughout, and wherein:

FIG. 1 is a system level diagram view of the TMLS system;

FIG. 2 is a central computer system block diagram view of the TLMS system;

FIG. 3 is a back office system block diagram view of the TLMS system;

FIG. 4 is a mobile frontline system block diagram view of the TMLS system;

FIG. 5 is a flow chart depicting an overview of the TLMS system and how the TLMS system is used in conjunction with a construction project and showing the primary steps in the TLMS system of setup and configuration, project planning, and project construction, and showing TLMS system outputs;

FIG. 6 is a flow chart depicting steps taken by a system administrator during setup and configuration of the TLMS system using the back office system.

FIG. 7 is a flow chart depicting steps taken by a project manager and/or a project planner during project planning of a project, including the creation of work package estimates, the work package setup, and the short interval schedule;

FIG. 8 is a flowchart continued from FIG. 7 and further depicting additional steps taken by a project manager and/or a project planner during project planning of a project, including job safety analysis planning, constraints checklist creation and constraints removal;

FIG. 9 is a flowchart depicting the steps taken by a frontline supervisor using the frontline system of the TLMS to manage the construction of a work package for a construction project;

FIG. 10 is a sample work breakdown structure;

FIG. 11 is a flowchart depicting the process of creating employee records;

FIG. 12 is a flowchart depicting the process of work package identification;

FIG. 13 is a flowchart depicting the TLMS system outputs for a work package;

FIG. 14 is a flowchart depicting the earned hours calculation performed by the TLMS system;

FIG. 15 is a flowchart depicting the productivity index calculation performed by the TLMS system;

FIG. 16 is a flowchart depicting the actual crew composite rate index calculation performed by the TLMS system;

FIG. 17 is a flowchart depicting the composite rate index calculation performed by the TLMS system;

FIG. 18 is a flowchart depicting the labor efficiency index (LEI) calculation performed by the TLMS system;

FIG. 19 is a flowchart depicting the schedule reliability calculation performed by the TLMS system;

FIG. 20 is a flowchart depicting the Trestles Labor Management index (TLMI) calculation performed by the TLMS system;

FIG. 21 is a flowchart depicting the frontline supervisor reliability calculation performed by the TLMS system;

FIG. 22 is a flowchart depicting the supervisor ranking calculation performed by the TLMS system;

FIG. 23 is a flowchart depicting the setup of frontline dynamic user interface graphic;

FIG. 24 is a flowchart depicting the operation of frontline dynamic user interface graphic;

FIG. 25 is a desktop view of the back office system showing the login screen;

FIG. 26 is a desktop view of the back office system showing the setup and configuration drop down menu;

FIGS. 27 and 28 are desktop views of the back office system showing the employee position classification page on the setup and configuration user interface;

FIG. 29 is a desktop view of the back office system showing the employee training and certifications page on the setup and configuration user interface;

FIG. 30 is a desktop view of the back office system showing the standard hazards and mitigation page on the setup and configuration user interface;

FIG. 31 is a desktop view of the back office system showing the client critique performance categories page on the setup and configuration user interface;

FIG. 32 is a desktop view of the back office system showing the schedule slippage reasons page on the setup and configuration user interface;

FIG. 33 is a desktop view of the back office system showing the sync page on the setup and configuration user interface;

FIG. 34 is a desktop view of the back office system showing the costs code library page on the setup and configuration user interface;

FIG. 35 is a desktop view of the back office system showing the dashboard tab as having been selected by the user;

FIGS. 36 and 37 are desktop views of the back office system showing the WBS filter pop-up window with user selected filters shown in schedule reliability chart page of the dashboard tab user interface;

FIG. 38 is a desktop view of the back office system showing the employee record page on the employee tab user interface;

FIG. 39 is a desktop view of the back office system showing the training and certification page of selected employee on the employee tab user interface;

FIG. 40 is a desktop view of the back office system showing the work crew page of the crew tab interface;

FIG. 41 is a desktop view of the back office system showing the WBS tab interface selected on the WBS composer page;

FIG. 42 is a desktop view of the back office system showing the add item pop-up menu of the WBS tab interface;

FIG. 43 is a desktop view of the back office system showing the WP estimate summary page of the WP estimate tab interface;

FIG. 44 is a desktop view of the back office system showing the estimate creator page of the WP estimate tab interface;

FIG. 45 is a desktop view of the back office system showing the WP estimate summary page of the WP estimate tab interface;

FIG. 46 is a desktop view of the back office system showing the work package planner status page of the WP planning tab interface;

FIG. 47 is a desktop view of the back office system showing the WP setup page of the WP planning tab interface;

FIG. 48 is a desktop view of the back office system showing the notification pop-up window in connection with the hierarchy menu on the WB setup page or the of the WP planning tab interface;

FIGS. 49 and 49A are desktop views of the back office system showing the graphical interface for the short interval schedule menu on the WP planning tab interface;

FIG. 50 is a desktop view of the back office system showing the constraints checklist menu on the WP planning tab interface;

FIG. 51 is a desktop view of the back office system showing the daily JSAs menu on the WP planning tab interface;

FIG. 52 is a desktop view of the back office system showing the report central tab interface;

FIGS. 52-65 are desktop views of the back office system showing the various types of detailed reports the user can create using the report central tab interface;

FIG. 66 is a tablet view of the frontline system showing the login screen;

FIG. 67 is a tablet view of the frontline system showing the open work package list page;

FIGS. 68 and 69 are tablet views of the frontline system showing the dynamic user interface graphic on the WP progress tab;

FIG. 70 is a tablet view of the frontline system showing the graphical interface for the user page as accessed through selection of the user button;

FIG. 71 is a tablet view of the frontline system showing the graphical interface of the profile page as accessed through the profile menu in the user interface;

FIG. 72 is a tablet view of the frontline system showing the graphical interface for the security page as accessed through the profile menu in the user interface;

FIG. 73 is a tablet view of the frontline system showing the crew page of the crew and JSA tab of the user interface;

FIG. 74 is a tablet view of the frontline system showing the job safety analysis page of the crew and JSA tab of the user interface;

FIG. 75 is a tablet view of the frontline system showing the JSA meeting attendance page in the crew and JSA tab of the user interface;

FIG. 76 is a tablet view of the frontline system showing the signature interface from the JSA meeting attendance page in the crew and JSA tab of the user interface;

FIG. 77 is a tablet view of the frontline system showing the status change made when signature interface is completed;

FIG. 78 is a tablet view of the frontline system showing the pin# interface window on the crew and JSA tab of the display interface;

FIG. 79 is a tablet view of the frontline system showing the short interval schedule page of the work package tab of the user display interface;

FIG. 80 is a tablet view of the frontline system showing the constraints checklist page of the work package tab of the user display interface;

FIG. 81 is a tablet view of the frontline system showing the attachments interface from the constraint checklist page of the work package tab of the user interface;

FIG. 82 is a tablet view of the frontline system showing the daily work time page of the reporting tab of the user interface;

FIGS. 83 and 84 are tablet views of the frontline system showing a daily work time interface as accessed from the daily work time page of the reporting tab of the user interface;

FIG. 85 is a tablet view of the frontline system showing the daily work time page of the reporting tab of the user interface;

FIG. 86 is a tablet view of the frontline system showing the reliability record page of the reporting tab of the user interface;

FIG. 87 is a tablet view of the frontline system showing the client critique page of the reporting tab of the user interface;

FIG. 88 is a tablet view of the frontline system showing the customer signature interface window from client critique page of the reporting tab of the user interface;

FIG. 89 is a tablet view of the frontline system showing the notes tab of the graphical interface;

FIG. 90 is a tablet view of the frontline system showing notes interface as accessed from the notes tab of the graphical interface.

### DETAILED DESCRIPTION OF THE DRAWINGS

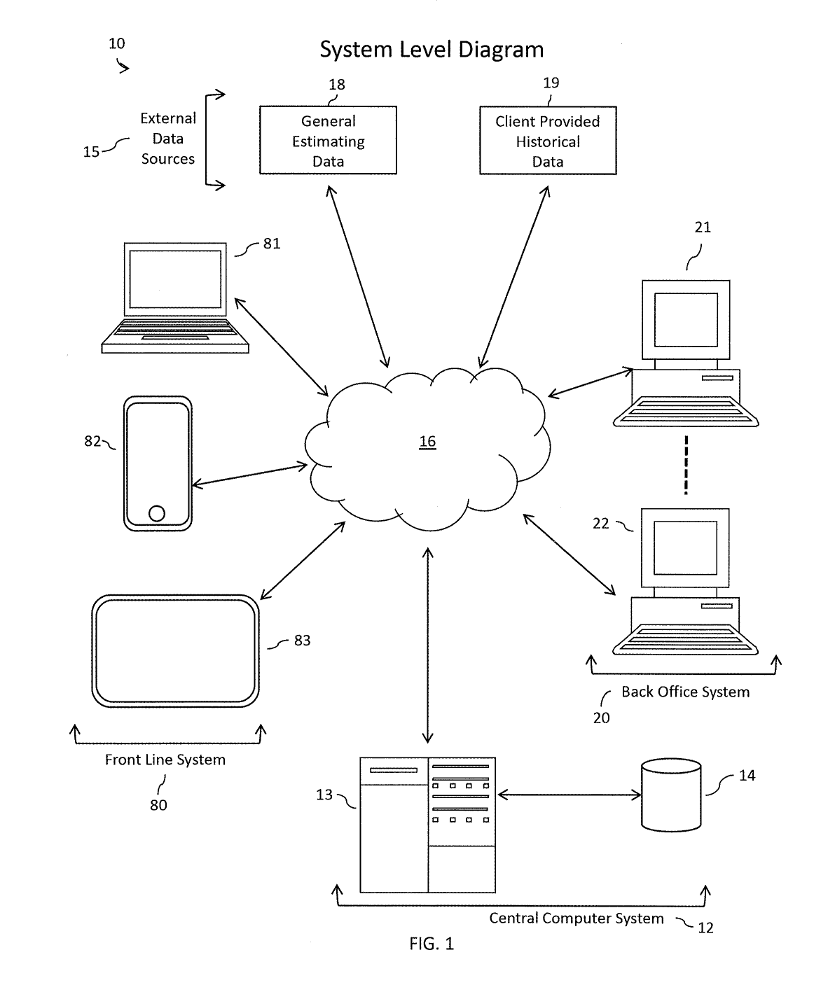

Referring to FIG. 1, the TLMS system 10 is depicted and divided into a central computer system 12, a back office system 20, a frontline system 80, and external data sources 15. As will be more fully described herein, central computer system 12, external data sources 15, back office system 20, and frontline system 80 are in digital communication with each other through digital communication channels, such as cloud 16. Cloud 16 is generally known in the information technology art as a network connection between computer components, equipment, and peripherals using wireless and wired communication techniques. It is to be appreciated that direct digital communication connections can be made in addition to, or instead of, the cloud 16 connections.

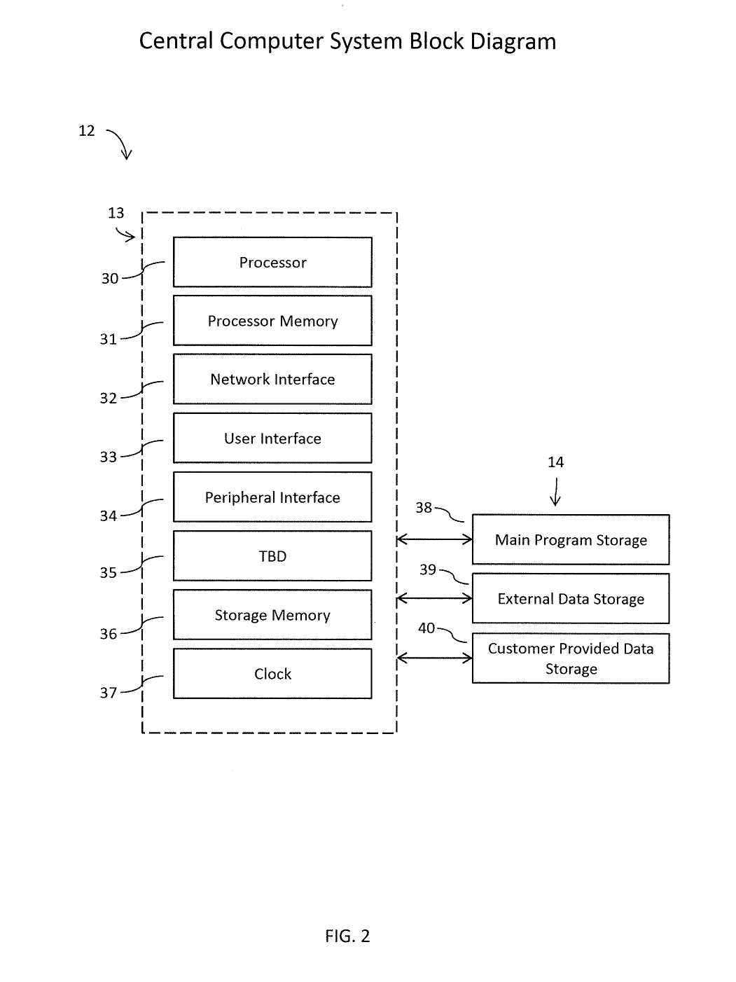

Central computer system 12 is generally known as a server computer, and includes a central server 13 and one or more external memory devices 14. As described herein and shown in FIG. 2, a central server 13 is a digital computing device generally known in the art having a processor 30 having a processor memory 31. A network interface 32 as is known in the art interfaces between central server 13 and the other components of the system 10. User interface 33 provides for the interface between a user and the central server 13. For instance, such user interface 33 could include standard user input devices including a keyboard, mouse, tablet, voice input device, and display devices, such as monitor. Other user interface devices known in the art are fully contemplated herein.

Peripheral interface 34 provides a digital interface between central server 13 and the other components of system 10, such as printers or other output devices. Central server 13 also includes storage memory 36 which provide localized digital storage for the central server for operational memory utilized during execution of programs within the central server. Also, a clock 37 is provided which provides synchrony to all operations within the central server 13. External memory 14 may include external main program storage 38, external data storage 39, or customer provided data storage 40. These data storage devices 38, 39, and 40 may communicate with central server 13 through peripheral interface 34 as is known in the art.

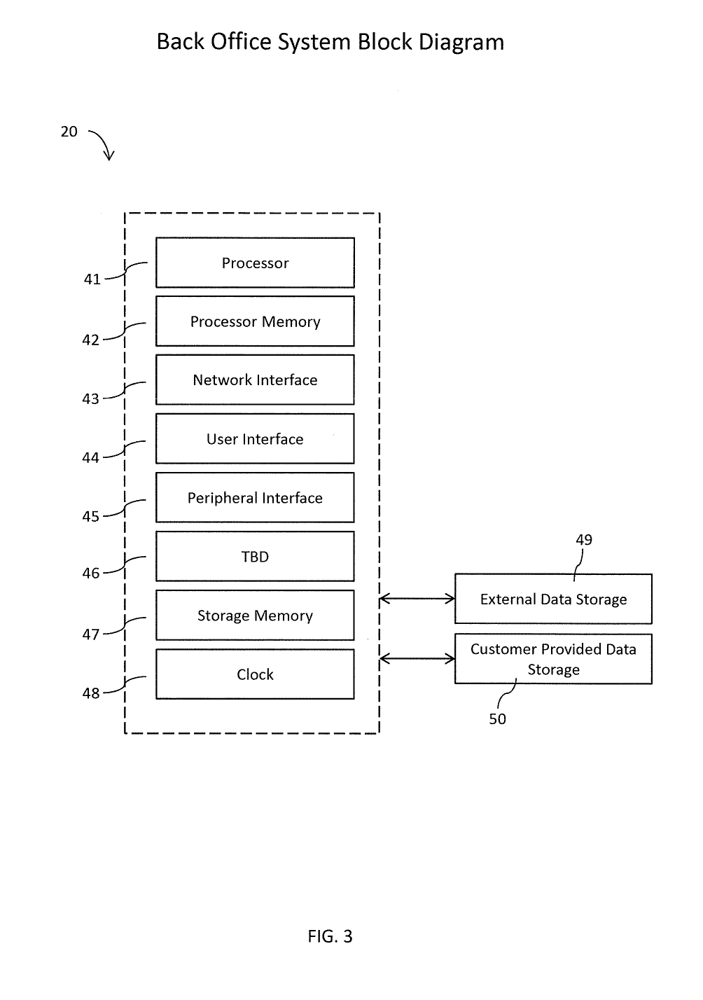

Back office system 20 is utilized to input and organize an awarded project from external data sources 15, such as general estimating data 18 and/or client provided historical data 19. In a preferred embodiment, back office system 20 includes a variety of digital equipment devices, such as computer workstations 21 and 22. Referring to FIG. 3, exemplary back office system 20 includes digital computing device generally known in the art having a processor 41 having a processor memory 42. A network interface 43 as is known in the art interfaces between back office system 20 and the other components of the system 10. User interface 44 provides for the interface between a user and the back office system 20. For instance, such user interface 44 could include standard user input devices including a keyboard, mouse, tablet, voice input device, and display devices, such as monitor. Other user interface devices known in the art are fully contemplated herein.

Peripheral interface 45 provides a digital interface between back office system 20 and the other components of system 10, such as printers or other output devices. Back office system 20 also includes storage memory 47 which provide localized digital storage for the back office system 20 for operational memory utilized during execution of programs within the back office system 20. Also, a clock 48 is provided which provides synchrony to all operations within the back office system 20. External data storage 49, or customer provided data storage 50 may be provided. These data storage devices 49 and 50 may communicate with back office system 20 through peripheral interface 45 as is known in the art.

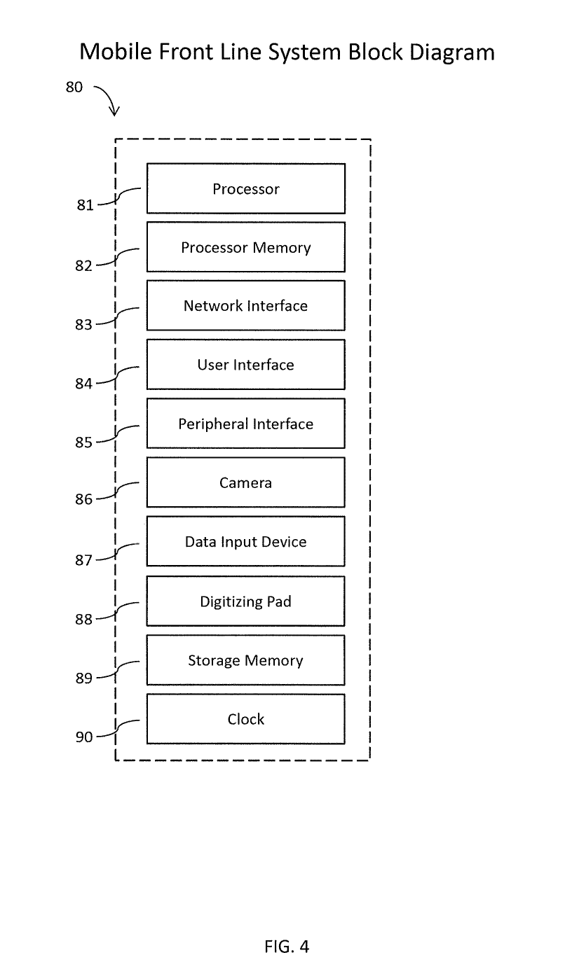

The frontline system 80 is primarily intended for use out in the field by a frontline supervisor. A preferred embodiment of a frontline system 80 includes a variety of digital equipment devices, such as a laptop 81, a handheld electronic device such as a cellular phone 82, or a tablet computer 83. Referring to FIG. 4, an exemplary frontline system 80 includes digital computing device generally known in the art having a processor 81 having a processor memory 82. A network interface 83 as is known in the art interfaces between frontline system 80 and the other components of the system 10. User interface 84 provides for the interface between a user and the frontline system 80. For instance, such user interface 84 could include standard user input devices including a keyboard, mouse, tablet, voice input device, and display devices, such as monitor. Other user interface devices known in the art are fully contemplated herein.

Peripheral interface 85 provides a digital interface between frontline system 80 and the other components of system 10, such as printers or other output devices. A camera interface 86 may also be provided which allows for the direct entry of photographic data to the frontline system 80 without connection of external peripheral devices. Additional data input devices 87 can be incorporated into the frontline system 80 without departing from the present invention. For instance, bar code readers for easily logging critical project data, deliveries, etc., can be incorporated. Also, a digitizing pad 88 may provide a frontline user to use the frontline system 80 in a dynamic and rugged environment without the need for careful keyboard manipulation or attention.

Frontline system 80 also includes storage memory 89 which provide localized digital storage for the frontline system 80 for operational memory utilized during execution of programs within the frontline system 80. Also, a clock 90 is provided which provides synchrony to all operations within the frontline system 80.

While TLMS system 10 has been depicted and described in conjunction with FIGS. 1-4, it is to be appreciated that these represent a preferred embodiment of the present invention. It is also to be appreciated that variations to the central computer system 12, back office system 20, frontline system 80, and external data sources 15 are fully contemplated herein consistent with the operation of the system as fully set forth below.

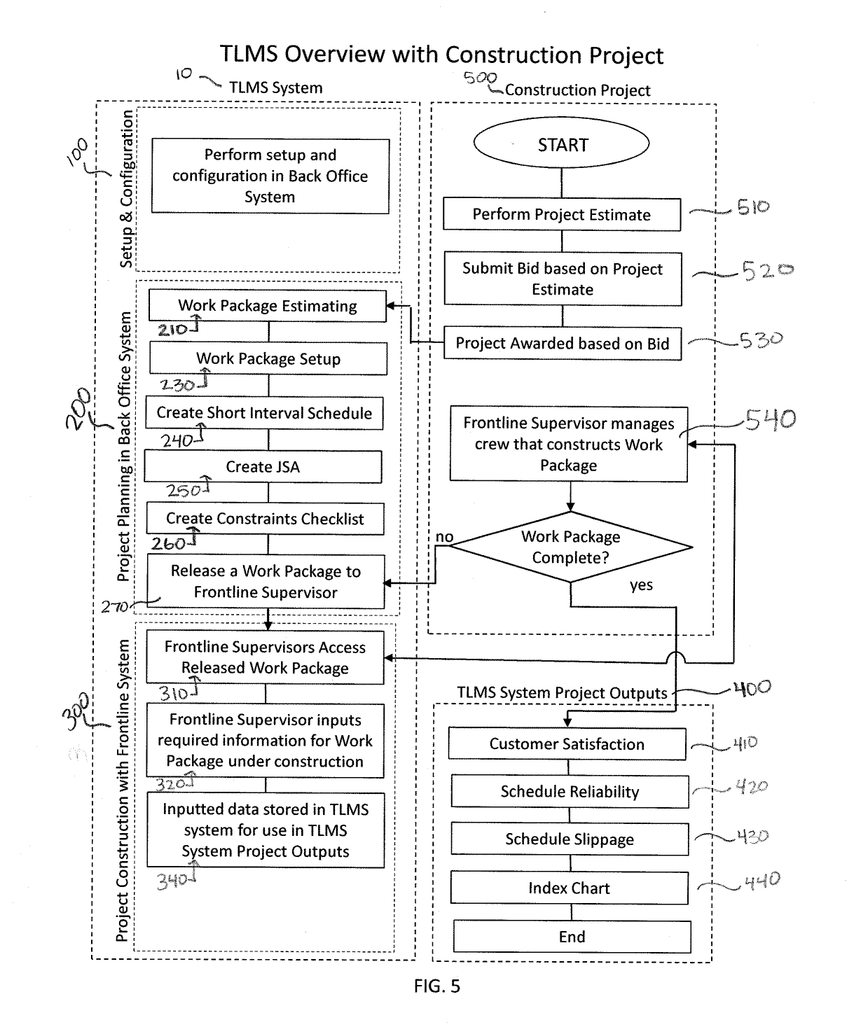

Referring next to FIG. 5, the interplay between a construction project 500 and the TLMS system 10 is shown. The first step to use the TLMS system 10 in conjunction with a construction project 500 is the completion of setup and configuration 100 for a construction company. The setup and configuration 100 is performed by a system administrator using the back office system 20. The setup and configuration 100 does not need to be accomplished in connection with a specific construction project. However, the setup and configuration 100 does not need to be accomplished prior to performing the next step of project planning 200 in the TLMS system 10.

The typical steps at the outset of a construction project 500 include performance of a project estimate 510, followed by the submissions of a bid 520 based on the project estimate 510. The next step in the construction project 500 is the project award 530, which presumably was primarily based on the project bid 520.

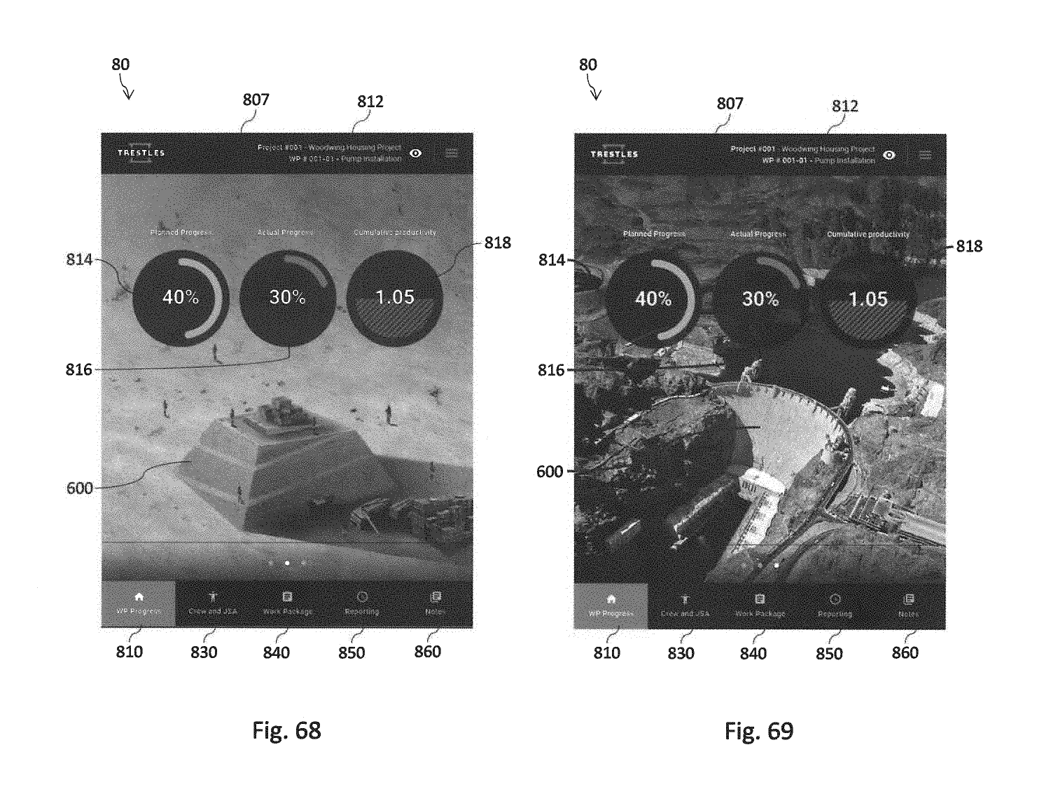

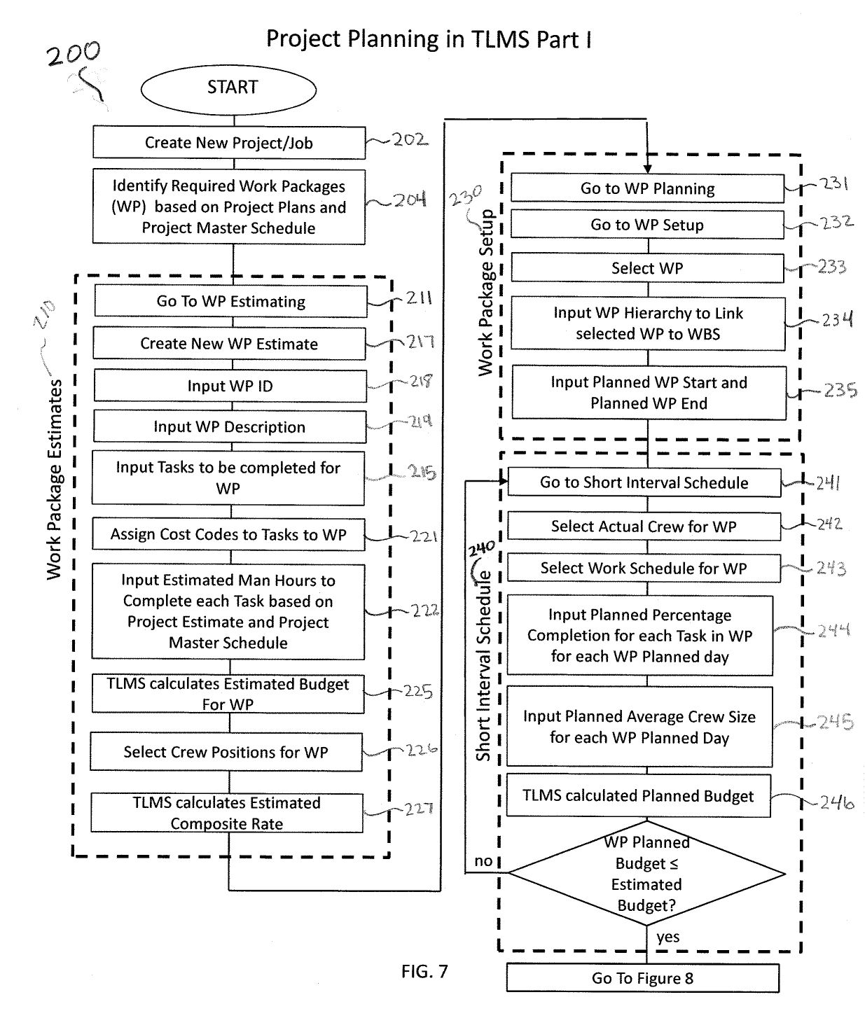

Once a construction company has received a project award 530, a project planner and/or project manager for the project begins the project planning 200 using the back office system 20 of the TLMS system 10. Project planning 200 begins with work package estimating 210 during which work packages 212 are created based the project estimate 510 and other project documents, such as a project master schedule. As set forth more fully in the discussion with respect to FIG. 7, the process of creating work packages 212 requires the creation of tasks 215 for each work package 212. The subdivision of a construction project 500 into work package 212 and a number of tasks 215 to be completed in connection with each work package 212 maximizes the value of the TLMS system 10 to a construction company using the TLMS system 10.

Project planning 200 next requires a project manager or project supervisor to perform work package setup 230, short interval schedule setup 240, job safety analysis (JSA) setup 250, and the constraint checklist setup 260. It is to be appreciated by those skilled in the art that the steps 230, 240, and 250 can be performed in any order and the order shown in FIG. 5 is merely for illustration of the steps themselves.

Upon the completion of the work package estimating 210, work package setup 230, short interval schedule setup 240, job safety analysis setup 250 and constraint checklist setup 260 for a particular work package 212, the work package 212 may then be released to a frontline supervisor for work package construction 270 using the frontline system 80. Also, the project planner or project manager may subsequently remove constraints from the constraint checklist 260 for each work package 212 and the tasks 215 within the work package 212 prior of the release of the work package 212 to the frontline supervisor. Those constraints may also be removed by the frontline supervisor before supervising the actual construction of the work package 212.

Upon release of a work package 212 to the frontline supervisor, the frontline supervisor performs construction management 540 as prescribed by the work package 212 while using the frontline system 80 to facilitate the management. The high-level tasks of the frontline supervisor are simply to first access the work package 310 and then input required information into the frontline system 320. During this process of project construction 300 with the frontline system 80, the frontline supervisor utilizes the frontline system 80 to input required information 310 on a daily basis for each work package 212 under construction. That inputted required information 320 is stored in the central computer system 30 for use both by the frontline supervisor using the frontline system 80 and his or her supervisors using the back office system 20. The TLMS system 10 also stores the inputs 340 from the frontline supervisor for use in the TLMS system project outputs 400.

The process is continued for each work package 212 until all work packages 212 for the project are constructed. The TLMS system 10 calculates project outputs 400 specific to each work package 212 and to the project, including customer satisfaction 410, schedule reliability 420, schedule slippage 430 and an index chart 440 that plots a variety of project parameters. The project outputs 400 enable the project manager or other high-level company personnel to evaluate what aspects of the project were productive, timely, and within budget as well as those aspects of the project that may have been unproductive, untimely, overbudget, or a combination thereof.

Turning to FIG. 6, the more specific steps required for the process of setup and configuration 100 are generally shown. The steps set out in FIG. 6 are not required to be performed sequentially except for when the context indicates otherwise. A primary task in performing the setup and configuration 100 is the creation of the work breakdown structure (WBS) 110 in the back office system 20 of the TLMS system 10. The WBS 110 sets forth the segmentation of a company. There are two aspects of the WBS 110. The first requires the creation of the WBS 110 in the setup and configuration in connection with non-project specific segments 112. The second requires additions to the WBS 110 during the project planning 200 through inputting hierarchy in connection with specific work packages 212 to the existing WBS 110 previously created in the setup and configuration 100. These second aspects of the WBS 110 are project specific segments 114.

The non-project specific segments 112 are disclosed more completely in connection with FIG. 41. The non-project specific segments 112 are particularly important for larger construction companies with a corporate hierarchy, multiple divisions, and multiple geographic locations.

These non-project specific segments 112 include a first level hierarchy for a corporation 111. Often large companies have subsidiaries, and the TLMS system 10 allows for creation of a WBS 110 to identify one or more companies 113 as a second level hierarchy. Similarly, the TLMS system 10 enables the administrator to further break down the corporation 111 or each of its companies 113 into various organizational units 115 as a third level hierarchy of segmentation.

The project specific segments 114 are disclosed more completely in connection with FIG. 10 for a WBS 110. Referring to FIG. 10, project specific segments 114 include the project 116, the phase 117 of the project 116 if applicable, the area 118 of the project 116 if applicable, the discipline 119 of the project if applicable, and the required work package 212, and tasks or steps 215 for the work package 212.

Returning to FIG. 6, another step in the setup and configuration 100 is for the system administrator to create and input employee records 120. The back office system 20 allows for the creation of employee records 120 for each employee of the company that performs construction, management, and/or planning activities for the company using the TLMS system 10. For each employee inputted the TLMS system 10, a unique ID number and pin number are assigned. The system administrator then either inputs directly or imports from a separate database information pertaining to the employee, including the name, position, classification, labor burden multiplier, base rate, premium rate, training and certifications completed by the employee, along with current contact information for the employee.

This process of creating employee records 120 includes the creation of employee classifications. These employee classifications are customizable for specific projects 116 and can include well known industry classifications such as foreman, operator, pipe fitter, surveyor, ironworker, etc. For each classification, the back office system 20 also prompts the system administrator to select user defined level designations, such as level I, level II, level III, etc. For example, during the process of creating employee classifications, the system administrator might include an operator level I, and a pipe fitter level III. These classifications and the required levels are selected based on the various types of skilled workers that are required to construct the various aspects of the project.

Another step in the setup and configuration 100 is to identify and input required employee training and certifications 130. Often construction projects require certain crew members have required certifications, training, and/or licenses in order to perform certain aspects of the scope of work for the construction project. The system administrator utilizes the back office system 20 of the TLMS system 10 in order to input such requisite certifications, training and/or licenses. For example, a project could require 40 hours of OSHA training for safety, a certification of NCCER journeyman for craft training, and a welding technique certification for a technical certification. Such training and certification requirements are inputted into the back office system 20 by the system administrator as part of the project setup and configuration process 100.

Another step in the setup and configuration 100 is for the system administrator to input standard hazards and associated mitigation classifications 150 that are applicable to all construction company projects. Such standard hazard and mitigation classifications 150 could include falls, hand lacerations, foreign objects in eyes, etc. Mitigation measures could be fall protection, wearing gloves, wearing eye projection, etc.

Another step in the setup and configuration 100 is for the system administrator to input schedule slippage reasons 160. Schedule slippage reasons 160 could include material, engineering, equipment, rework, reassigned work, workload, permits, etc. All commonly experienced reasons for schedule slippage experienced by the construction company should be inputted into the back office system 20 during the setup and configuration 100.

Another step in the setup and configuration 100 is to create and/or import costs codes 170. For example, a unique cost code 170 should be created in connection with tasks such as mobilization, staging of materials, survey layout, excavation, form and strip, etc., that the construction company would expect to regularly perform. Projects have unique aspects that may require one or more unique cost codes. Other projects have cost codes that are provided by the customer. The TLMS system 10 back office system 20 provides the flexibility for the system administrator to input construction company standard cost codes 170 during the setup and configuration or for a project manager to assign cost codes 170 during project planning 200 to address project specific cost codes 170 or customer driven cost codes 170.

Another step in the setup and configuration 100 is to create and input the customer critique template 180 with a variety of performance categories 181. Performance categories 181 are user defined but likely include safety, quality, schedule, professionalism. The template 180 enables a customer representative to use the touch screen on the frontline supervisor's mobile device to select rating for each category on a 1-5 scale. 1=Very Poor, 2=Poor, 3=Average, 4=Good, & 5=Very Good. The screen also has a free form text box to enable customer representative to provide written comments regarding the performance of the crew or the technician.

Once the steps 110, 120, 130, 150, 160, 170 and 180 are completed to the satisfaction of the system administrator, the setup and configuration process 100 is complete and the TLMS system 10 is ready for use in connection with a construction project 500.

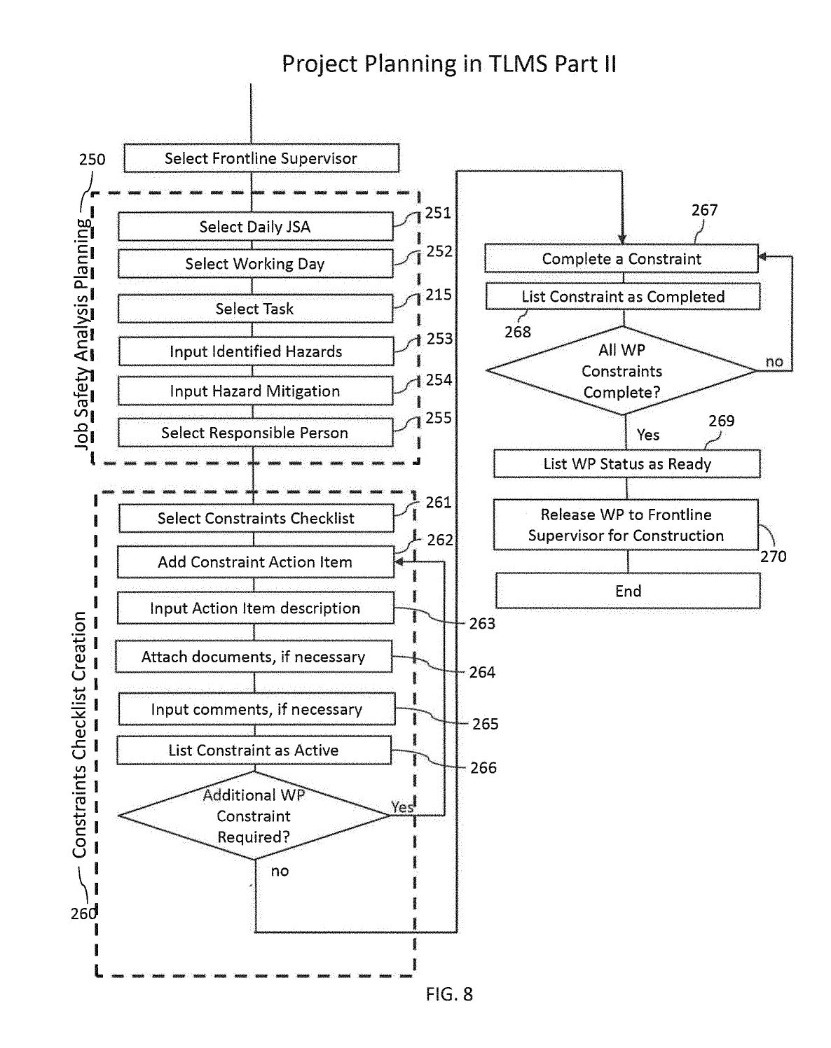

Referring next to FIGS. 7 and 8, the steps of project planning 200 for a construction project 500 are generally described. The project planning 200 is performed by a project planner and/or a project manager using the back office system 20 of the TLMS system 10, in a device such as a desktop 22 or a laptop 81. Upon the award of a project, a project manager or project planner creates a new project 202 in the back office system 20.

Next, the project planner or project manager reviews project documents, including the estimate giving rise to the project, project plans, and the project master schedule and performs work package identification 204 whereby the project manager or project planner divides the project into discrete scopes of work, called required work packages 212. Once the required work packages 212 are identified, the project planner or project manager can begin the preparation of work package estimates 210.

The process of creating work package estimates 210 begins with the project planner or project manager selecting the WP estimating tab 211 in the back office system 20 and then selecting create new WP estimate 217. After selecting create new WP estimate 217, a user interface screen allows for the inputting of additional information. The project planner or project manager is provided a system generated unique WP identification number 218. The unique WP identification number 218 will link a specific work package estimate 210, to all future phases of the work package 212, including planned, released, in progress, or completed.

The project planner then inputs a work package description 219 for the work package 212, such as welding, pump foundation, pump installation, etc. The project planner also inputs the specific tasks 215 to be completed for the work package 212. Tasks 215 could include items such as mobilization, staged material, survey/lay-out, excavation, form and strip, rebar, etc. For each task 215 added to a work package 212, the next step is for the project planner manager to assign a cost code 221 to each task 215 selected from the list of cost codes 170 created during the setup and configuration 100 if it is required to track employee time and labor costs to the cost code level. Tracking employee time and labor cost to a cost code 221 is optional. The project manager or project planner may elect to record time at the work package 212 level.

To complete the process of preparing a work package estimate, the project planner or project manager inputs the estimated man hours 222 to complete each task 215 based primarily on the project estimate 510 and the project master schedule. Once the inputs for a particular work package estimate 215 are completed, then the TLMS system 10 calculates an estimated budget 225 for the work package 212. The above process is repeated until all of the work package estimates 215 are completed for the project resulting in an estimated budget 225 that can be compared the project estimate 510.

The TLMS system 10 allows for a user to move from work package estimates 210 directly to work package setup 230 as soon as a single work package 212 is completed in the work package estimate 210 process. Thus, the TLMS system 10 contemplates that as the project continues, there will be various work packages 212 at different stages of design, from work package estimates 210, to work package setup 230, to the preparation of the short interval schedule 240, to job safety analysis 250, to constraint checklist creation 260. Moreover, the TLMS system 10 also allows for construction of a work package 212 while other work packages 212 are in various stages of planning.

The next phase of project planning 200 is performing the work package setup 230. While working in the back office system 20, the project planner or project manager selects the WP planning tab 231 and then selects WP setup 232. Once in WP setup 232, the project planner or project manager can easily review the work packages 212 created during the work package estimates 210 process and select a work package 233.

After selecting a work package 212, the project planner or project manager inputs the work package hierarchy 234 in order to link the selected work package 212 to the WBS 110. More specifically, the project planner or project manager selects specific segments such as the project 116, the phase 117 of the project 116 if applicable, the area 118 of the project 116 if applicable, the discipline 119 of the project if applicable in order to link the specific work package 212 to the WBS 110.

The final step in the work package setup 230 is for the project planner or project manager to input the planned work package start date and the planned work package end date 235.

Upon completion of the work package setup 230, the project planner or project manager can create the short interval schedule 240, create the job safety analysis planning 250, or create the constraints checklist 260. FIGS. 7-8 show a specific order for the creation of the short interval schedule 240, the job safety analysis planning 250, and the creation of the constraints checklist 260, however, those steps can be performed in any order desired by the project planner or project manager.

The process of creating the short interval schedule 240 begins with the project manager or project planner selecting the short interval schedule tab 241 in the WP planning tab 231 of the back office system 20. Next, the project manager or project planner selects a crew 242 from list of previously created crews or from the employee records 140 with the expectation that the selected crew will perform the construction of the specific work package 212. The process of selecting a crew 242 can include the selection of the frontline supervisor for the work package 212, include a crew description such as Joe Smith's crew, and link the crew 242 to a specific discipline 119.

As part of the process of creating the short interval schedule 240, the project manager or project planner also selects the work schedule 243 for the crew 242, such as an eight-hour shift. The project planner or project manager also inputs a planned percentage completion 244 for each task 215 listed in the work package 212 for each work package 212 planned day. Finally, the project manager or project planner inputs the planned average crew size for each planned day 245 of the work package 212.

Upon completion of the inputs and selections required in the short interval schedule 240, the TLMS system 10 calculates a planned budget 246 for the work package 212. The TLMS system 10 prompts the project planner or project manager with any variance between the estimated budget 225 for the work package 212 and the planned budget 246. Therefore, the TLMS system 10 provides the opportunity for the project planner or project manager to simulate the construction of the work package 212 through the comparison of the estimated budget 225 to the planned budget 246 in order to determine whether the planned budget 246 to construct the work package 212 is within the estimated budget 225. If not, then the project planner or project manager can adjust the variables such as crew selection, crew size, planned percentage completion, etc., until the short interval schedule 240 is within budget. This comparison enables problems with project planning to be identified and resolved prior to the frontline supervisor beginning work on a work package 212 and therefore significantly reduce potential cost and schedule overruns to be faced by the frontline supervisor during actual construction of the work package 212.

Ensuring a work package 212 is properly planned prior to release to the frontline supervisor also requires job safety analysis (JSA) planning 250, and the creation of the constraints checklist 260.

To perform job safety analysis planning 250, the project manager or project planner selects the daily JSA tab 251 on WP planning tab 231 in the back office system 20 of the TLMS system 10. The project planner or project manager then selects the working day 252. Next, for each task 215 in the work package 212, the project manager or project planner selects a specific task 215 and then inputs identified hazards 253, hazard mitigation 254, and selects a responsible person 255 to ensure that the identified hazard mitigation measure is adhered to during construction. The hazards 253 and hazard mitigations 254 are selected from lists that were created during the setup and configuration 100.

To perform constraints checklist creation 260, the project manager or project planner selects the constraints checklist tab 261 on the WP planning tab 231 in the back office system 20 of the TLMS system 10. Next, the project manager or project planner selects an add constraint action item 262 then inputs an action item description 263, such as engineering, materials, scope of work, drawings, specification, etc. The project manager or project planner will attach documents 264 and input comments 265 relating to the constraint if necessary. The project manager or project planner then will list the entered constraint as active 266. The project manager or project planner will repeat the process until all required constraints are identified in the back office system 20 of the TLMS system 10.

As a specific work package 212 nears readiness for release to the frontline supervisor for construction, the project manager or project planner begins the process of completing or removing constraints 267. Upon the completion or removal of a constraint, the constraint is listed as completed 268. Once all constraints are listed as completed 268, the project manager or project planner changes the work package status to ready 269 and releases the fully planned work package 212 to the frontline supervisor for construction. If approval of the fully planned work package by the project manager's or project planner's supervisor is required, said supervisor can status the work package 212 as approved.

It is to be appreciated by those skilled in the art that once a work package 212 is selected in the WP planning tab 231, a user can quickly switch between the WP setup tab 232, the short interval schedule tab 241, the constraint checklist tab 261, and the daily JSA tab 251.

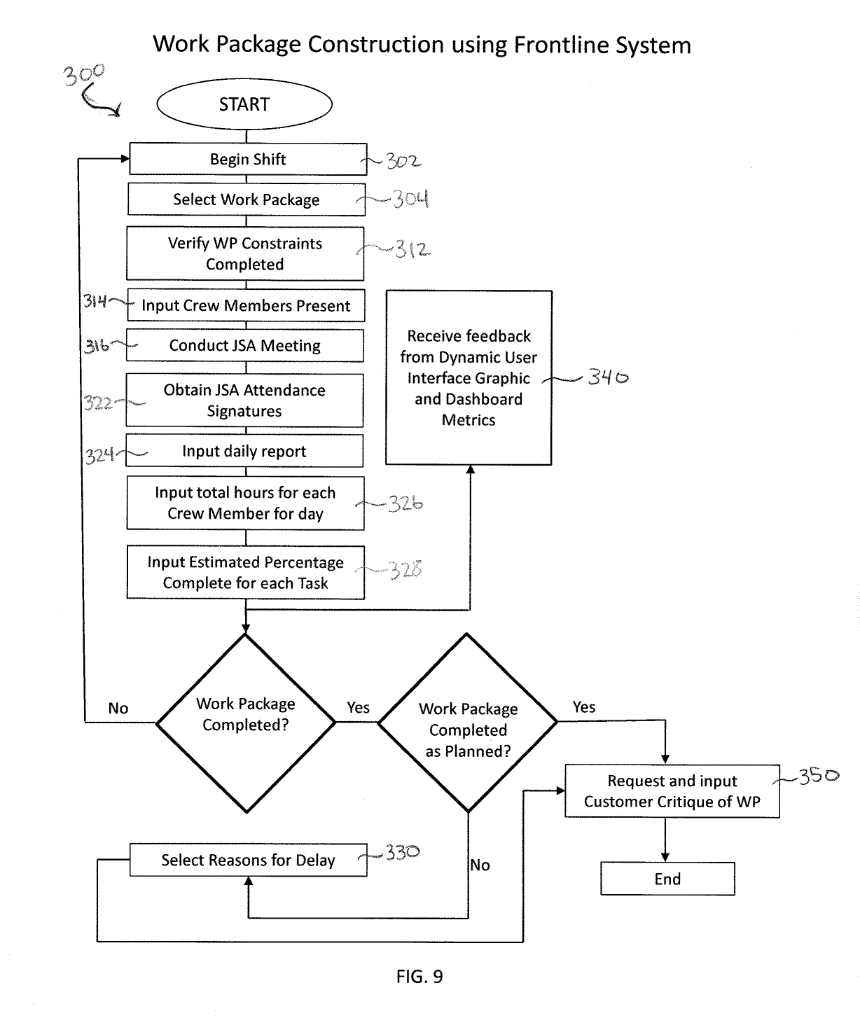

Referring next to FIG. 9, the process of a frontline supervisor using frontline system 80 of the TLMS system 10 during the construction of a specific work package 212 is set forth. At the beginning of a shift 302 while working in the field, the frontline supervisor selects a work package 304 for the specific work package 212 that the crew 242 plans to construct during the shift.

The process of selecting a work package 304 using the frontline system 80 is straightforward. While using a mobile device such as a tablet 83, the frontline supervisor logs into the frontline system 80 using a unique user name and passcode assigned to the frontline supervisor. The frontline system 80 login screen is shown in FIG. 25. Once in the frontline system 80, the frontline supervisor has access to a list of all work packages 212 assigned to him or her. The frontline supervisor simply selects the particular work packages 212 that he or she is about to oversee construction.

Once the process of selecting a work package 304 is complete, the frontline supervisor verifies that all work package constraints are competed 312 through review of the constraint checklist 260. The frontline supervisor will be able to quickly and easily verify if any constraints in the constraint checklist 260 are not complete by review of the constraint status. If one or more of the constraints for the work package 212 is not competed, the frontline supervisor can then immediately notify the project manager of the issue and receive direction from him or her as to whether or not to proceed with construction for the day.

Upon receipt of instruction to proceed from the project manager, or upon verification that all constraints are completed as identified in the constraints checklist 260, the frontline supervisor then proceeds to edit the crew members assigned during project planning 200, if necessary, based on crew members present 314 for the shift in the frontline system 80.

Next, the frontline supervisor (or other person tasked with the responsibility during project planning) conducts a job safety analysis meeting (JSA) 316 to go over all of the identified hazards 253 and hazard mitigation 254. Upon completion of the JSA meeting 316, the frontline supervisor obtains electronic attendance signatures 322 from the crew.

Throughout the shift, the frontline supervisor inputs information into a daily report 324. The daily report 324 memorializes issues that took place during the day that were noteworthy.

Upon the completion of the shift, the frontline supervisor inputs in the frontline system 80 the total hours for each crew member for that shift 326. The frontline supervisor also inputs in the frontline system 80 the estimated percentage complete or actual quantities installed 328 for each task 215.

After all tasks 215 are completed, the frontline system 80 will alert the user, by work package id number, if the work package 212, including all tasks 215, were not completed in the time frame established during the work package setup 230. The frontline supervisor then selects one or more reasons for the delay 330.

The entered information will also auto update the dynamic user interface graphic 600 and dashboard metrics providing immediate feedback 340 to the frontline supervisor of the work crew's performance on the project. Examples of such dynamic user interface graphics 600 and dashboard metrics are shown more fully in connection with FIGS. 25 through 90.

If upon the belief the work package 212 is complete, and it is discovered one or more tasks 215 within the work package 212 are incomplete, the frontline supervisor repeats the steps set forth at the beginning of the shift 302 the following shift until the work package 212 is complete.

Upon the complete construction of the work package 212, the frontline supervisor is prompted by the TLMS system 10 to obtain a customer critique 350 through the presentation of the previously created customer critique template 180. More specifically, the frontline supervisor selects the client critique tab 351 which loads the customer critique template 180 for presentation to the customer representative. In addition to ratings for predetermined performance categories, the customer representative will be able to provide written comments regarding the performance of the crew and/or frontline supervisor. Only when all tasks in the work package 212 are reported as complete by the frontline supervisor, the client critique tab is enabled.

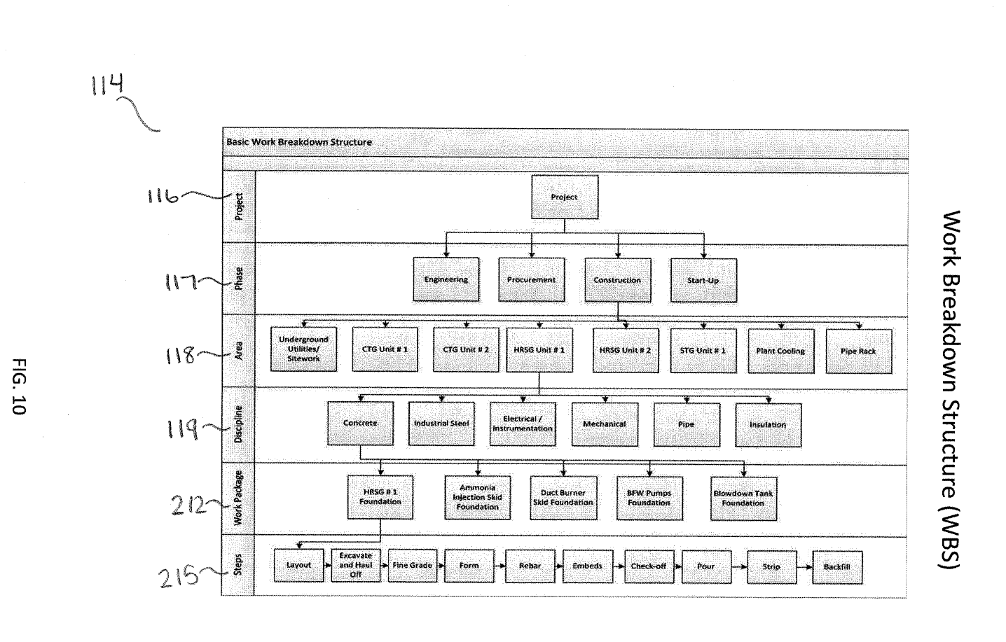

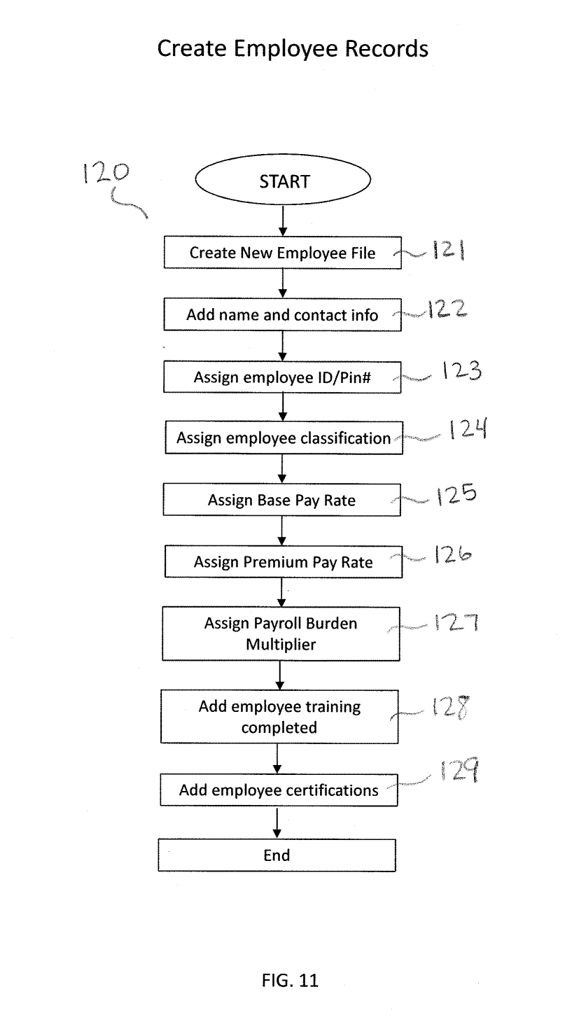

Referring next to FIG. 11, the process of inputting employee records 120 during setup and configuration 100 in the back office system 20 is more specifically set forth. The process includes the creation of a new employee file 121 in the TLMS system 10. Next, the administrator inputs the employee name and contact info 122 for the new employee file 121. Next the administrator assigns and inputs a unique employee identification number and pin number 123. In one embodiment, the unique employee identification number and pin number 123 are automatically generated upon the creation of a new employee file 121. Next, the administrator assigns a base pay rate 125 and a premium pay rate 126 for the specific employee referenced in the employee file 121. Next the administrator assigns and inputs a payroll burden multiplier 127 for the employee. This step enables the company to track actual employee costs. Next, the administrator inputs all employee training completed 128 for the specific employee identified in the employee file 121. Finally, the administrator inputs all employee certifications 129 obtained by the specific employee identified in the employee file 121.

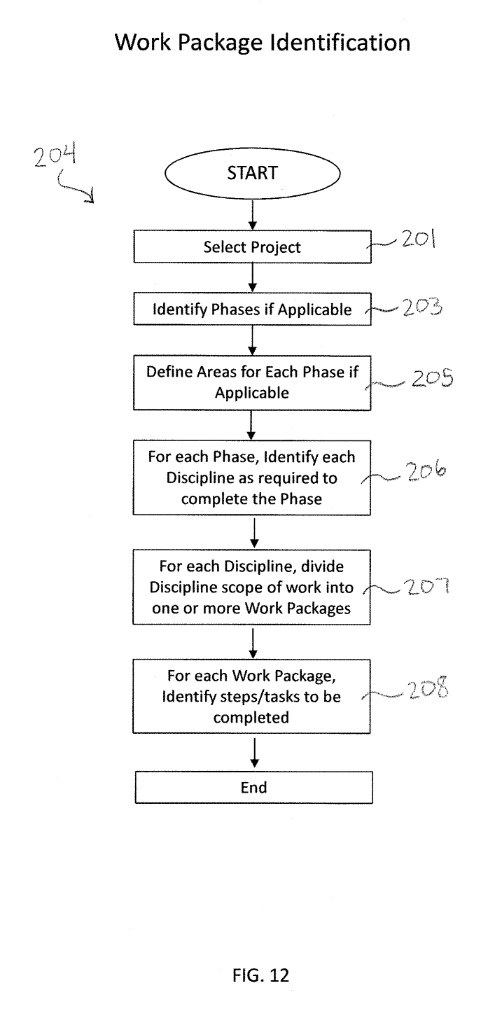

Referring next to FIG. 12, the work package identification 204 process for project planning 200 is more fully described. First, the project planner or project manager must select the project 201 and identify all phases 203 of the project 201, if applicable. Next, the project planner or project manager must define the physical area 205 of the phase as some phases of a project may be performed in a different physical area than other phases of a project. Next, the project planner or project manager identifies the specific disciplines 206 required to complete the phase 203, such as electrical, concrete, HVAC, plumbing, etc. Next, the project planner or project manager divides the scope of work 207 for each discipline into one or more work packages 212. For each work package 212 identified in step 207, the project planner or project manager must then divide each work package 212 into a series of steps or tasks 215 to be completed 208.

The TLMS system 10 calculates a number of index charts 408 that provide useful tools for evaluating whether or not a specific work package and/or project was constructed timely, productively, and within budget. These index charts 408 are presented on one or more dashboard in the back office system 80 and provide a quick and easy means of evaluating a work package 212, a project, or organizational unit as a whole. These index charts 408 include a productivity index 420, a composite rate index 440, a labor efficiency rate index 450, and a TLMI 470.

Referring next to FIG. 13, the various TLMS system 10 outputs on a work package 212 level are generally shown. At the end of a daily shift, the frontline supervisor completes the daily input requirements 320 using the frontline system 80. The TLMS system 10 then utilizes the data from those inputs to calculate earned hours 410, a productivity index 420, an actual crew composite rate 430, a composite rate index 440, a labor efficiency rate (LEI) 450, schedule reliability 460, and the Trestles Labor Management index (TLMI) 470. Each of these calculations are performed upon the completion of each shift and finalized for the work package 212 upon the completion of the work package 212.

Referring next to FIG. 14, the specific method of calculating earned hours 410 is generally disclosed and begins with the inputting of the estimated percentage complete 328 for each task 215 of the shift. The TLMS system 10 then performs a first calculation 411 by multiplying the estimated percentage complete 328 by the estimated total hours 222 to complete the task and outputting the result to back office dashboard 413 linked to the specific task 215. The TLMS system 10 next queries whether there are additional tasks in the work package for which there is an estimated percentage complete 414. If yes, then the first calculation 411 is repeated for each task in the work package 212 until the first calculation 411 has been performed for all tasks 215 in the work package 212. If the response to query 414 is no, then the TLMS system 10 performs a second calculation 415 whereby it sums the task earned hours for the daily shift and outputs the total daily earned hours for the shift about outputs to a TLMS system 10 dashboard. The TLMS system 10 next queries whether all tasks in the work package 212 are complete 416. If no, then TLMS system 10 returns to step 328 for the following shift. If the answer to query 416 is yes, then TLMS system 10 sums the daily earned hours 415 for the work package 212 and outputs work package earned hours 417 to the back office dashboard. Performing the calculations as set forth in FIG. 14 enables a project manager or company executive to review earned hours at a task level, shift level, and at a daily package level using TLMS dashboards in the back office system 20.

Referring next to FIG. 15, the specific method of calculating the productivity index 420 is generally disclosed. The productivity index calculation 420 begins with inputting the calculated earned hours 415 from the earned hours calculation 410. Next, a third calculation 422 is performed by the TLMS system 10 whereby the calculated earned hours 415 are divided by the crew hours 326 for the shift. The output is the daily productivity index 424 which is outputted to a back office dashboard in the TLMS system 10 and to the frontline supervisor dynamic graphic interface 600. The TLMS system 10 next queries whether all tasks in the work package 212 are complete 426. If no, then steps 415, 422 and 424 are repeated for the next shift until the answer to query 426 is yes. Once the answer to query 426 is yes, the TLMS system 10 performs a fourth calculation 428 whereby it sums the daily productivity indexes to obtain the work package productivity index 429, which is then outputted to a back office system 20 dashboard. A work package productivity index 429 that is less than one indicates that the construction of the work package was less productive than planned. Similarly, a work package productivity index 429 that is greater than one indicates that the construction of the work package was more productive than planned.

Referring next to FIG. 16, the specific method of calculating the actual crew composite rate 430 is generally disclosed. The actual crew composite rate 430 calculation begins with a fifth calculation 432 performed by the TLMS system 10 whereby the total labor cost is calculated by totaling the inputted hours 326 multiplied by the rate for each of those inputted hours 326 for a completed work package 212. Next, the TLMS system 10 performs a sixth calculation 434 whereby the total labor cost is divided by the total number of hours worked during the same time frame that total labor cost is captured and outputs the resulting actual crew composite rate 436 to the back office dashboard.

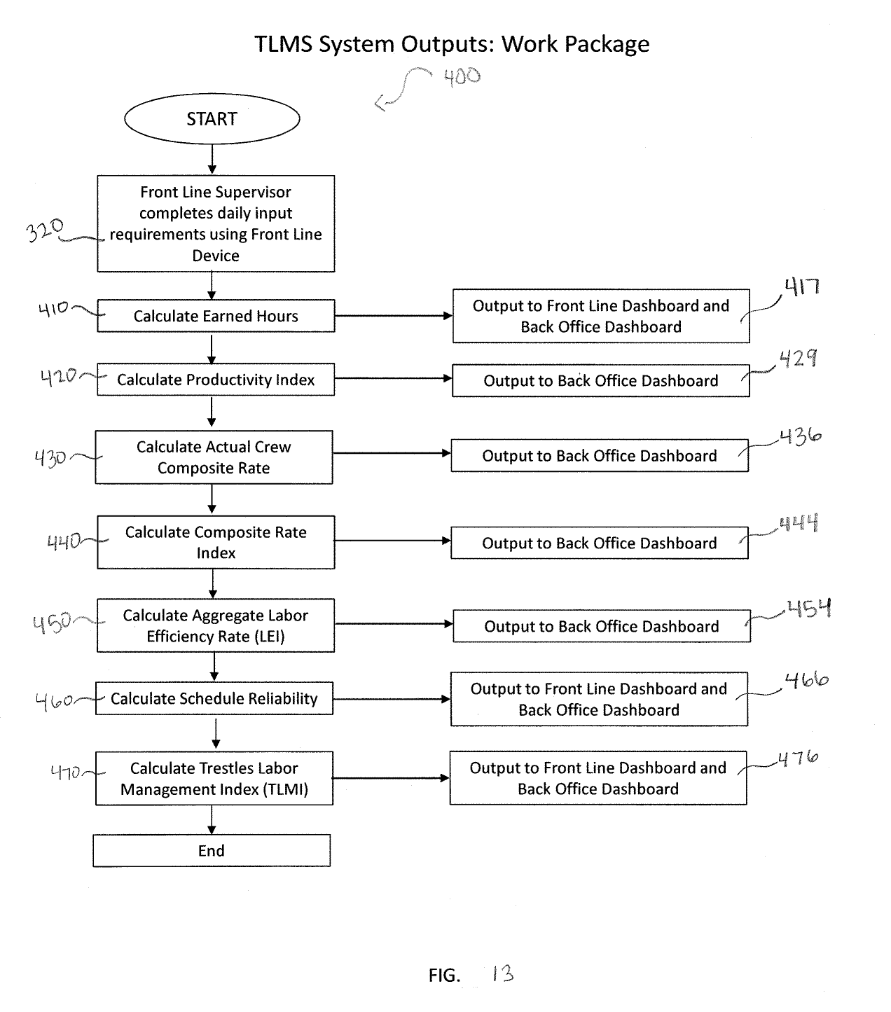

Referring next to FIG. 17, the specific method of calculating the composite rate index 440 for a work package 212 is generally disclosed. The specific method of calculating the composite rate index 440 begins with the input of the estimated composite rate 227 and input actual composite rate 436. Next, the TLMS system 10 performs a seventh calculation 442 performed by the TLMS system 10 whereby the estimated crew composite rate 227 is divided by the actual crew composite rate 436. The resulting composite rate index 444 is outputted to a back office dashboard. A composite rate index 444 that is less than one notifies a user of the TLMS system 10 that labor cost is overbudget. Similarly, a composite rate index 444 that is greater than one notifies a user of the TLMS system 10 that the actual labor cost was under budget.

Referring next to FIG. 18, the specific method of calculating the labor efficiency index 450 is generally disclosed. The TLMS system 10 inputs the work package productivity index 429 and also inputs the work package composite rate index 444 in order to perform a seventh calculation 452 whereby the work package productivity index 429 is multiplied by the work package composite rate index 452. The resulting labor efficiency index 454 is outputted to a back office 20 dashboard. The labor efficiency index provides a useful tool for evaluating the impact of labor cost versus productivity. A work package can have high labor cost and high productivity, high labor cost and low productivity, low labor cost and high productivity, and low labor cost low productivity. Whatever the combination, a labor efficiency index 454 of less than one indicates the work is being performed at a labor cost less than was estimated and a labor efficiency index 454 of greater than one indicates the work is being performed at a labor cost that exceeds the estimate of the work package 212.

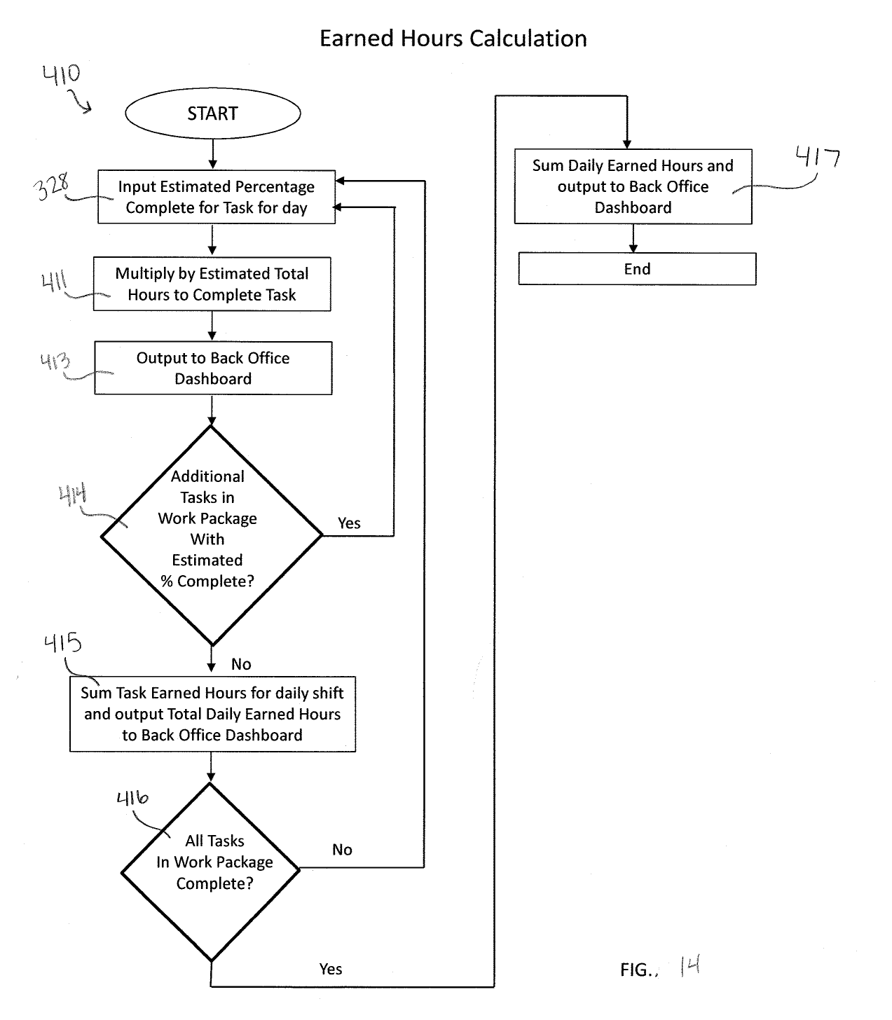

Referring next to FIG. 19, the specific method of calculating the schedule reliability 460 is generally disclosed. The process of calculating the schedule reliability 460 begins with the completion 461 of a work package 212 and the frontline supervisor answering the inquiry of whether the work package 212 was completed as planned 462. If the work package 212 was completed as planned the TLMS system 10 assigns a value 463 “1” to the work package 212. If the work package 212 was not completed as planned, the TLMS system 10 assigns a value 463 “0” to the work package 212. If the project is not complete, another work package 212 is completed 468 and is ultimately assigned a value 463 of either “1” or “0” until the project is completed and all work packages 212 are constructed.

Upon completion of the project, the TLMS system 10 performs an eighth calculation 464 whereby the TLMS system 10 averages the assigned values 463 for the work packages 212 and then outputs the resulting schedule reliability 466 to a back office 20 dashboard. It is to be appreciated by those skilled in the art that the TLMS system 10 also can also save assigned values 463 for a particular type of work package 212, such as concrete foundation, and the TLMS system can then calculate schedule reliability of a particular type of work package 212 over the course of multiple projects.

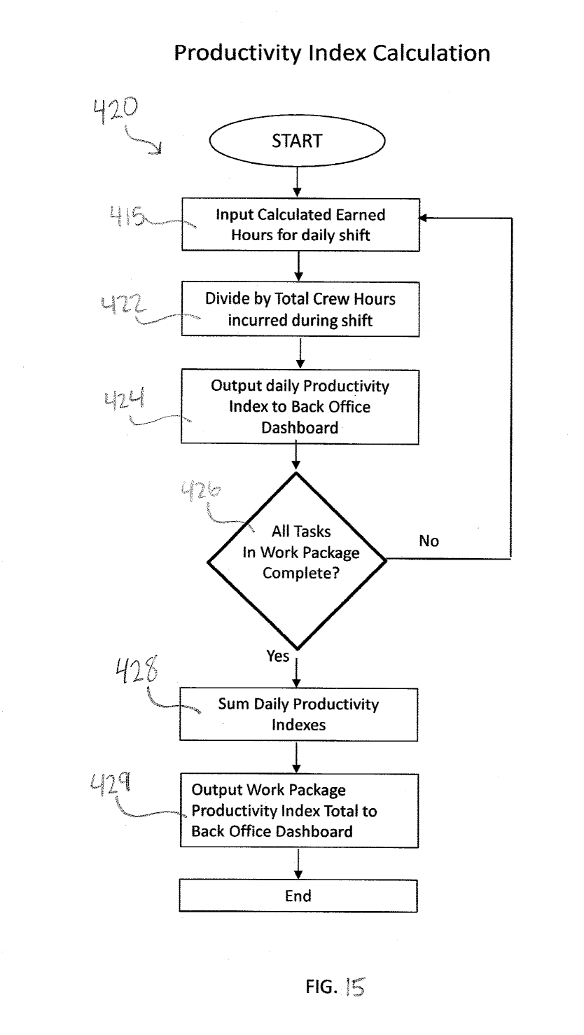

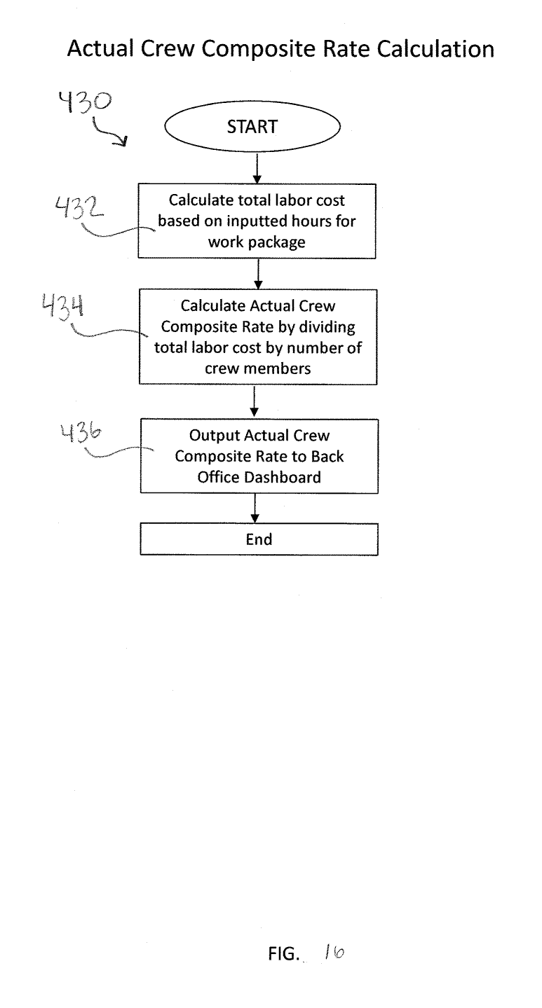

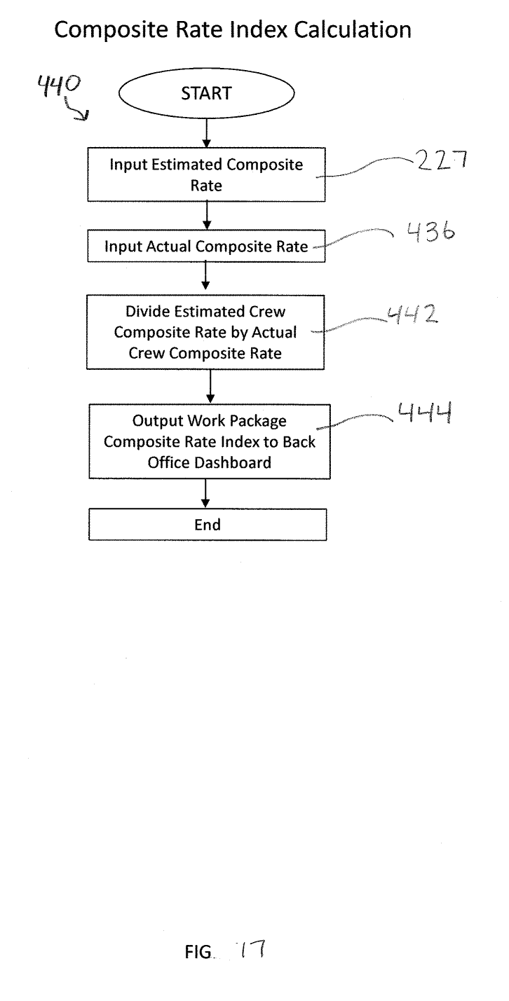

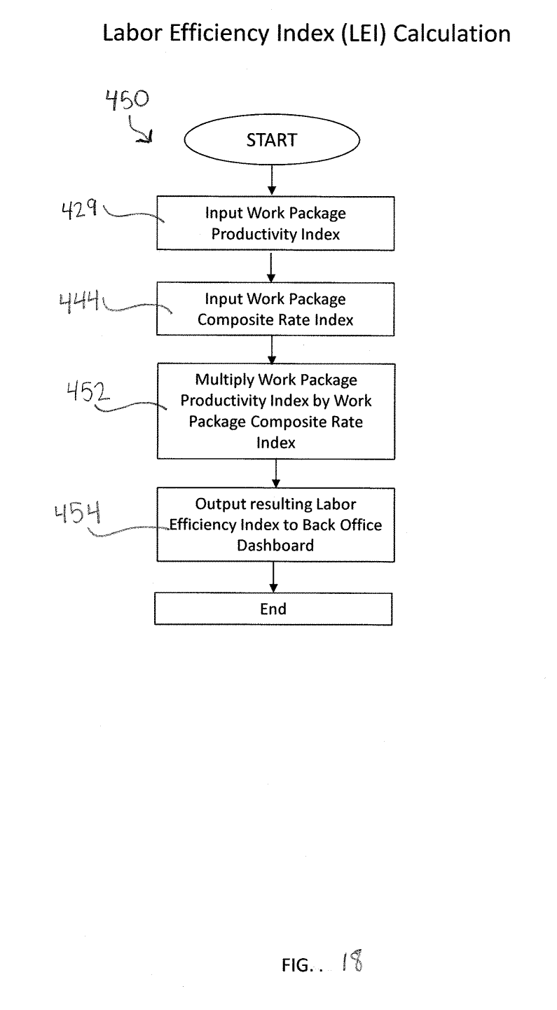

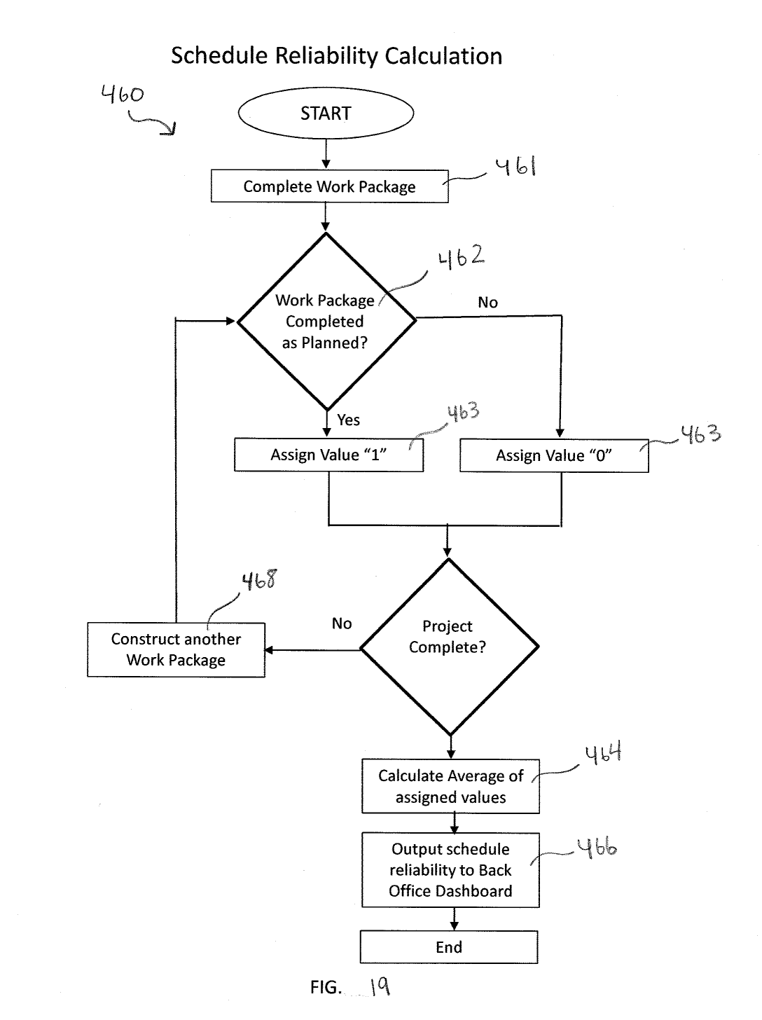

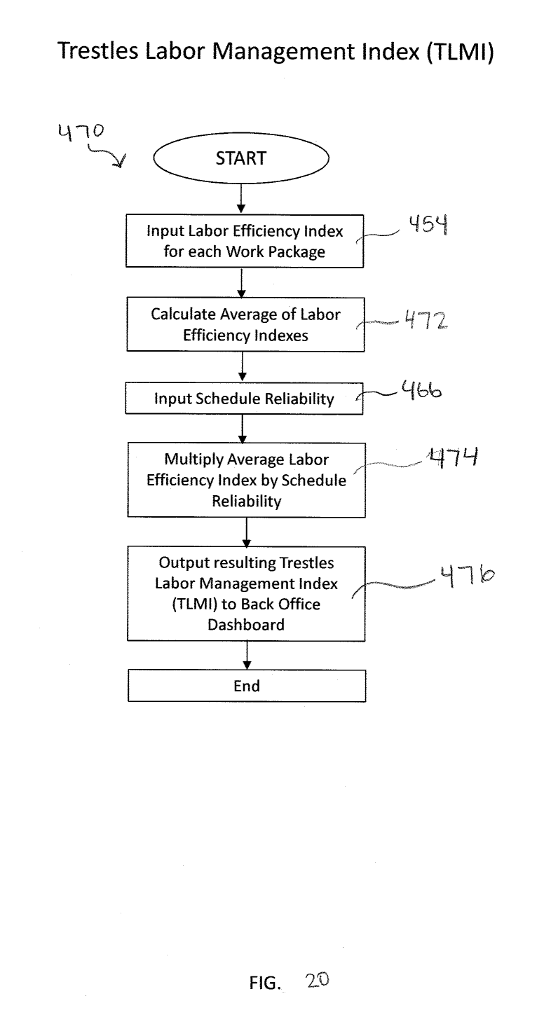

Referring next to FIG. 20, the specific method of calculating the Trestles Labor Management index (TLMI) 470 is generally disclosed. The TLMS system 10 inputs the labor efficiency index (LEI) 454 for each work package and then performs a ninth calculation 472 whereby an average labor efficiency index LEI is calculated for the project. The TLMS system 10 then inputs the schedule reliability 466 and performs a tenth calculation 474 whereby the aggregate labor efficiency index 454 is multiplied by the schedule reliability 466 resulting in the Trestles Labor Management index 470. The resulting Trestles Labor Management index 470 is outputted 476 to a back office dashboard.

The Trestles system 10 stores the TLMI 470 for each project to enable easy comparison of the various TLMI 470 to evaluate impact of specific changes to project estimating, project planning, and project construction on the TLMI 470, with a company objective of always seeking to increase a TLMI 470. The higher the TLMI 470, the more a company knows it is improving its overall construction activities as a function of timeliness, productivity, and budget.

The TLMS system 10 also performs frontline supervisor performance calculations. The frontline supervisor performance calculations include a frontline supervisor reliability rate 480 and a frontline supervisor ranking 490.

Referring next to FIG. 21, the specific method of calculating the frontline supervisor reliability rate 480 is generally disclosed. The TLMS system 10 first inputs the total number of work packages performed 482 by a frontline supervisor. The TLMS system 10 next inputs the total number of work packages performed by the frontline supervisor as planned 484. The TLMS system 10 then performs an eleventh calculation 486 whereby the total number of work packages performed as planned 484 is divided by the total number of work packages performed 482 resulting in the frontline supervisor reliability rate 480. The supervisor reliability rate 480 is then outputted 488 to a Back Office 20 dashboard.

Referring next to FIG. 22, the specific method of calculating the frontline supervisor ranking 490 is generally disclosed. First, the TLMS system 10 imports the total number of work packages performed by a frontline supervisor 491. Next, the TLMS system 10 imports the labor efficiency index 454 for each work package performed by the frontline supervisor 492. Next, the TLMS system 10 performs a twelfth calculation 493 whereby the TLMS system 10 calculates aggregate labor efficiency index by multiplying the sum of total earned hours divided by actual hours with the sum of estimated composite rate 227 divided by actual composite rate 436.

Next, the TLMS system 10 inputs the supervisor reliability rate 488 and performs a thirteenth calculation 494 whereby the TLMS system 10 multiplies the aggregate labor efficiency index calculated in step 493 by the supervisor reliability rate 488 resulting in a supervisor ranking score 495 that is outputted to a back office dashboard.

Next, the TLMS system 10 performs step 496 by repeating steps 491 through 495 for each frontline supervisor in the company. The TLMS system 10 then ranks 497 the frontline supervisors by their respective supervisor ranking score 495 and outputs the resulting supervisor ranking 498 to a back office dashboard. Utilizing the WBS filtering functionality 716 frontline supervisors can be ranked overall, by the organizational unit they are assigned to, by project, or by their discipline.

The TLMS system 10 provides a unique frontline dynamic user interface graphic 600 to encourage the frontline supervisor to fully perform the frontline system inputs 320 during construction of work packages 212.

Referring next to FIG. 23, the setup process of the frontline dynamic user interface graphic 600 is generally shown. The frontline system 80 enables the frontline supervisor to link a specific project, and the work packages within the project that are assigned to the frontline supervisor, to a dynamic user interface graphic 600. The dynamic user interface graphic 600 adjusts with percentage of project and work package completion. The frontline supervisor uses the frontline system 80 to select a specific dynamic user interface graphic 604 from the dynamic user interface graphic list 620. The specifically selected dynamic user interface graphic 604 will adjust with project completion. Next, the frontline supervisor uses the frontline system 80 to select a specific work package 608 and then selects a specific dynamic user interface graphic 610 for the specifically selected work package 608. The TLMS system 10 will query whether all work packages assigned to the frontline supervisor have been a dynamic user interface graphic 630. If not, then the TLMS system 10 will prompt the frontline supervisor to continue to select dynamic user interface graphic 600 for each work package 212 assigned to the frontline supervisor.

The dynamic user interface graphics list 620 includes a variety of dynamic user interface graphics 600. The dynamic user interface graphics 600 are designed to be visually interesting and replicate a game like interface making use of the frontline system 80 more entertaining for the frontline supervisor. The dynamic user interface graphics 600 can include dynamic scenes such as an Egyptian pyramid under construction, a dam under construction, a cube, or other dynamic scenes that could be continually created and added to the frontline system 80.

Referring next to FIG. 24, the operation process of the frontline dynamic user interface graphic 600 is generally shown. Upon completion of a shift 640 for a work package 212, the frontline supervisor simply inputs the required information into the frontline system 80, including the total crew hours 324 for the shift and the estimated percentage completed on each task in the shift 328. The TLMS system 10 then calculates the work package percentage complete 650 and then adjusts the dynamic user interface graphic 600 based on the work package percentage complete 660. The TLMS system 10 calculates and displays on the dynamic user interface graphic 600 the planned percent complete for the corresponding time frame to enable the frontline supervisor to compare against the actual percent complete. The TLMS system 10 also calculates and displays on the dynamic user interface graphic 600 the current productivity related to the relevant work package 212 in progress. As set forth more fully in connection with FIGS. 25 through 90 below, for each dynamic user interface graphic 600 stored in the TLMS system 10, a series of sequential dynamic user interface graphics are also stored in the TLMS system 10, wherein each sequential user interface graphic is linked to a specific percentage of completion.

Referring next to FIG. 25, a desktop view of the back office system 20 shows login screen 701, requiring an email address 702 and a password 703 in order to sign in 704 thereby allowing access to the back office system 20 of the TLMS system 10.

Referring next to FIG. 26, a partial desktop view of the back office system 20 shows the project leader 705 who has special access to a setup and configuration menu 680, the selection of which enables a user to begin the setup and configuration process 100.

Referring next to FIGS. 27 and 28, upon selection of the configuration menu 680, the TLMS system 10 displays setup and configuration tabs, including an employee position classifications tab 681. The selection of the employee position classifications tab 681 causes the back office system 20 to display classifications of employee positions, including level 681(a) and position 681(b) of the various employee classifications contemplated as necessary in a construction company. Level [sp] 681(a) includes inputs such as level I, level II, level III, etc. Position 681(b) includes inputs such as general foreman, foreman, leadman, surveyor, operator, carpenter, ironworker, etc. A user simply selects new item 682 in order to create a new employee classification whereby the user will be prompted to enter a level 681(a) and a position 681(b) for the newly created employee classification. The creation of employee classifications occurs during the setup and configuration process 100.

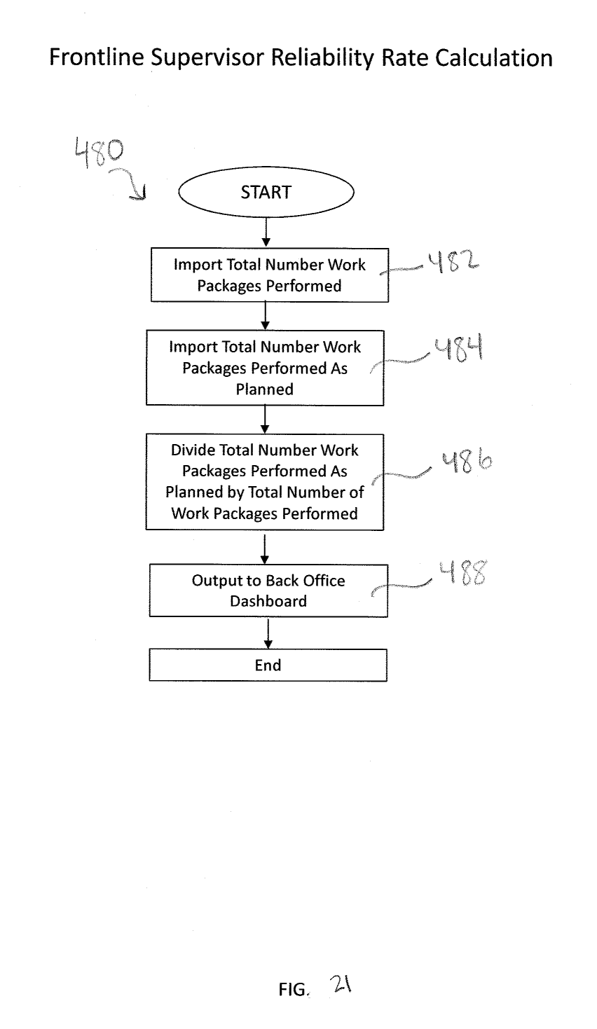

Referring next to FIG. 29, the training and certifications tab 683 of the setup and configuration menu is shown selected thereby causing the back office system 20 to display classifications of employee training and certifications, including category 683(a) and training/certification 683(b). Category 683(a) includes inputs such as safety, craft training, technical certifications, licenses, and safety. Training/certifications 683(b) includes inputs such as OSHA 4.0 hr., OSHA 10 hr., union apprenticeship, master electrician, etc. The selection of new item 683(c) enables the creation additional classifications of employee training and certifications to be inputted by the user. The creation of classifications of employee training and certifications occurs during the setup and configuration process 100.

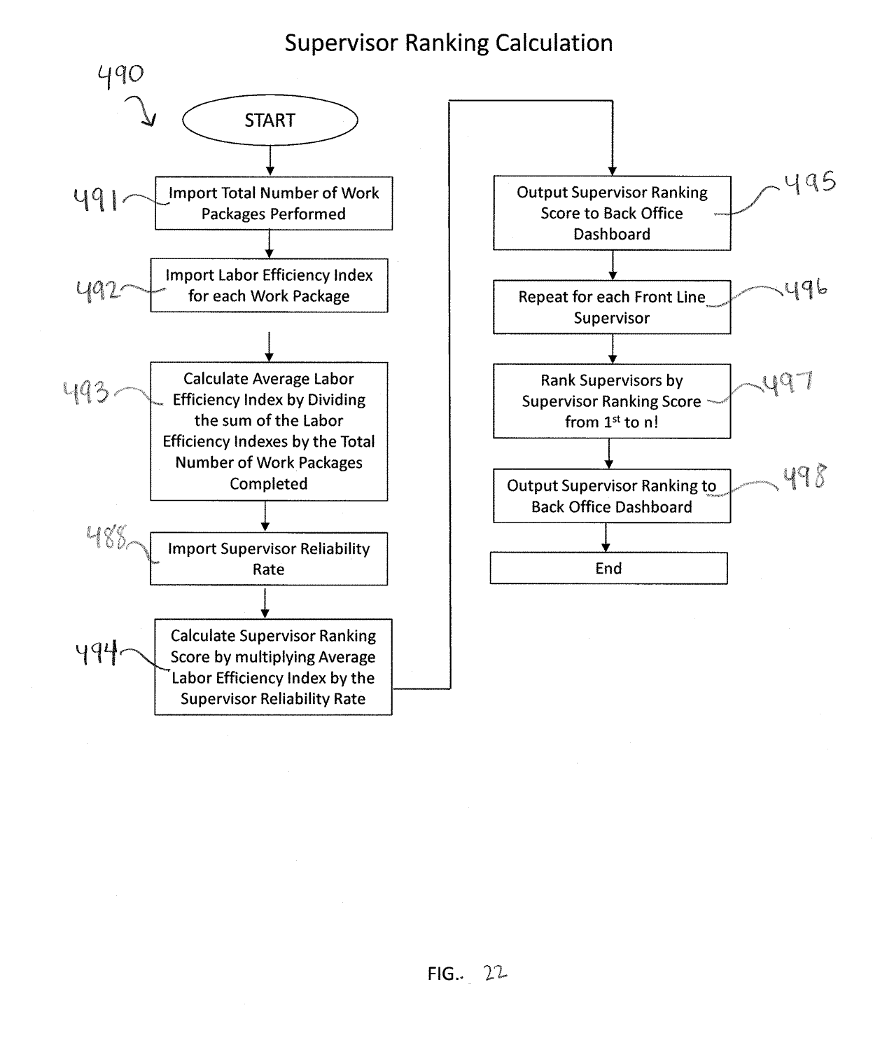

Referring next to FIG. 30, the standard hazards and mitigation tab 684 of the setup and configuration tabs is shown selected thereby causing the back office system 20 to display classifications of standard hazards 684(a) and mitigation options 684(b). Standard hazards 684(a) includes inputs such as falling objects, pinched fingers, back injuries, etc. Mitigation options 684(b) includes inputs such as correct use of PPE, restrict access to danger areas, maintain proper communication, etc. The selection of new item 684(c) enables the creation additional classifications of standard hazards 684(a) and mitigation 684(b) to be inputted by the user. The creation of classifications of standard hazards 684(a) and mitigation 684(b) occurs during the setup and configuration process 100.

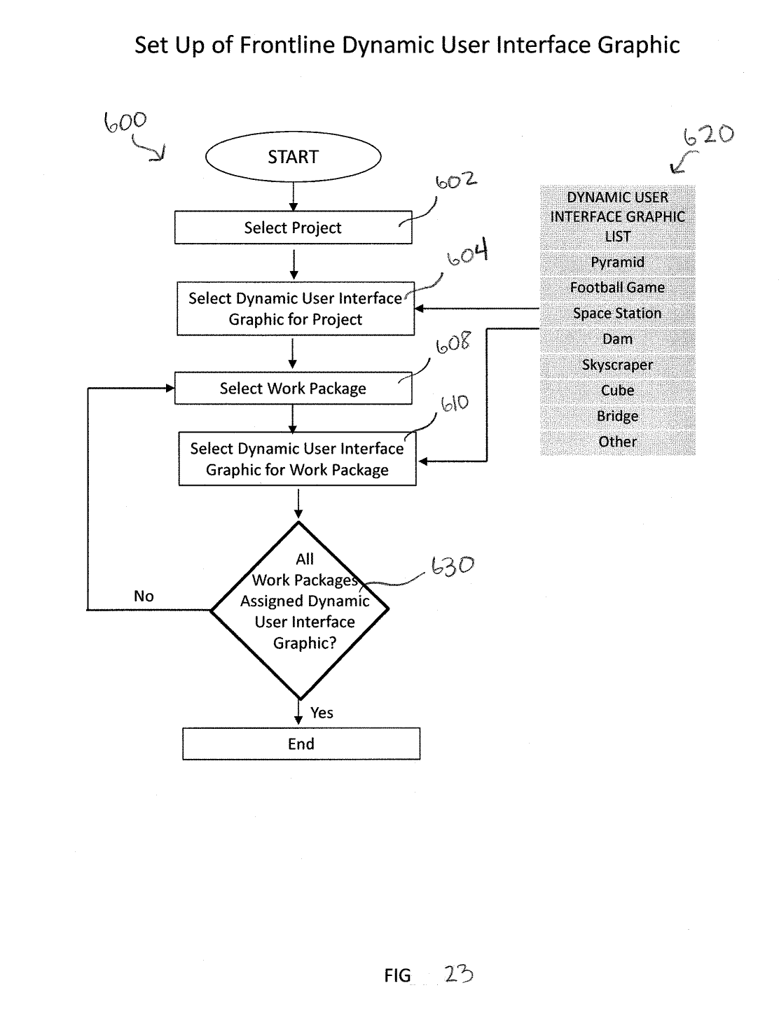

Referring next to FIG. 31, the client critique performance categories tab 685 of the setup and configuration menu is shown selected thereby causing the back office system 20 to display classifications of performance categories 685(a). Performance categories 685(a) includes inputs such as safety, quality, schedule, and professionalism. The selection of new item 685(b) enables the creation of additional classifications of client critique performance categories 685(a) to be inputted by the user. The creation of client critique performance categories 685(a) occurs during the setup and configuration process 100.

Referring next to FIG. 32, the schedule slippage reasons tab 686 of the setup and configuration menu is shown selected thereby causing the back office system 20 to display classifications of schedule slippage reasons 686(a). Schedule slippage reasons 686(a) include inputs such as engineering, material, equipment, rework, re-assignment, workload and permits. The selection of new item 686(b) enables the creation of additional classifications of schedule slippage reasons 686(a) to be inputted by the user. The creation of classifications of schedule slippage reasons 686(a) occurs during the setup and configuration process 100.

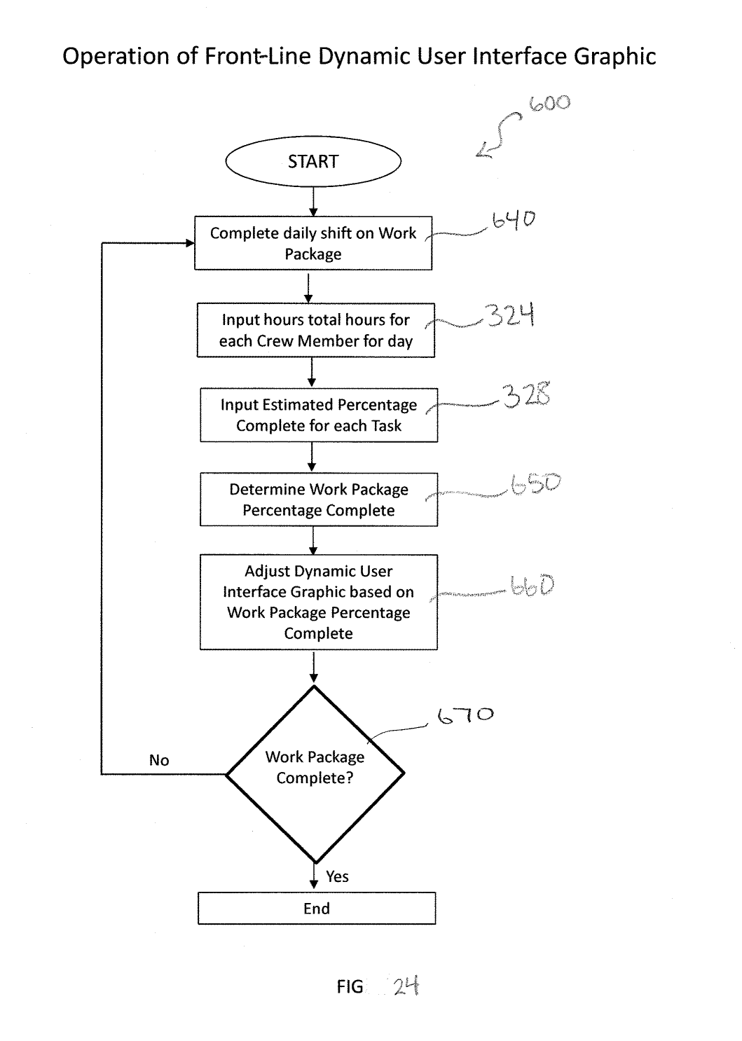

Referring next to FIG. 33, the sync tab 687 of the setup and configuration menu is shown selected thereby causing the back office system 20 to display synchronization fields 687(a). Synchronization fields 687(a) include data fields such as employee information, employee position classifications, employee position, training and certifications, crews, WBS, and estimate. Each synchronization field 687(a) can be turned on or off by the user. A synchronization field 687(a) that is turned on will synchronize the data associated with the field with a third party construction management system that also utilizes the data field. The selection of new item 687(b) enables the creation of additional synchronization fields 687(a) to be inputted by the user. The creation and selection of synchronization fields 687(a) to be synchronized with a third party construction management system can occur at any time. However, only an authorized user, such an administrator or project leader has access to the sync tab 687.

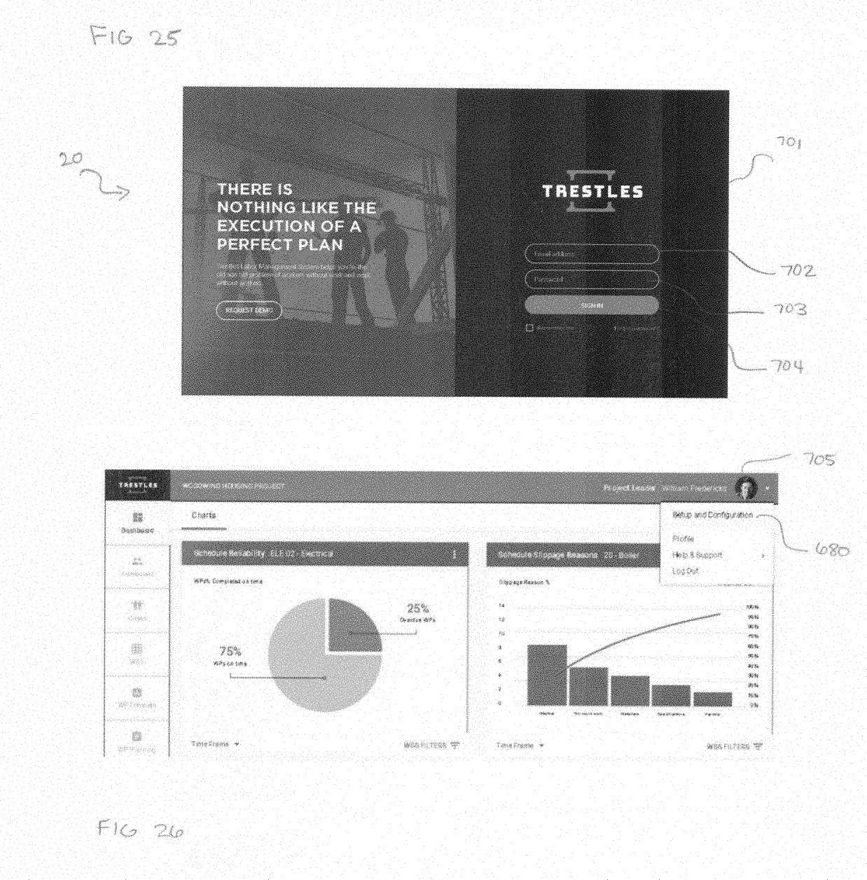

Referring next to FIG. 34, the cost codes library tab 688 of the setup and configuration menu is shown selected thereby causing the back office system 20 to display classifications of cost codes, including name 688(a), cost code 688(b), and description 688(c).

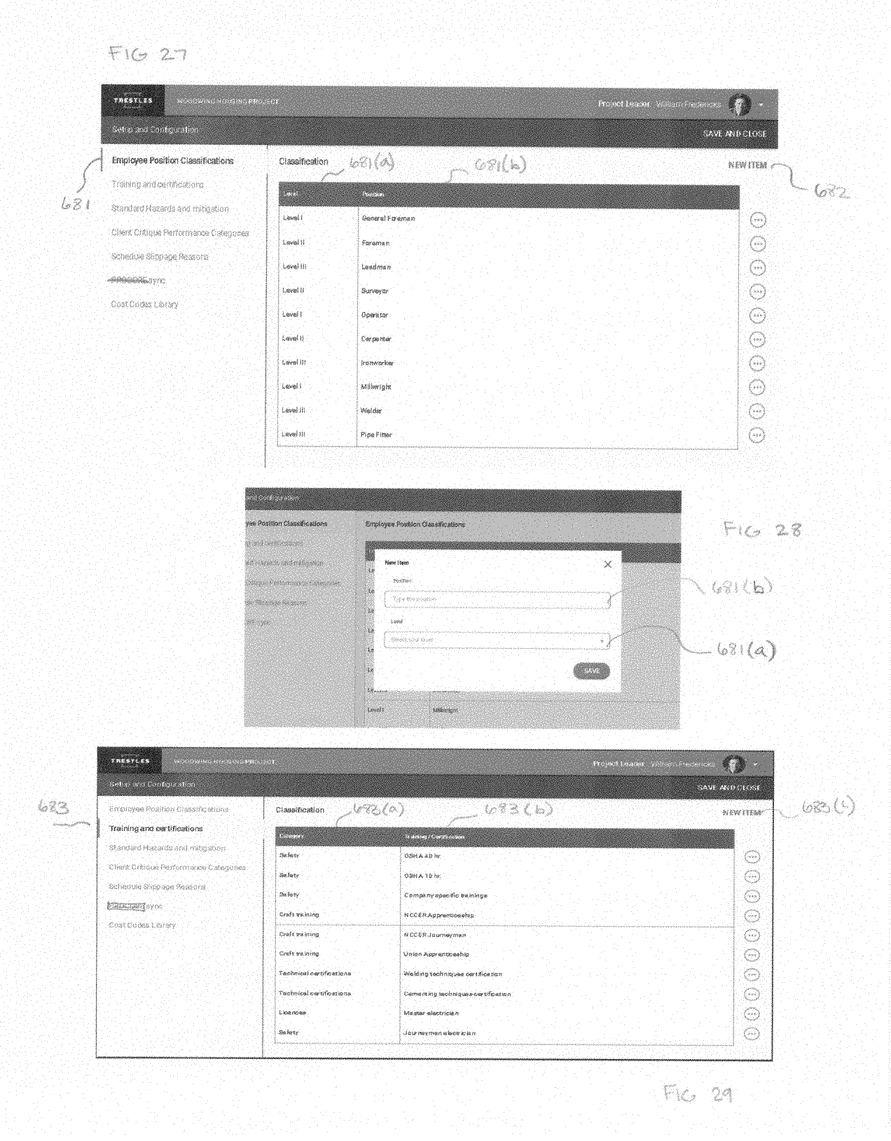

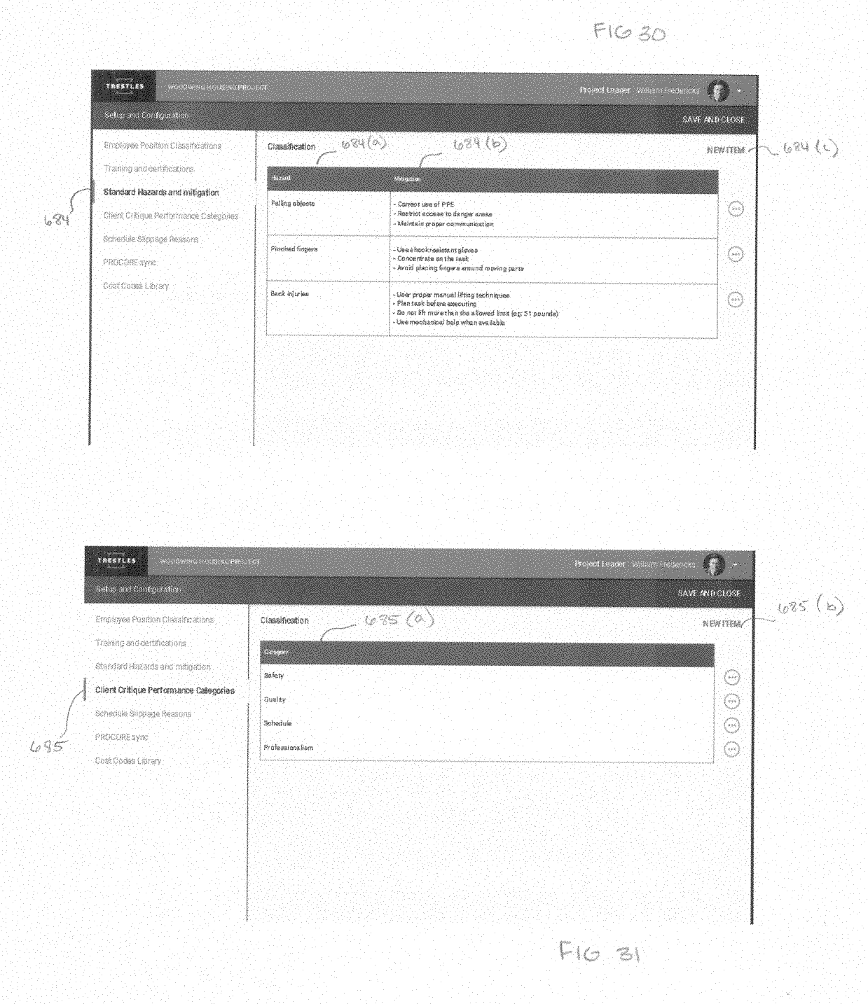

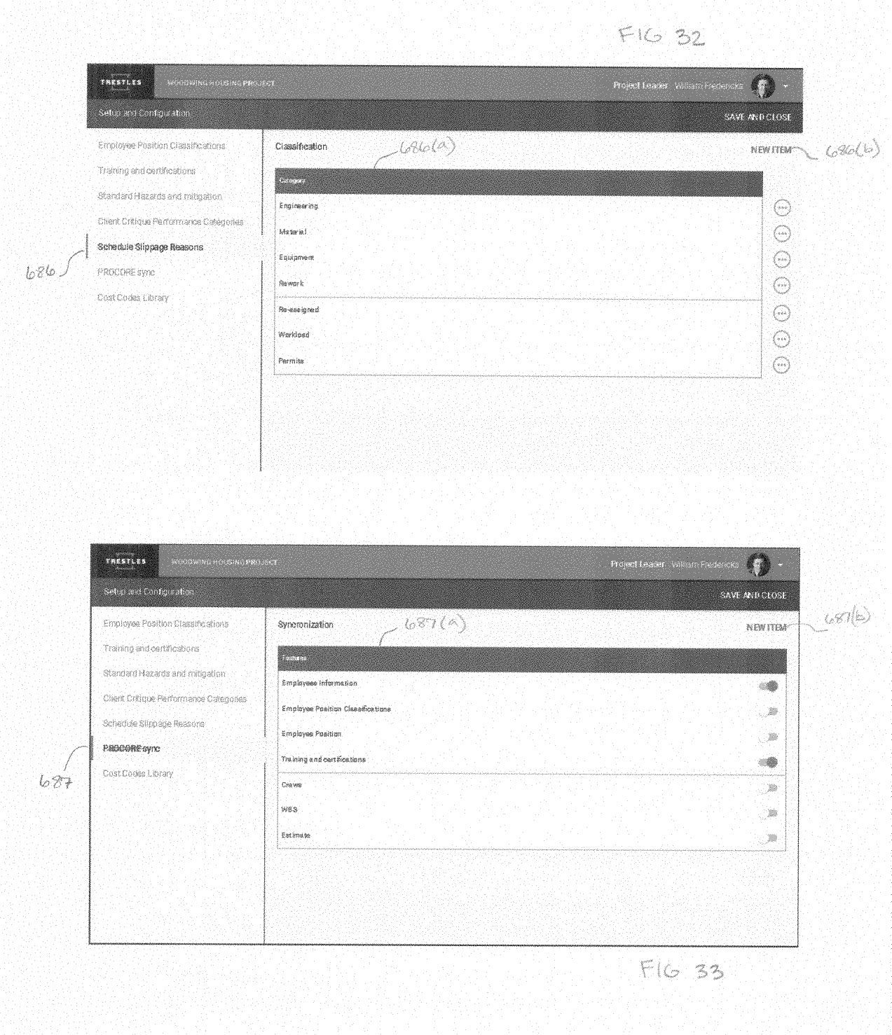

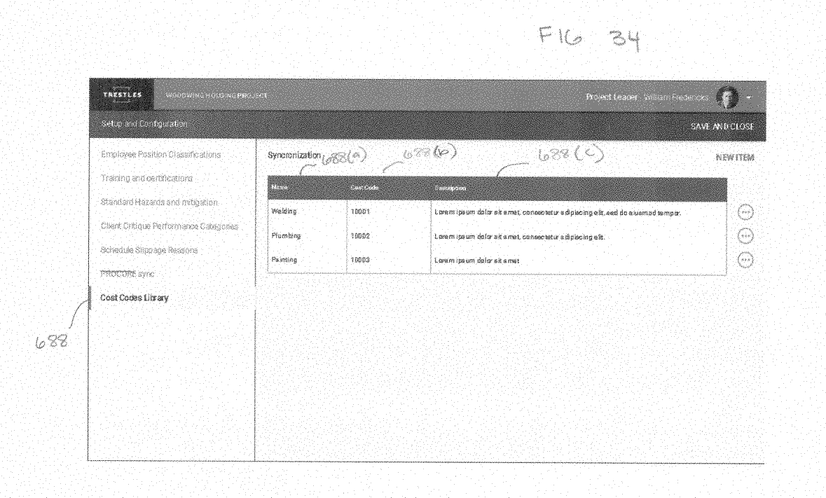

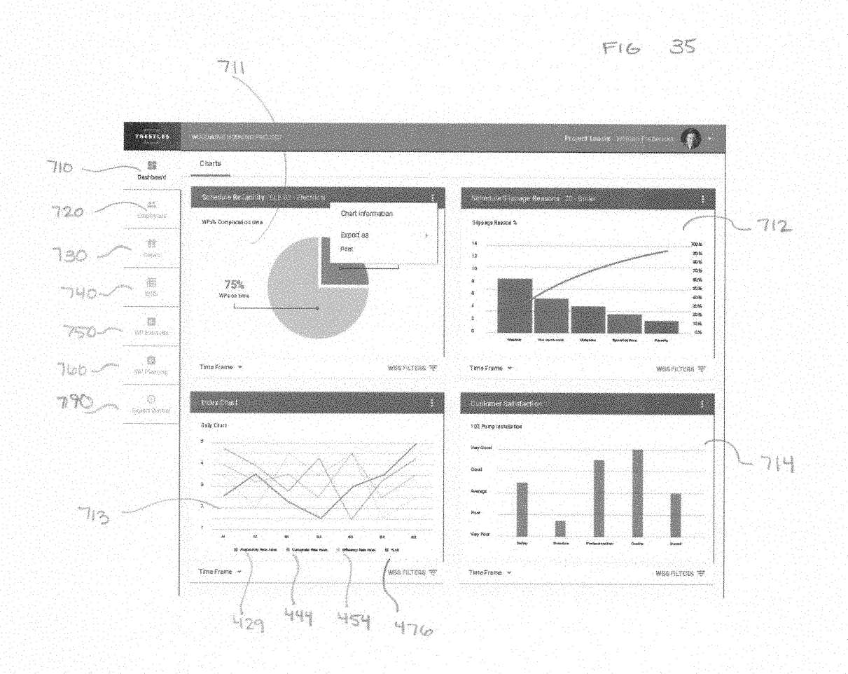

Referring next to FIG. 35, a desktop view of the back office system 20 shows a dashboard tab 710, an employees tab 720, a crews tab 730, a WBS tab 740, a WP Estimate tab 750, a WP Planning Tab 760 and a report central tab 790 with the dashboard tab 710 selected.

The selected dashboard tab 710 shows a schedule reliability chart 711 for the discipline “ELE 02 electrical.” The schedule reliability chart 711 demonstrates that 75% of the work packages completed by the discipline “ELE 02 electrical” were completed on time as planned.

The selected dashboard tab 710 also displays a schedule slippage reasons 712 for a work package entitled “20-Boiler” and provides a percent occurrence of the various reasons for schedule slippage including weather, too much work, materials, specifications and permits.

The selected dashboard tab 710 also displays an index chart 713 plotting productivity rate index 429, composite rate index 444, labor efficiency index (LEI) 454, and Trestles Labor Management index (TLMI) 476 over time.

The selected dashboard tab 710 also displays a customer satisfaction chart 714 for a work package entitled “102 pump installation.”

Referring next to FIGS. 36 and 37, a WBS filter 716 is shown for the schedule reliability chart 711 shown in FIG. 35. The WBS filter 716 enables filtering through the various WBS segments in order to create schedule reliability charts 711 at various segment levels, including work package, area, phase, project, and organizational unit.

Referring next to FIG. 38, a desktop view of the back office system 20 shows the employees tab 720 selected and displaying employee records 120. The employees tab 720 of the back office system 20 enables a user to search for employees 721, select options 722, and create a new record 723. Options 722 include for each employee the editing of a record 724, the exporting of a record 725, and the deletion of a record 726. Under training and certifications, the TLMS system 10 user can select a training record 727 in order to review additional details for the selected training record 727.

Referring next to FIG. 39, the selected training record 727 for “Joe Smith” is shown selected with specific information related to the training record, including training name or certification 727(a), issuing entity 727(b), date of issuance 727(c), duration 727(d), type 727(f), and expiration date 727(g).

Referring next to FIG. 40, a desktop view of the back office system 20 shows the crews tab 730 selected with the TLMS system 10 showing a list of crews 731 and for each crew displaying a unique crew id number 732, a crew discipline 733, a list of crew members 734, the frontline supervisor for the crew 735, the jobs assigned to the crew 736, the composite base rate for the crew 737, and the composite premium rate for the crew 738. The crews tab 730 interface has a create crews 739 link that enables a user to create a new crew and populate fields 733 through 739 for the newly created crew. Further, a user can simply edit any field 733 through 739 through the selection of a particular field for a particular crew.

Referring next to FIG. 41, a desktop view of the back office system 20 shows the WBS tab 740 selected with the TLMS system 10 showing the WBS composer 741 with a custom selected WBS 110 for a specific company. The WBS composer 741 shows a hierarchy interface 742 with the various segments of the WBS 110 whereby the user may select the applicable hierarchy 742 for a company or specific project. The WBS composer 741 also shows a WBS chart 743 which is a graphical representation of the selections made using the hierarchy interface 742. The WBS composer 741 also enables the user to add an item 744.

Referring next to FIG. 42, the add item menu 746 is shown after a user selected the add item 744 shown in FIG. 41. The add item menu 746 enables a user to add additional segments into WBS 110.

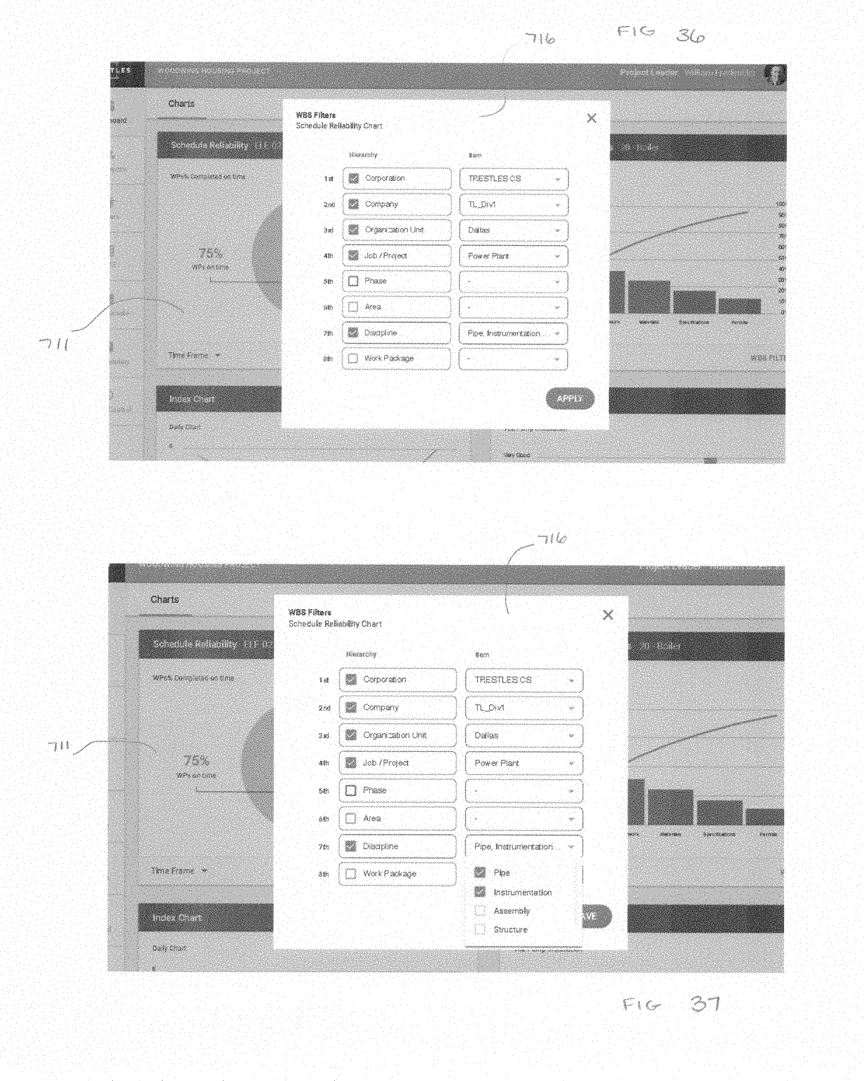

Referring next to FIG. 43, a desktop view of the back office system 20 shows the WP estimate tab 750 selected with the TLMS system 10 showing the WP estimate summary 751 with a list of estimated work packages 753. For each work package 212 in the list of estimated work packages 753, fields are populated for work package id number 753(a), work package description 753(b), estimated man hours 753(c), estimated budget 753(d), planned budget 753(e) and variance 753(f). The work packages 212 populated in the list of estimated work packages 753 is controlled by WBS filter 752. The process of project planning 200 begins with selecting the WP estimate tab 750. Once selected, the process of work package estimating 210 can be formed by selecting create estimate 754.

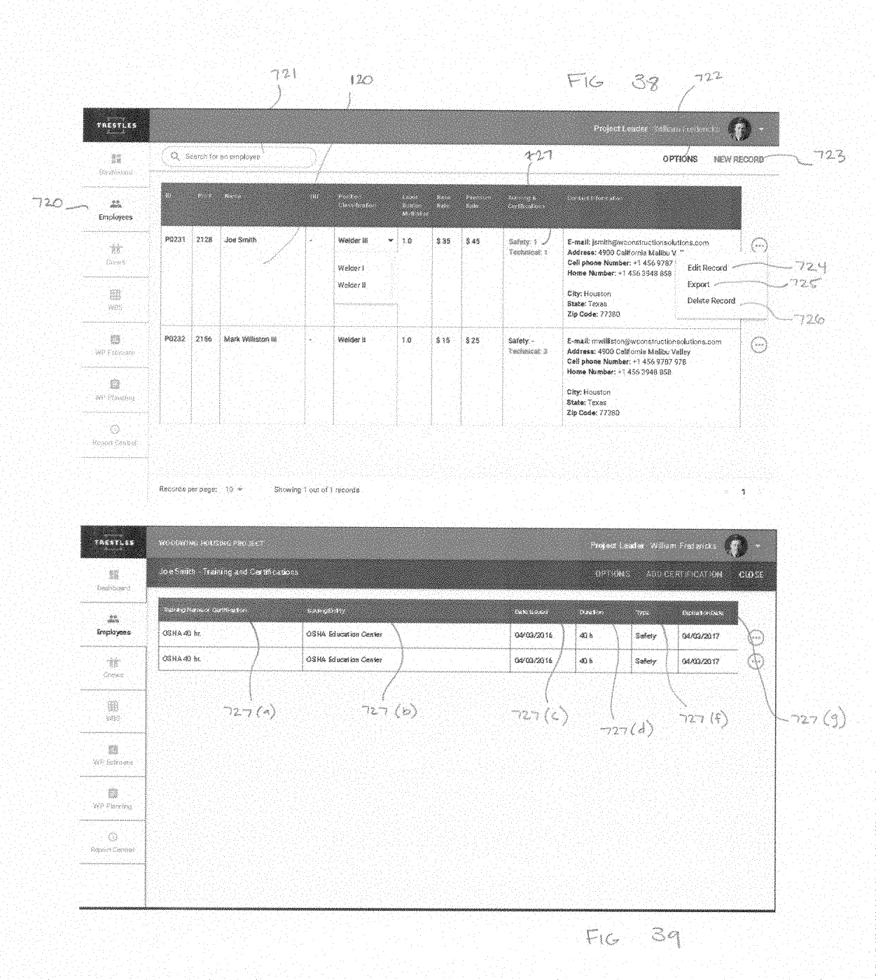

Referring next to FIG. 44, the estimate calculator 755 is displayed by the back office system 20 upon selection of create estimate 754. The estimate calculator 755 automatically creates the WP ID# 753(a), which in FIG. 44 is shown as “105”. The work package description 753(b) is then entered, which in FIG. 44 is shown as “Pump Foundation.” Next the user selects add new task 756 in order to create the various tasks 215 that need to be performed in connection with the work package 212 being estimated. Tasks 215 for the work package 212 shown are mobilization, stage materials, survey/lay-out, excavation, form & strip, rebar, anchor blts., 2″ conduit, 6″ conduit, place & finish, backfill, and punch lists/de-mob. For each task 215 added to the work package 212, a variety of task inputs 757 are required, including task name 757(a), cost code 757(b), quantity 757(c), unit of measurement 757(d), unit/man hours 757(e), man hours 757(f), weighted % 757(g), bid composite base rate 757(h) and estimated budget 757(i). The process of making task inputs 757 is performed during the work package estimating 210 process.

Referring net to FIG. 45, the newly created work package 212 for the pump foundation is shown as work package 212 “#105” in the list of estimated work packages 753.

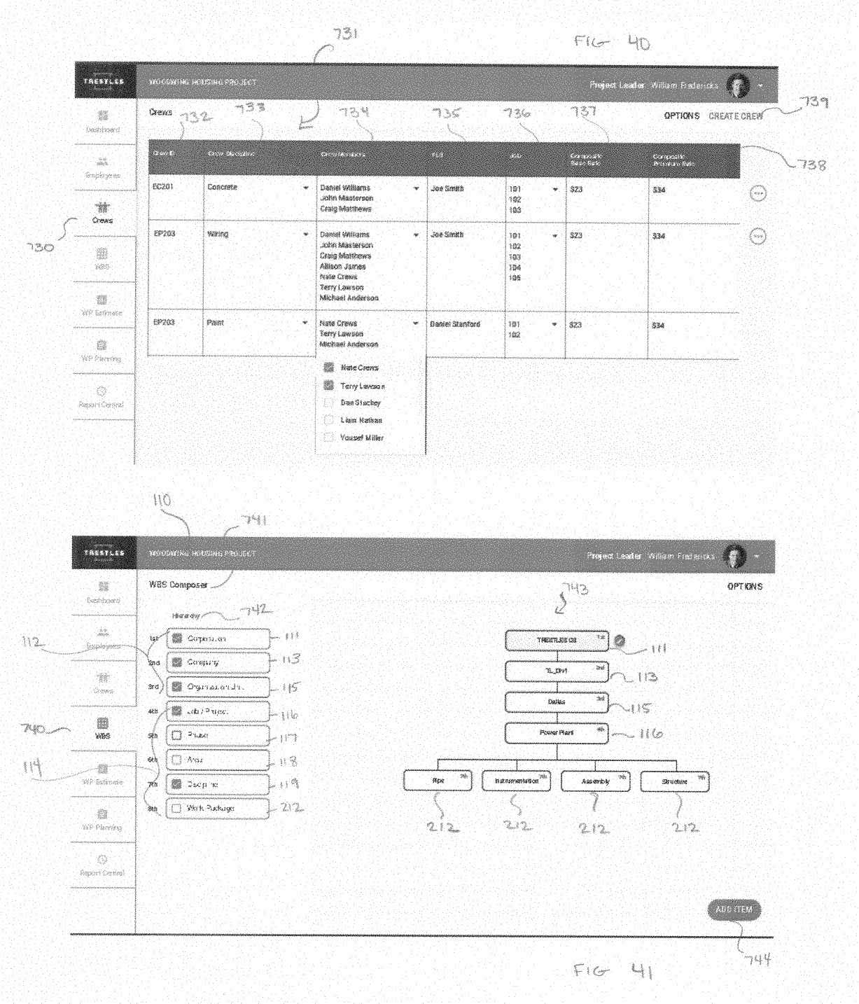

Referring next to FIG. 46, a desktop view of the back office system 20 shows the WP planning tab 760 selected with the TLMS system 10 showing a list of work packages 761. For each work package 212 in the list of work packages 761, fields are populated for work package id number 762, work package description 763, work package schedule 764 with start date and end date information, actual completion date 765, the total estimated man hours for the work package 766, the assigned crew for the work package 767, the short interval schedule checklist 768, the constraints checklist 769, the daily JSA 770 and the work package status 771.

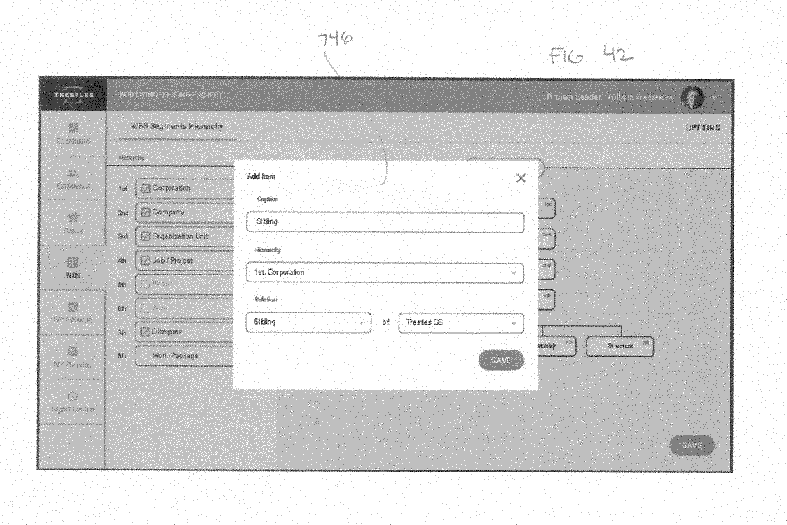

Referring next to FIG. 47, after a user in the back office system 20 selects a specific work package 212 from the list of work packages 761, the user accesses a user interface with additional tab selections. FIG. 47 shows the WP setup tab 772 selected resulting in an interface including inputs for work package hierarchy 773, work package id 774, work package timing 775, and work package tracking 776. The inputs 773 through 776 are typically filled in during the work package setup 230 process.

The work package hierarchy inputs 773 include the WBS segments set forth in connection with FIG. 41. The work package id 774 is typically automatically populated by the TLMS system 10 upon the creation of the work package 212 during the work package estimating process 210. The work package timing inputs 775 include the planned work package start date, planned work package end date, and total estimated man hours for the work package. The work package tracking input 776 enables the user to enable tracking of labor hours and cost codes at the work package level or the task level.

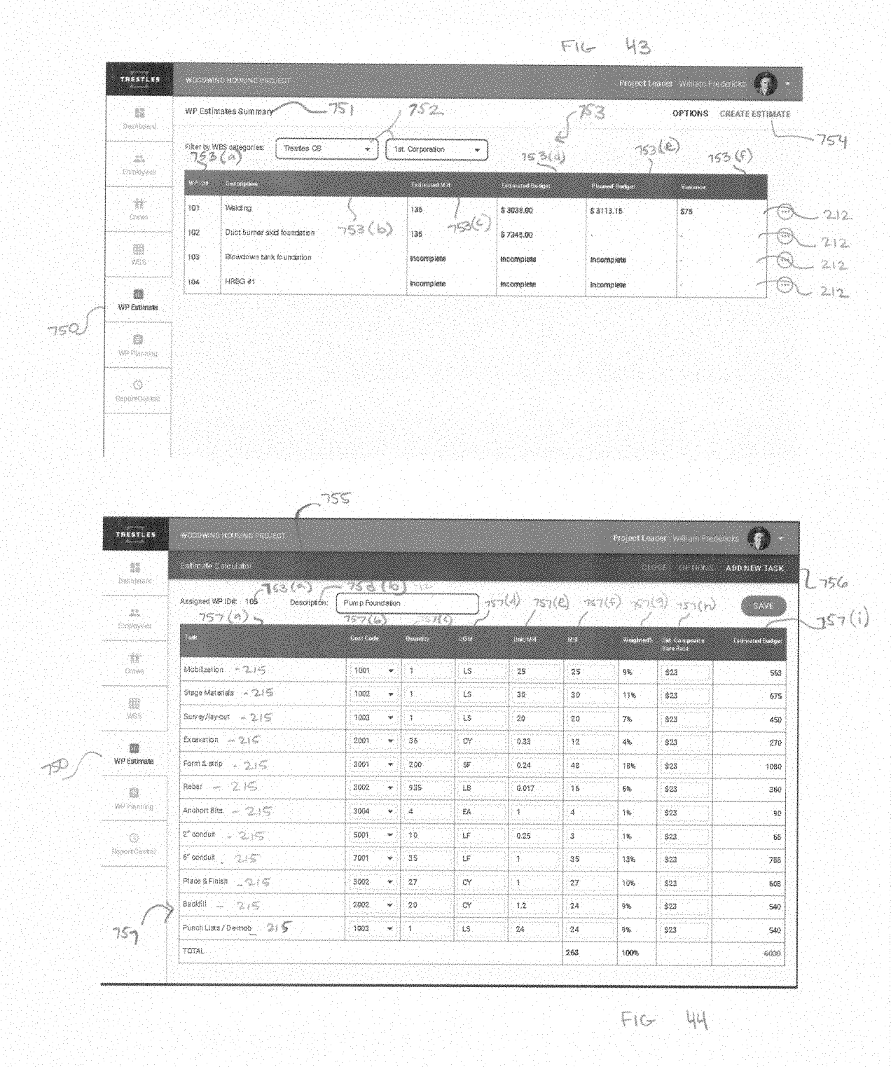

Referring next to FIG. 48, an automatic notification menu 777 is shown in connection with the work package hierarchy menu 773 and provides for the input of the parameters of the reminder, including date, time, description, means of reminding such as email or pop up message, the timing of the reminder and the frequency of the reminder.

Referring next to FIGS. 49 and 49A, the graphical interface for the short interval schedule (SIS) tab 778 is shown selected resulting in an interface for inputs crew assignments 779, selection of work schedule 780, and SIS task schedule 781. The crew assignments inputs 779 include fields for selecting a crew ID number 779(a), a crew description 779(b), a crew discipline 779(c), a frontline supervisor for the crew 779(d), and a list of crew members 779(e). Some of these selections are automatically populated by the TLMS system 10 by the simply completing the crew id number input 779(a). Inputting of the 779 fields typically occurs during the creation of the short interval schedule phase 240 of project planning 200.

The selection of work schedule 780 includes fields for selecting a shift 780(a), the workdays per week 780(b), and the hours to be worked for each shift 780(c). Inputting of the 780 fields typically occurs during the creation of the short interval schedule phase 240 of the project planning 200.

The SIS task schedule 781 includes input fields for all of the tasks 215 associated with the selected work package 212. Those input fields include task name 781(a), cost code 781(b), estimated man hours 781(c), weighted percentage 781(d), bid composite base rate or estimated composite rate 781(e), estimated cost 781(f), completion percentage 781(g) for each day scheduled for the work package 212, and the planned average crew size 781(h) for each day scheduled for the work package 212. Inputting of the 781 fields typically occurs during the creation of the short interval schedule phase 240 of the project planning 200.

Upon completion of the SIS task schedule 781 inputs, the TLMS system 10 displays various planning outputs 782 for each day scheduled for the work package 212, including daily progress plan 782(a), cumulative planned progress 782(b), planned earned daily hours 782(c), cumulative planned earned hours 782(d), planned hours per day 782(e), cumulative planned hours 782(f), planned daily productivity 782(g), planned cumulative productivity 782(h), planned crew composite rate 782(i), planned daily labor cost 782(j), planned cumulative labor cost 782(k), and variance 782(l). The variance 782(l) enables the project planner or project manager to immediate reliance whether or not the work package as planned 200 is within the work package estimate 210.

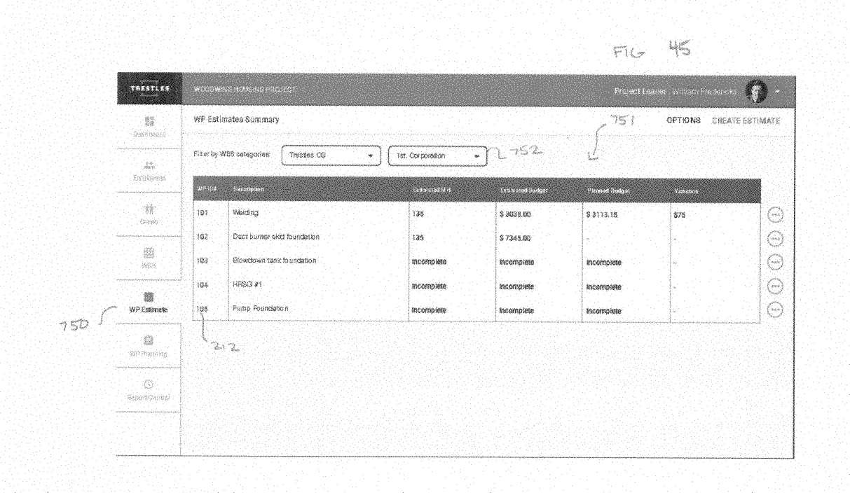

Referring next to FIG. 50, the graphical interface for the constraint checklist tab 783 is shown selected by a user, the selection resulting in an interface for the inputs action item 783(a), scope 783(b), responsible person 783(c), attachments 783(d), comments 783(e) and status 783(f). Action item 783(a) contemplates inputs such as scope of work, drawings, specification, etc. Scope 783(b) sets out the start date and the end date for removing the constraint. Responsible person 783(c) allows selection of a person that is assigned to remove or oversee the removal of the constraint. Attachments 783(d) allows for the attachment of relevant specific documents, such as plans, specification, RFI responses, etc., to be linked to the specific action item 783(a) comments 783(e) allows for the input of specific comments or instructions relating to the specific action item 783(a). Finally, the status 783(f) allows the status of the constraint action item 783(a) to be inputted, including whether or not the constraint action item 783(a) is active or completed. Inputting of the 783 fields typically occurs during the creation of the constraint checklist phase 250 of the project planning 200.

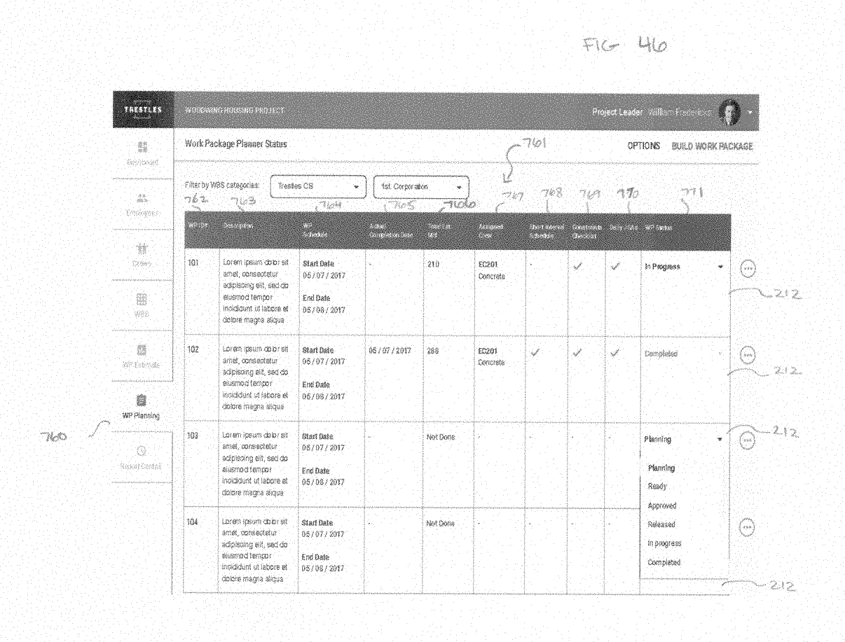

Referring next to FIG. 51, the graphical interface for the daily JSA tab 784 is shown selected by a user, the selection resulting in an interface for the inputs of selection of working day 784(a), tasks 784(b), activity steps 784(c), identified hazards 784(d), hazard mitigation 784(e), and the responsible person 784(f). Inputting of the 784 fields typically occurs during the job safety analysis planning phase 260 of the project planning 200.

Referring next to FIGS. 52, a desktop view of the back office system 20 shows the report central tab 790 selected with the TLMS system 10 showing a report central graphic interface whereby the user selects the type of report 791, the display criteria 792, and optionally filters the results by WBS categories 793. Types of reports 791 include labor management, work package status report, constraint checklist, short interval schedule, reliability report, schedule slippage report, frontline supervisor ranking report, frontline supervisor daily log, customer satisfaction survey and employee time log. Types of display criteria 792 include work package and cost code.

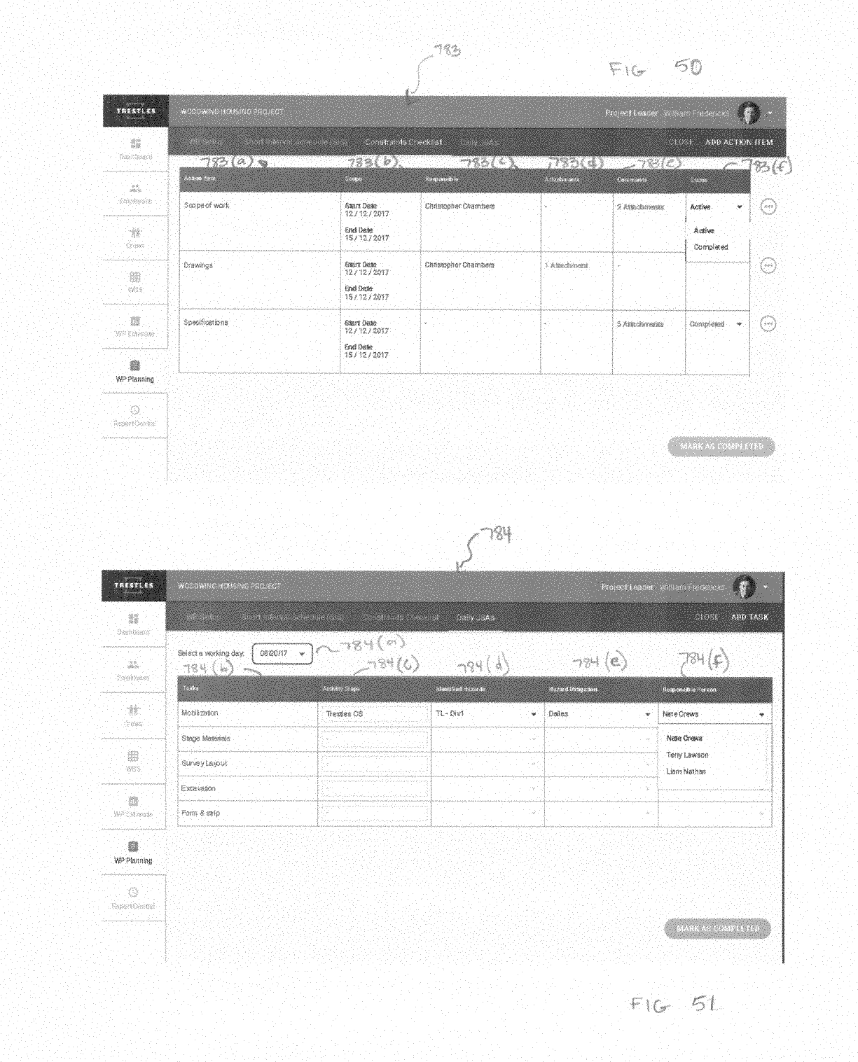

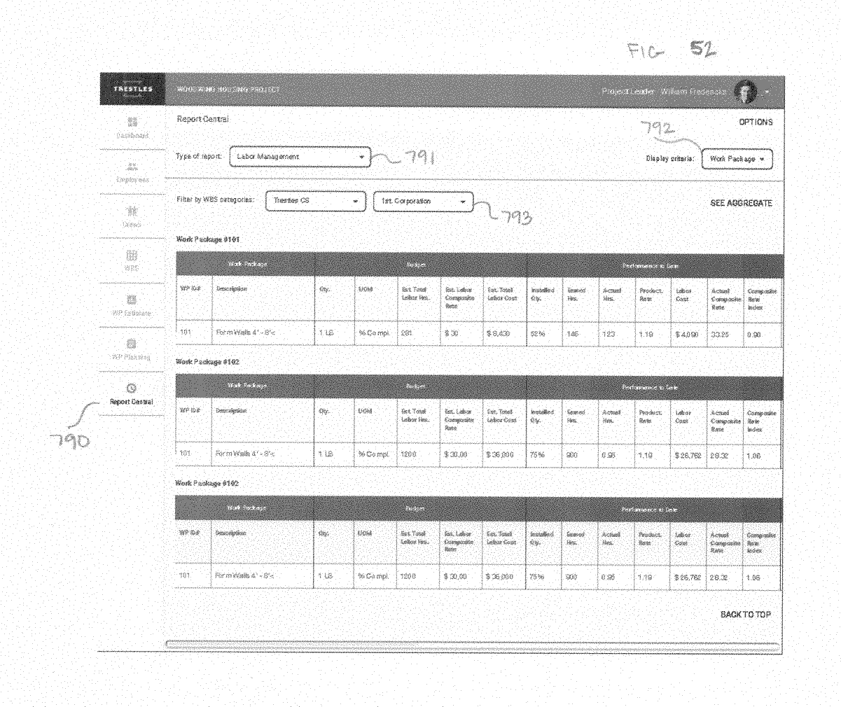

It is to be appreciated that some reports do not require filtering by WBS 793 while other reports do not require selection of a display criteria 792. For example, the work package slippage report shown in FIG. 57 does not require the selection of a display criteria, but does enable filtration by WBS categories. Other reports, such as the constraints checklist report show in FIG. 58 do not require either the selection of a display criteria 792 or filtration by WBS categories 793, but does require selection of a work package 794.

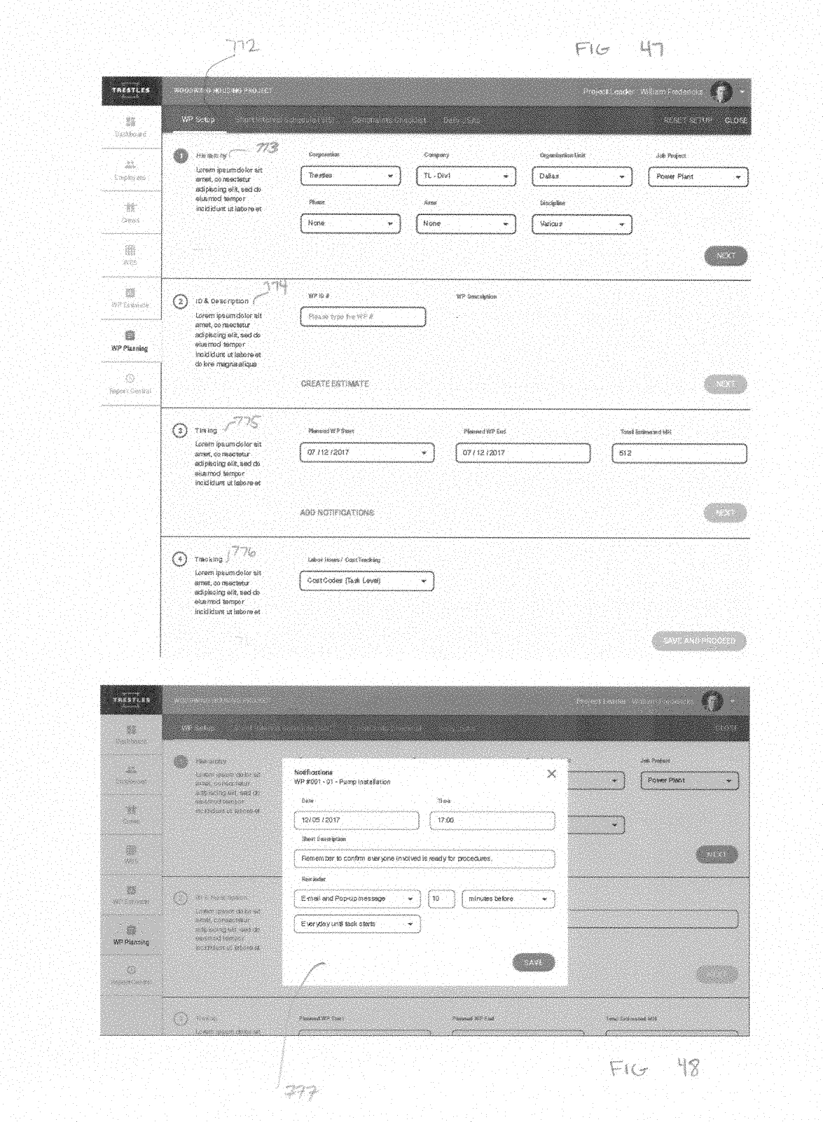

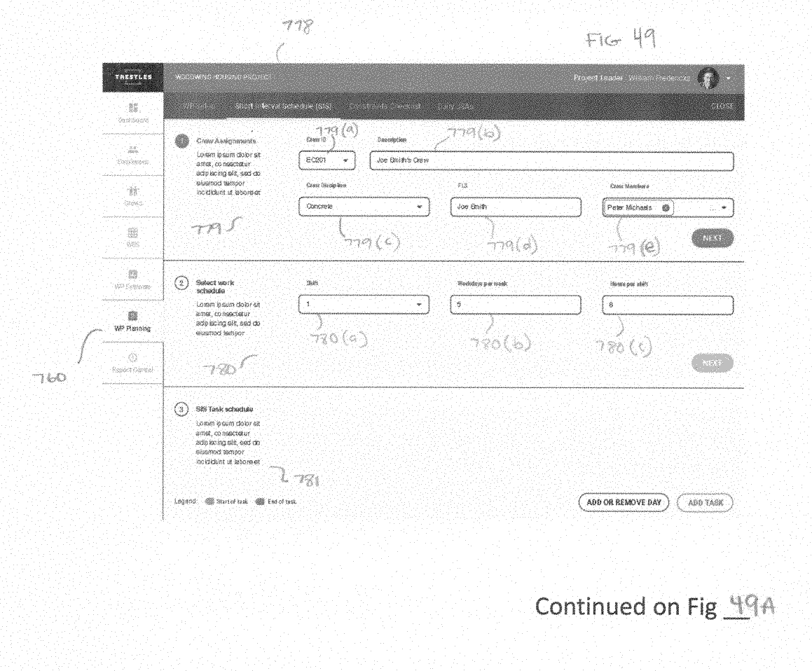

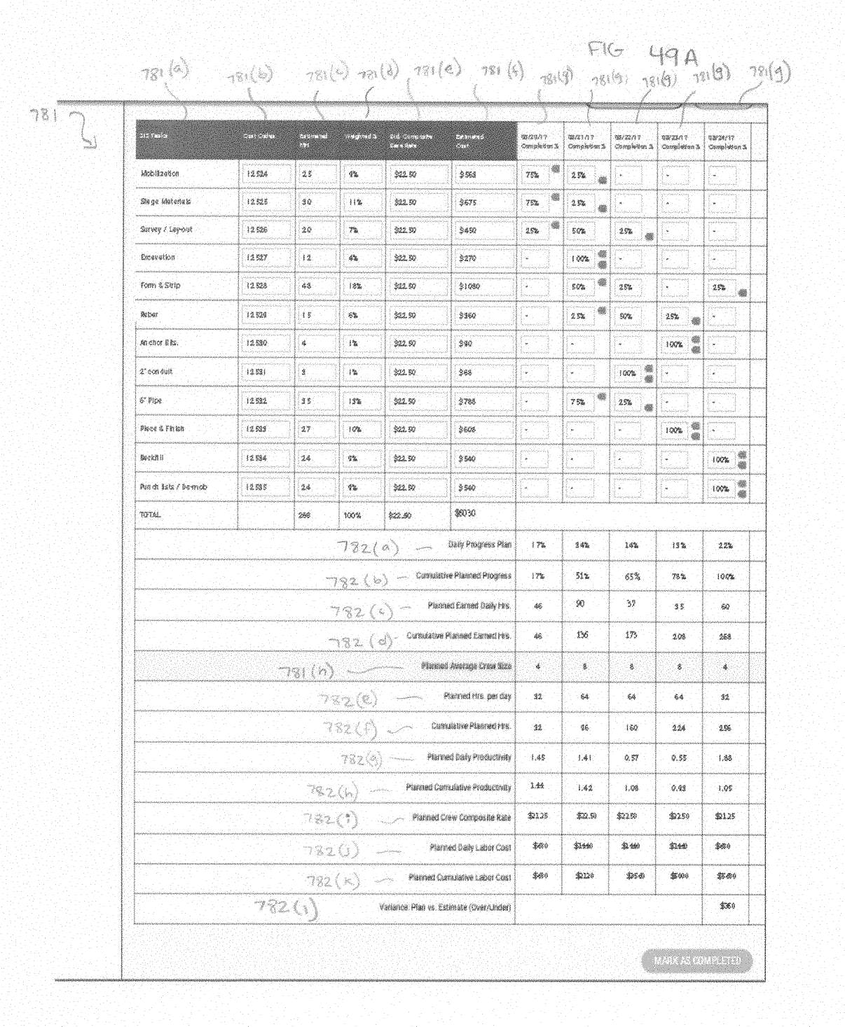

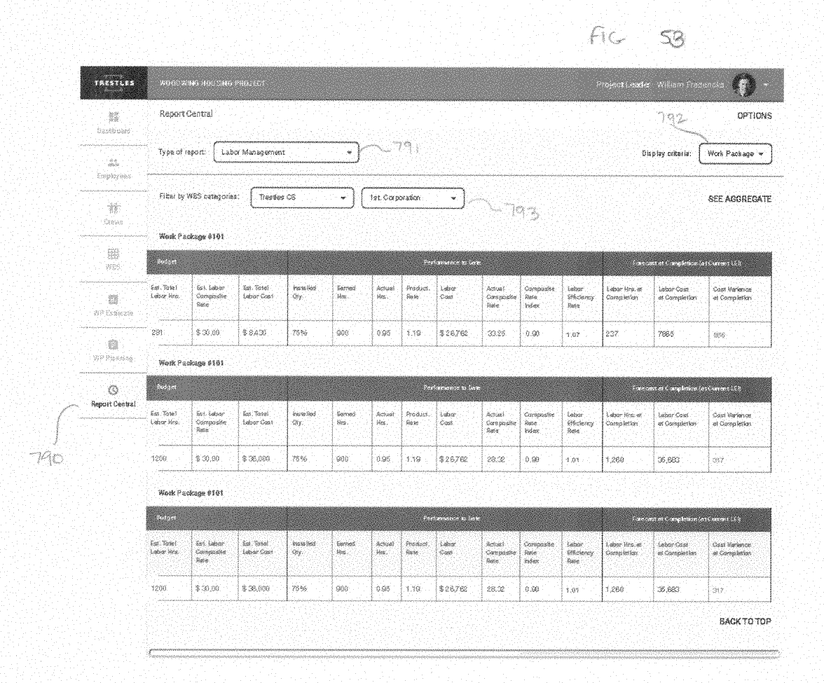

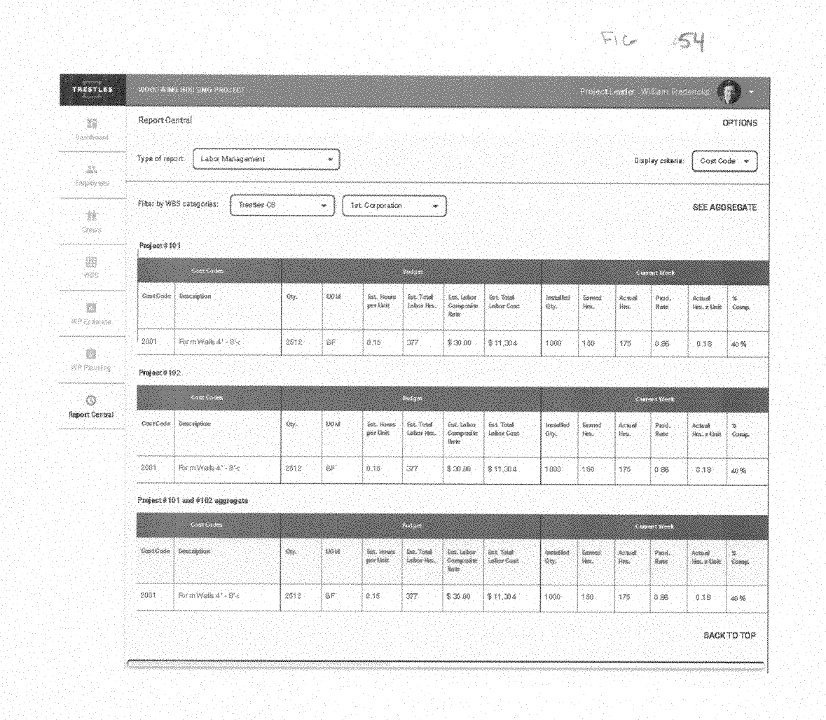

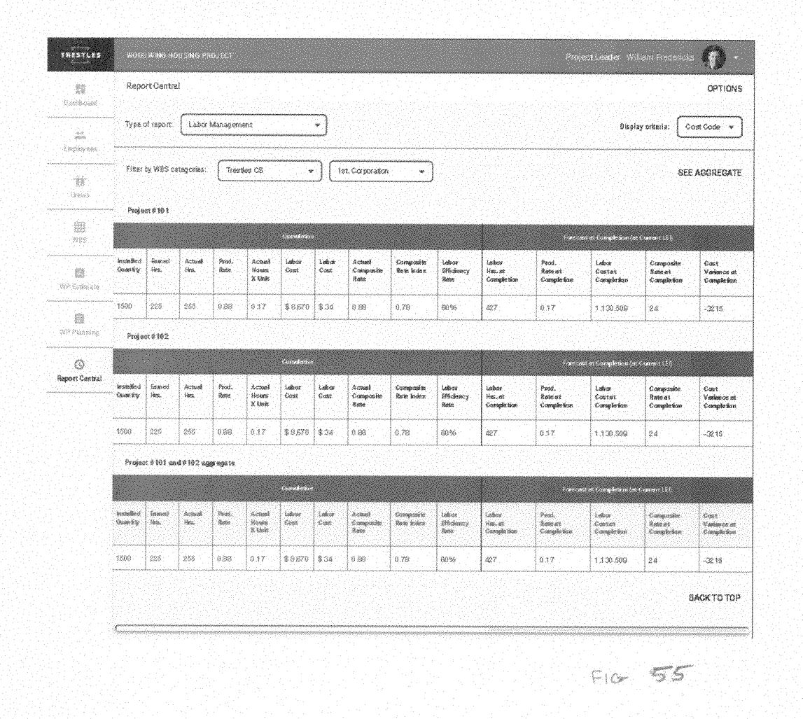

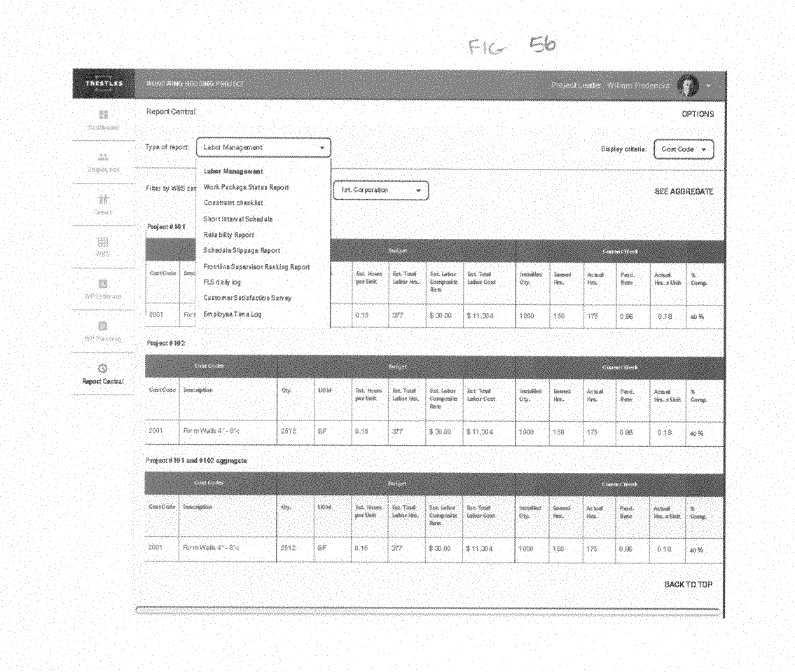

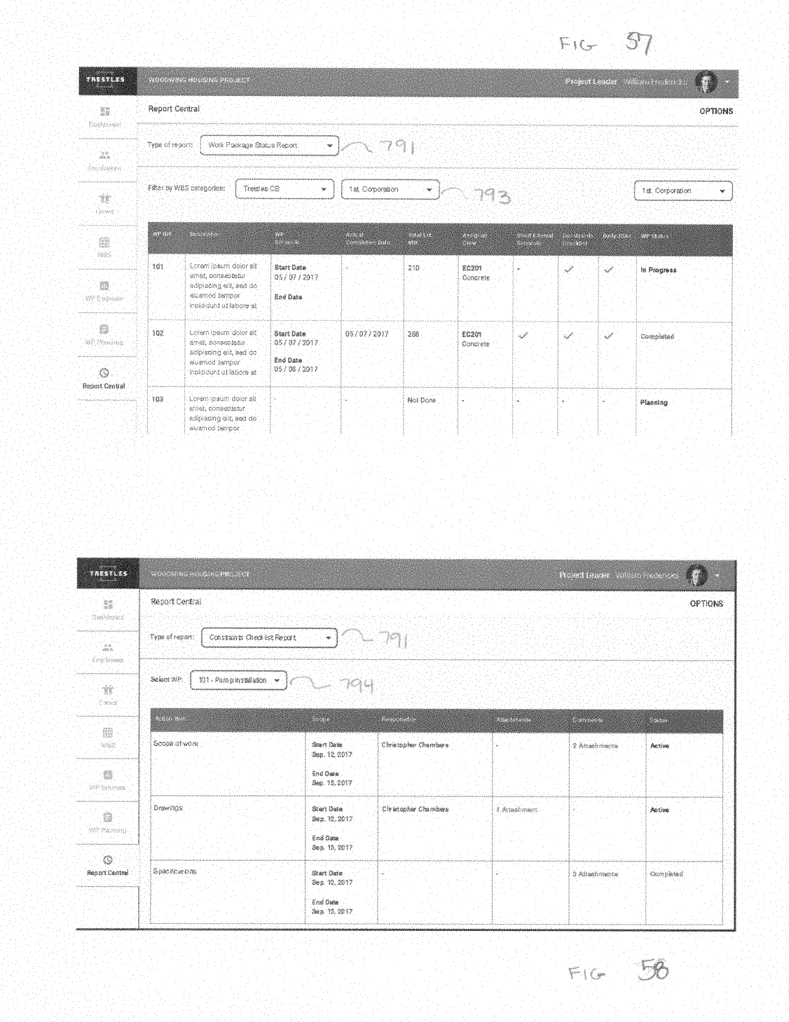

The reports shown in FIGS. 52 through 65 are illustrative of the detailed and diverse reports available because of the data inputs during the various stages of setup and configuration 100, project planning 200, and construction 300 by the frontline supervisor.

A high level company executive or project manager can evaluate an organizational unit, a project or a work package using the report central tab 790 and dashboard tab 710 of the back office system 20 and obtain substantial amounts of information about the planning and performance of an organization at levels of detail down to specific tasks. Moreover, such high level company executive or project manager can use these tools to evaluate the performance of frontline supervisors and quickly identify top performing frontline supervisors in the company, as well as frontline supervisors that require coaching or training.

Referring next to FIG. 66, a tablet view of the frontline system 80 shows login screen 801, requiring an email address 802 and a password 804 in order to sign in 806 thereby allowing access to the frontline system 80 of the TLMS system 10.

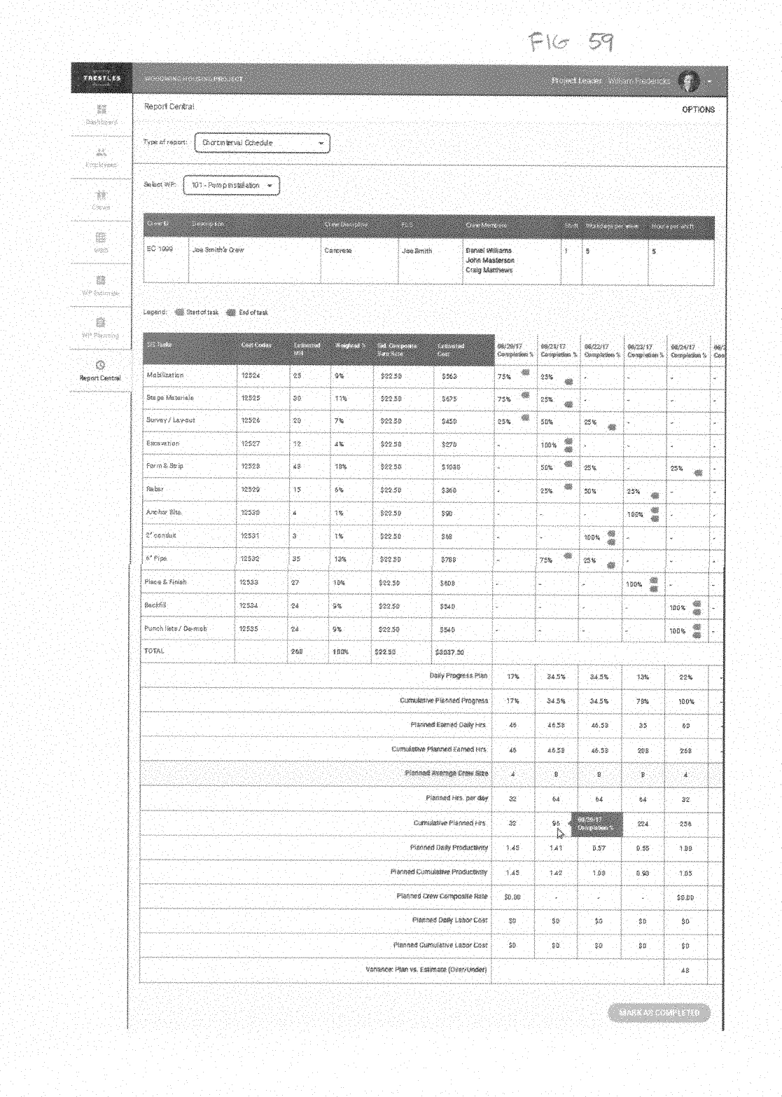

Referring next to FIG. 67, a tablet view of the frontline system 80 shows a work package list 808 thereby prompting the user, presumably a frontline supervisor, to select a specific work package 212 corresponding to the work package 212.

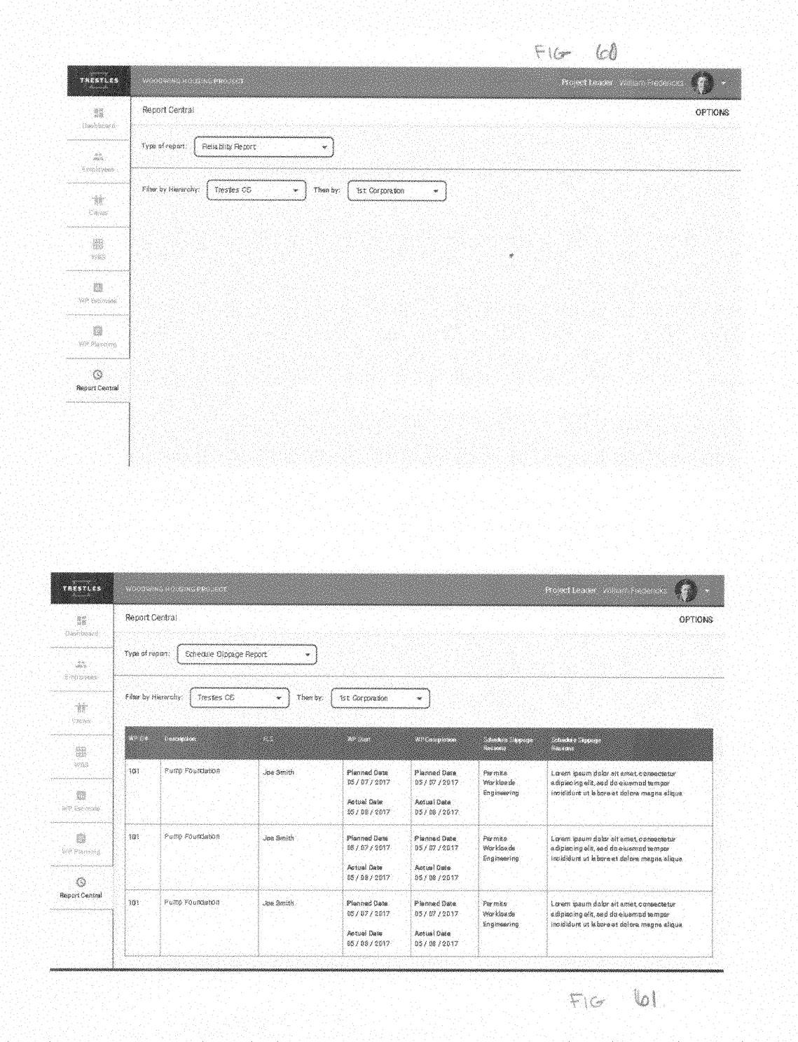

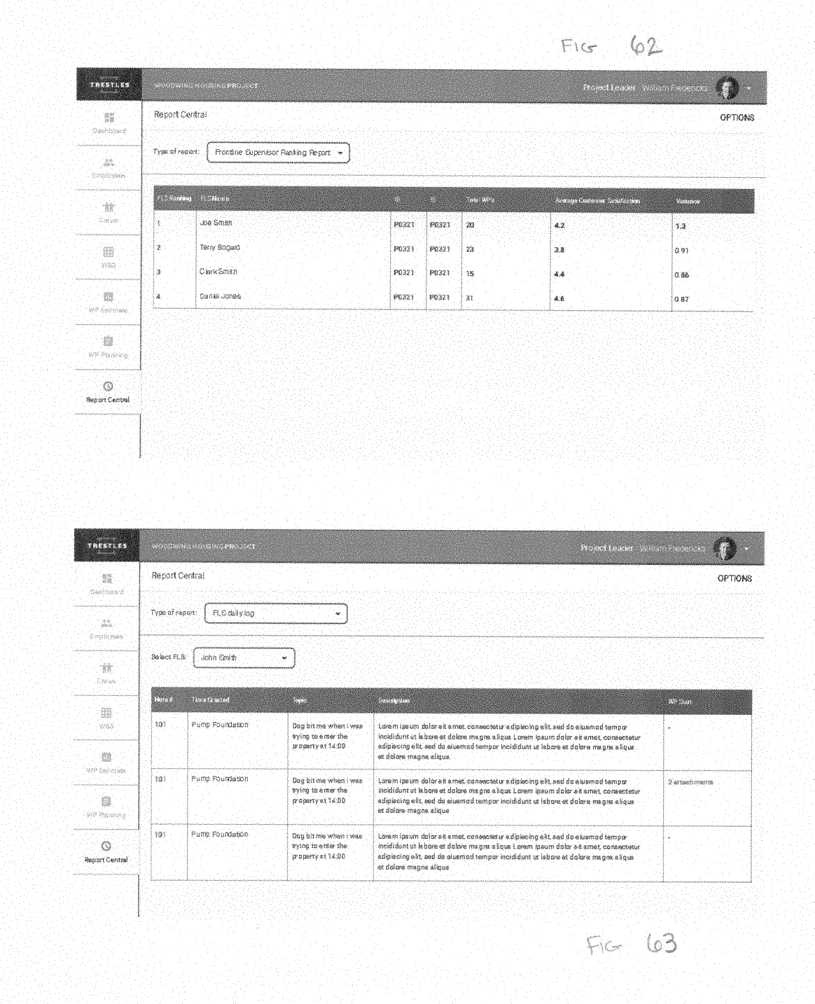

Referring next to FIGS. 68 and 69, a tablet view of the frontline system 80 shows the WP Progress tab 810 having been selected by the frontline supervisor by default from the frontline system 80 upon work package 212 selection by the frontline supervisor. The frontline system 80 enables the frontline supervisor to quickly and easily select different tabs to access different features of the frontline system 80, including the WP progress tab 810, the crew and JSA tab 830, the work package tab 840, the reporting tab 850, and the notes tab 860. No matter the tab selected, a top banner 807 appears with specific information pertaining to the selected work package 212, including project name and number, work package name and work package id number. Similarly, no matter the tab selected, also in the top banner 807 is a user button 809 that enables the user to access his or her profile as set forth more fully in connection with FIGS. 70-72 below.

The primary display on the graphical interface for the WP progress tab 810 is a dynamic user interface graphic 600. In FIG. 68, the dynamic user interface graphic 600 is a partially constructed pyramid. In FIG. 69, the dynamic user interface graphic 600 is a fully constructed dam. The graphical interface for the WP progress tab 810 includes a planned progress graphical display 814 and an actual progress graphical display 816. The planned progress graphic display 814 is based upon the progress planned completion for day derived by the TLMS system 10 from data inputted during the project planning phase 200. The actual progress graphic display 816 is based upon the actual progress completed progress derived by the TLMS system 10 from the frontline supervisor's inputs during the construction phase 300. The productivity index graphic display 818 is the productivity index 429 outputted from the TLMS system 10. The planned progress graphical display 814, the actual progress graphical display 816, and the productivity index graphic display 818 all are dynamic and adjust daily based upon the original project planning phase data 200 and progress and inputs by the frontline supervisor. The dynamic user interface graphic 600 is selected by the frontline supervisor prior to commencing construction of the specific work package 212.

Referring next to FIG. 70, a tablet view of the frontline system 80 shows user page 820 which is accessed by the user through selection of the user button 809 shown in FIG. 68. The graphical interface for the user page 820 includes the WP progress tab 810, the crew and JSA tab 830, the work package tab 840, the reporting tab 850, and the notes tab 860. In addition, the graphical interface for the user page 820 also includes a profile link 821, a help link 822, and a logout link 823.

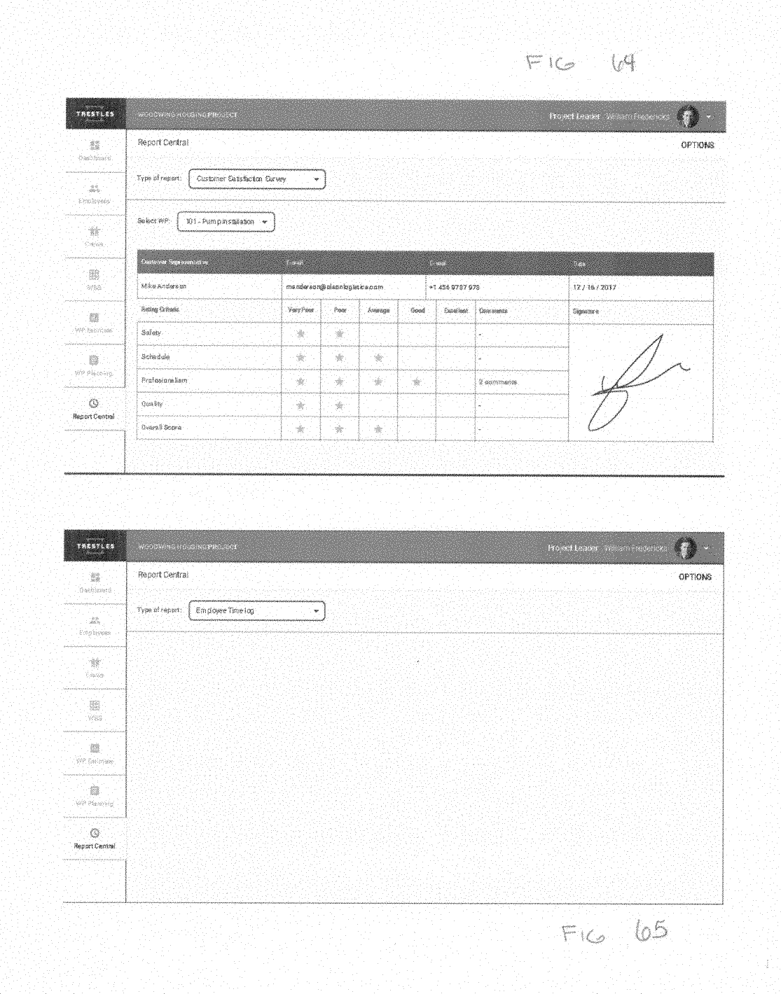

Referring next to FIG. 71, a tablet view of the frontline system 80 shows the profile page 824 resulting from the selection of profile 821 shown in FIG. 70. The graphical interface for the profile page 824 includes a user picture 824(a) and user information 824(b). User information 824(b) includes user email address, company, and the first and last of the user. The user information is populated by the TLMS system 10 based upon the login of the user and through access to the data for the unique employee record for the user. The user can switch from the profile page 824 by simply selecting the security page 825 on the graphical interface.

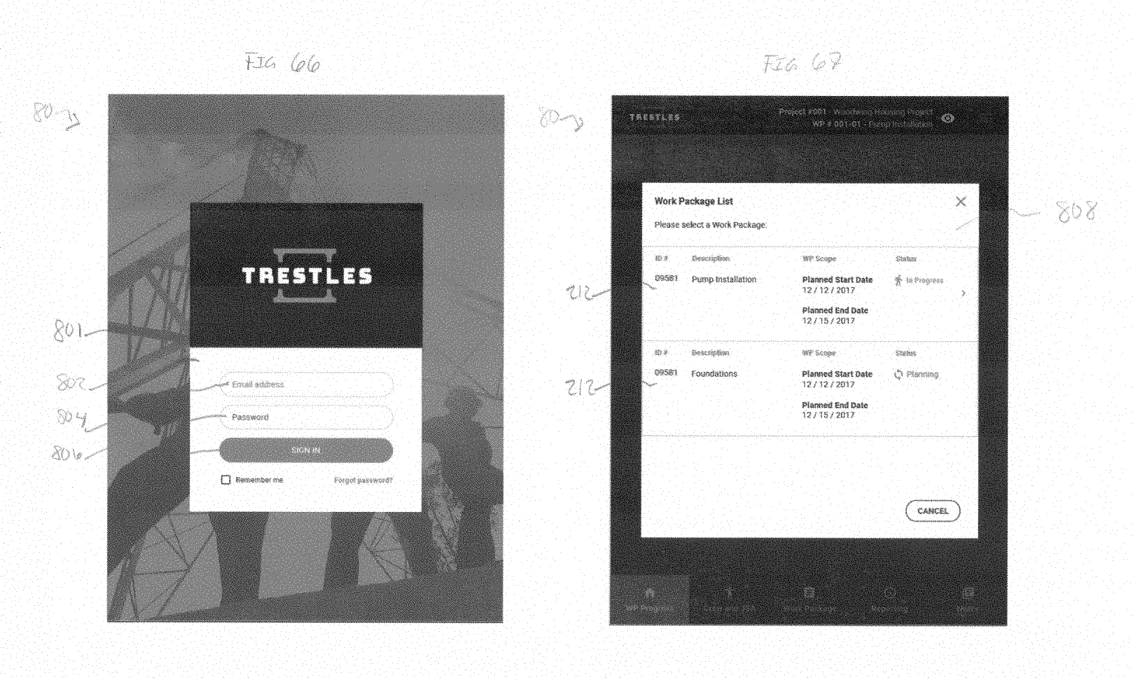

Referring next to FIG. 72, a tablet view of the frontline system 80 shows the security page 825. The graphical interface for the security page 825 includes user picture 824(a) as well as a change your password section 826. The change your password section 826 enables the user to change his or her password in the frontline system 80.

Referring next to FIG. 73, a tablet view of the frontline system 80 shows the crew and JSA tab 830 having been selected by the frontline supervisor. The crew and JSA tab 830 has a crew page 832, a job safety analysis page 834 and a JSA meeting attendance page 835 that are each selectable by the user. FIG. 72 shows the crew page 832 having been selected by the user. The graphical interface for the crew page 832 includes fields for crew member 832(a), classification 832(b), and a remove button 832(c). Any crew member listed on the crew page 832 who is not present in the field for a particular shift can simply be removed by the frontline supervisor user through the selection of the remove button 832(c). Any crew member present who was not planned but in fact who is performing work can be added to the crew page 832 through the selection of the add crew member button 832(d).

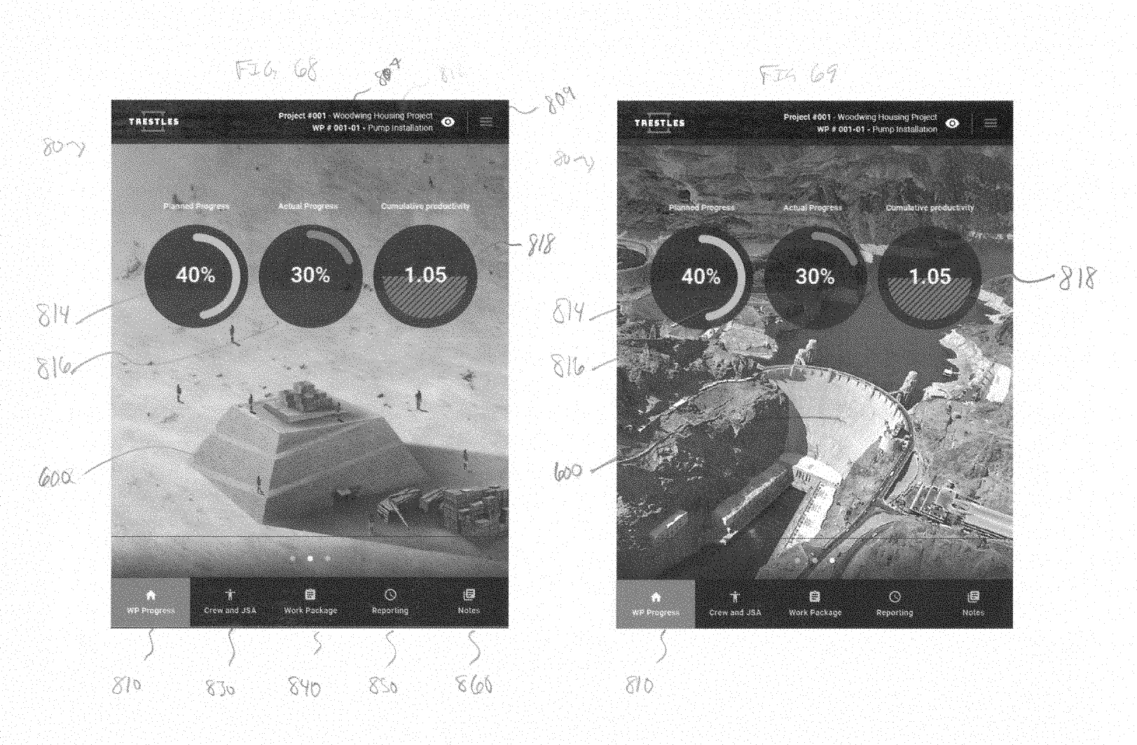

Referring next to FIG. 74, a tablet view of the frontline system 80 shows the job safety analysis page 834. The graphical interface for the job safety analysis page 834 includes a work package planned day number indicator 834(a), an activity steps field 834(b), an identified hazards field 834(c), a hazard mitigation field 834(d) and a responsible person field 834(e). The data for fields 834(a) through 834(e) are inputted during the creation of the JSA 250 during project planning 200. However, since projects do not always go as planned, the graphical interface for the job safety analysis page 834 includes a new JSA button 834(f) to enable to frontline supervisor to add additional job safety issues that were not planned.

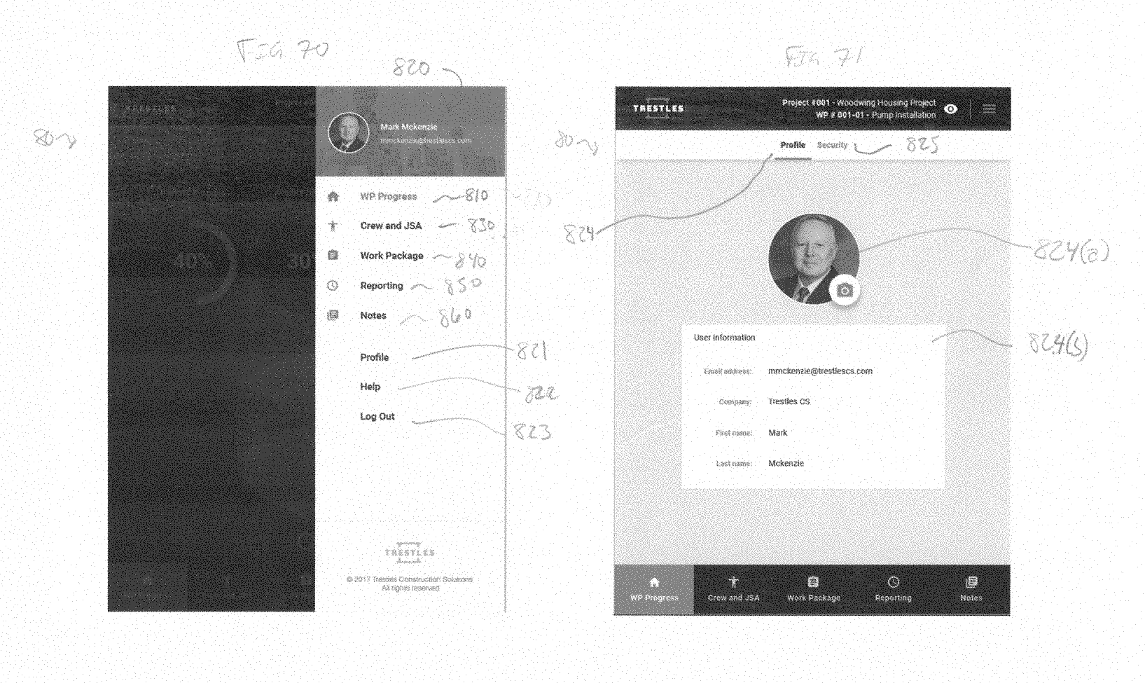

Referring next to FIG. 75, a tablet view of the frontline system 80 shows the JSA meeting attendance page 835. The graphical interface for the JSA meeting attendance page 835 includes data fields for safety meeting attendees 835(a), signature 835(b), pin# 835(c), and status 835(d). Upon the beginning of a shift, if required, the frontline supervisor conducts a job safety meeting and verifies attendance of each crew member at the job safety meeting either through obtaining the signature or pin number for each crew member. For each crew member present, whose attendance has not yet been verified in the frontline system 80, the frontline supervisor can optionally select either signature 835(b) or the pin# 835(c) for each crew member. FIG. 75 shows crew members Christopher Chambers and Michael Williams with a status 835(d) of “checked attended” with fields for signature 835(b) and pin# 835(c) disabled. FIG. 75 also shows crew member John Dotti with a status 835(d) of “unchecked attended.” The “unchecked attended” status prompts the frontline supervisor to seek either the signature 835(b) or pin number 835(c) from crew member John Dotti in order to verify his attendance at the job safety meeting provided John Dotti attended the job safety meeting.

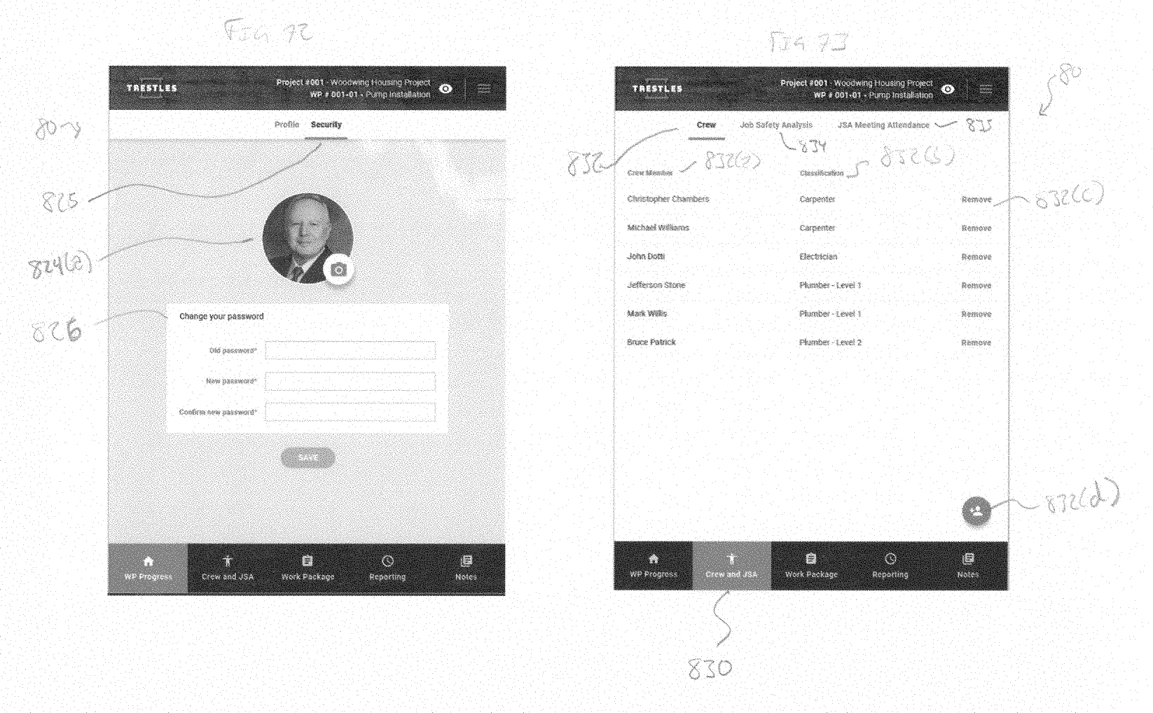

Referring next to FIG. 76, a tablet view of the frontline system 80 shows the signature interface 835(e) resulting from the selection of the signature 835(b) by the frontline supervisor for the crew member John Dotti. The frontline supervisor simply presents the tablet displaying the signature interface 835(e) to John Dotti and obtains the signature from John Dotti directly on the signature interface 835(e). The frontline supervisor then simply selects the save button 835(f) to save the signature in the TLMS system 10.

Referring next to FIG. 77, a tablet view of the frontline system 80 shows the status 835(d) of crew member John Dottie as “checked attended” with data fields for signature 835(b) and pin# 835(c) disabled.

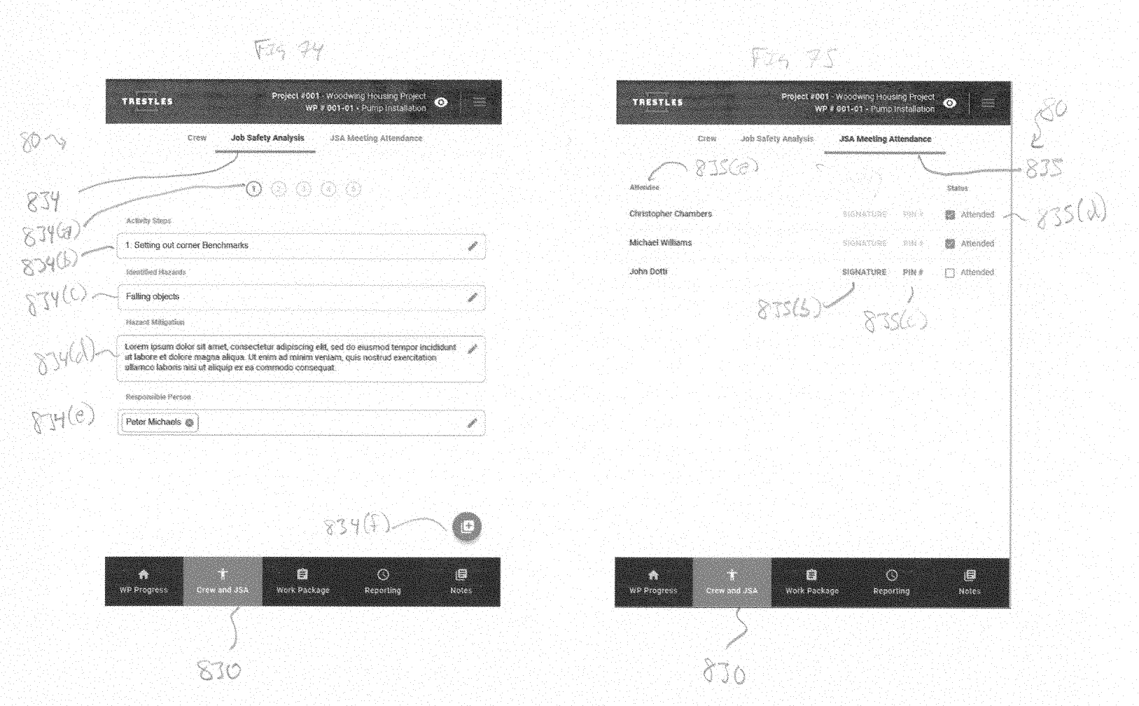

Referring next to FIG. 78, a tablet view of the frontline system 80 shows the pin# interface 835(g) resulting from the selection of the pin# 835(c) by the frontline supervisor for the crew member John Dotti as an alternative method of verifying job safety meeting attendance for crew member John Dotti. The frontline supervisor simply presents the tablet displaying the pin# interface 835(g) to John Dotti, who then in turn, simply inputs his unique company assigned pin number directly into the pin# interface 835(g). The frontline supervisor then simply selects the save button 835(h) to save the inputted pin number in the TLMS system 10.

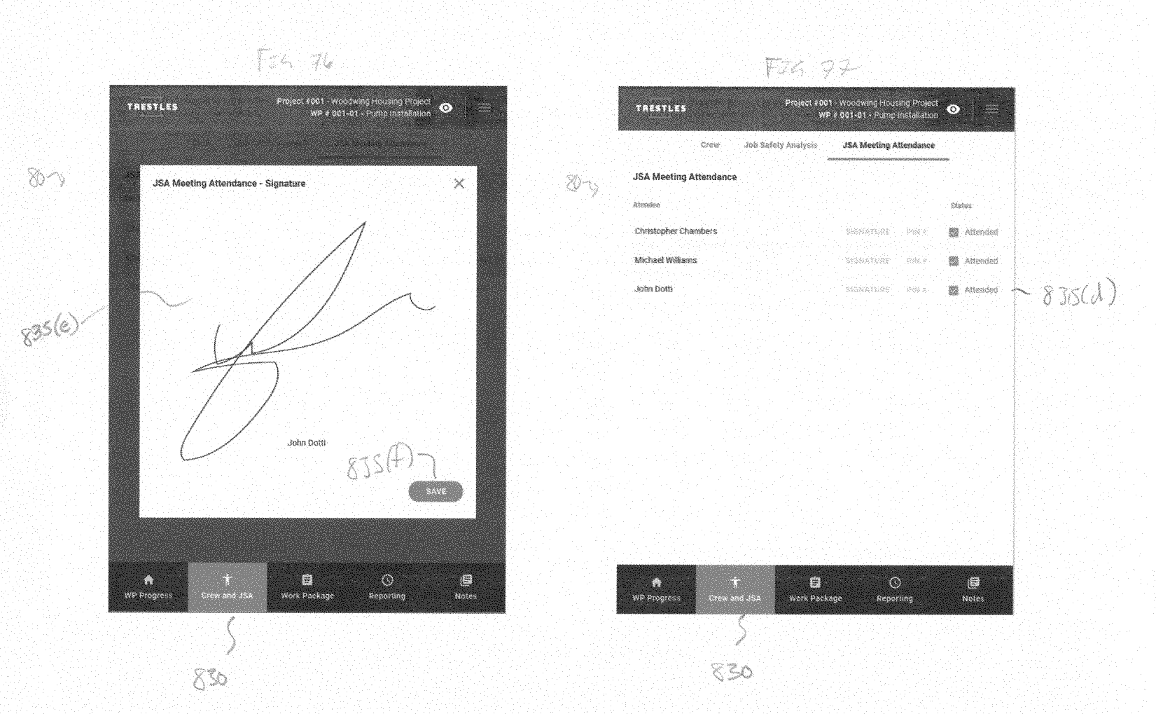

Referring next to FIG. 79, a tablet view of the frontline system 80 shows the Work Package tab 840 having been selected by the frontline supervisor. The work package tab 840 has a short interval schedule page 842 and a constraints checklist page 844 that are each selectable by the user. FIG. 79 shows the short interval schedule page 842 having been selected by the user. Regardless of whether the short interval schedule page 842 or the constraints checklist page 844 is selected by the user, work package planned banner 843 shows the planned start state and the planned end date for the selected work package. The graphical interface for the short interval schedule page 842 includes fields for cost code 842(a), task 842(b), scope 842(c), and crew members 842(d) in connection with each task 215 listed on the short interval schedule page 842. The data populating the cost code 842(a), task 842(b), scope 842(c), and crew members 842(d) fields was inputted during the project planning 200 and provides the frontline supervisor with key information relating to the tasks 215 planned for the particular shift, including a data field for total planned man hours 842(e).

Referring next to FIG. 80, a tablet view of the frontline system 80 shows the constraints checklist page 844 having been selected by the user. The graphical interface for the constraint checklist page 844 includes fields for action item 844(a), scope 844(b), attachments 844(c), and comments 844(d) in connection with all constraints/action items for a specific work package 212. The constraint description is listed in the action item 844(a) field. When an attachment is added to a particular constraint, an attachment button 844(f) is enabled allowing the user to select the attachment button 844(f) and view the attachment or attachments. Similarly, when a comment is added to a particular constraint item, a comment button 844(e) is enabled allowing the user to select the comment button 844(e) button and view the added comment. In the event a new constraint arises in connection with work package 212, a new constraint button 844(g) enables the frontline supervisor user to add a new constraint item.

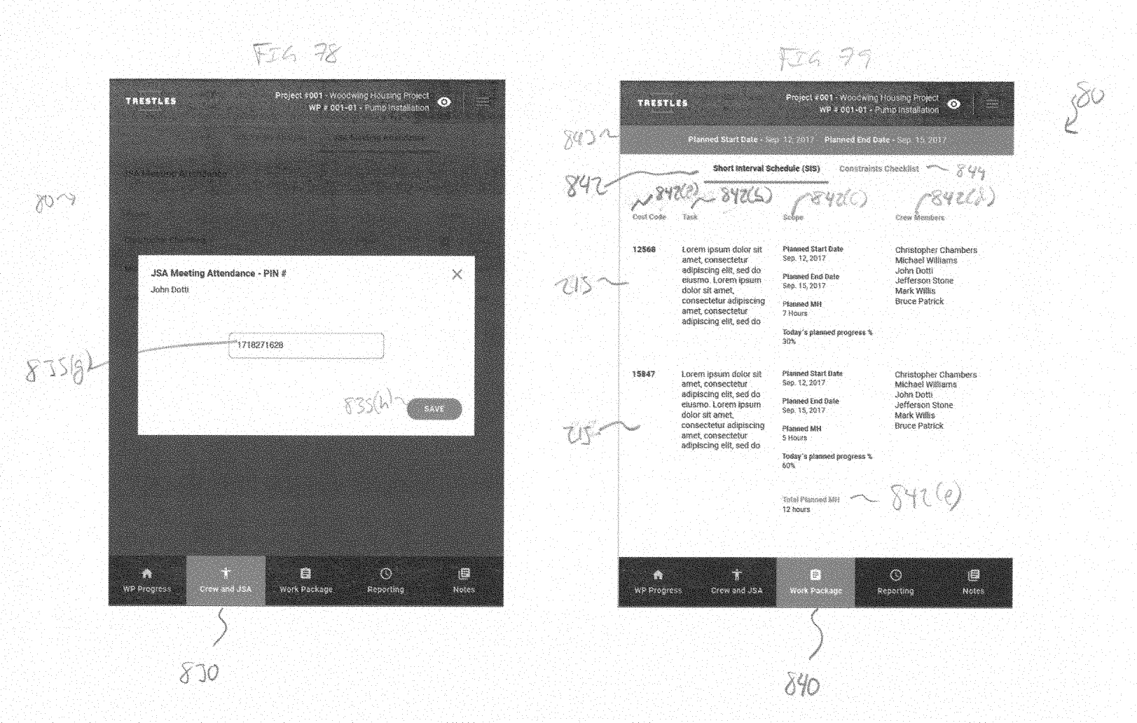

Referring next to FIG. 81, a tablet view of the frontline system 80 shows attachments 845(a), 845(b) and 845(c) for the constraint entitled “specifications” as shown in FIG. 80. When the frontline supervisor has completed his or her review of the attachments, the frontline supervisor simply selects the done button 846 to return to the constraint checklist page 844.

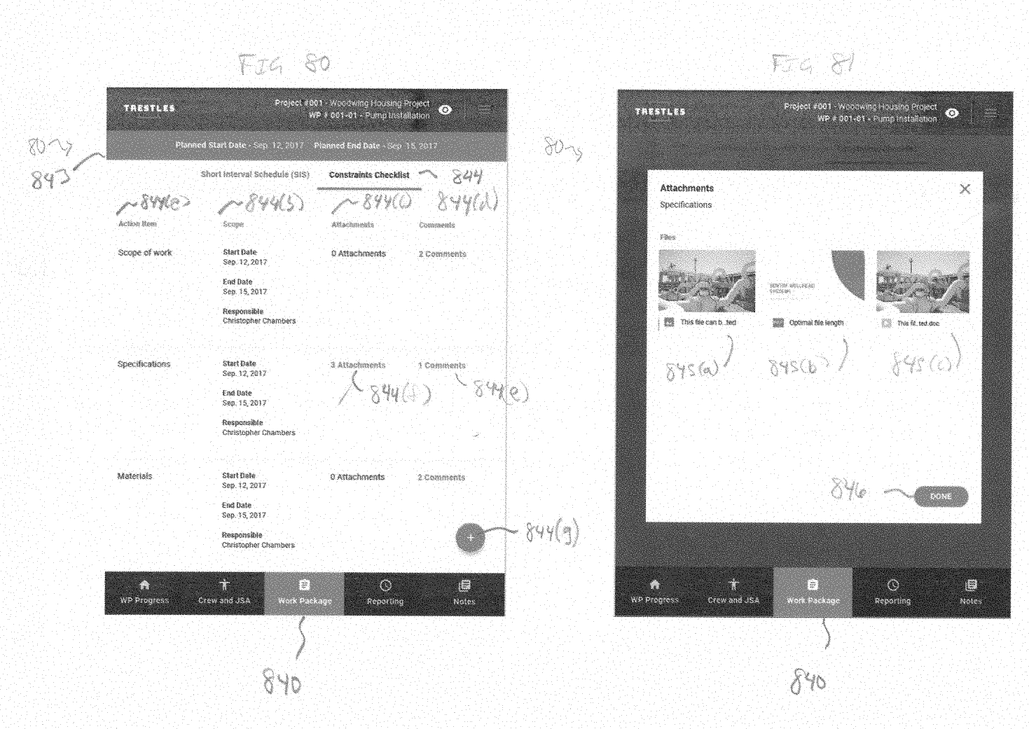

Referring next to FIG. 82, a tablet view of the frontline system 80 shows the reporting tab 850 having been selected by the frontline supervisor. The reporting tab 850 has a daily work time page 852, a daily progress record page 855, a reliability record page 856 and a client critique page 858. FIG. 82 shows the daily work time page 852 having been selected by the user. The graphical interface for the daily work time page 852 includes fields for crew member 852(a), classifications 852(b) and registered time 852(c). When registered time 852(c) has not been inputted for a particular crew member, the crew member name 852(d) is enabled to be selected by the user. Enablement can be graphically represented to the user through simple use of a different and easily discernable font color, such as red.

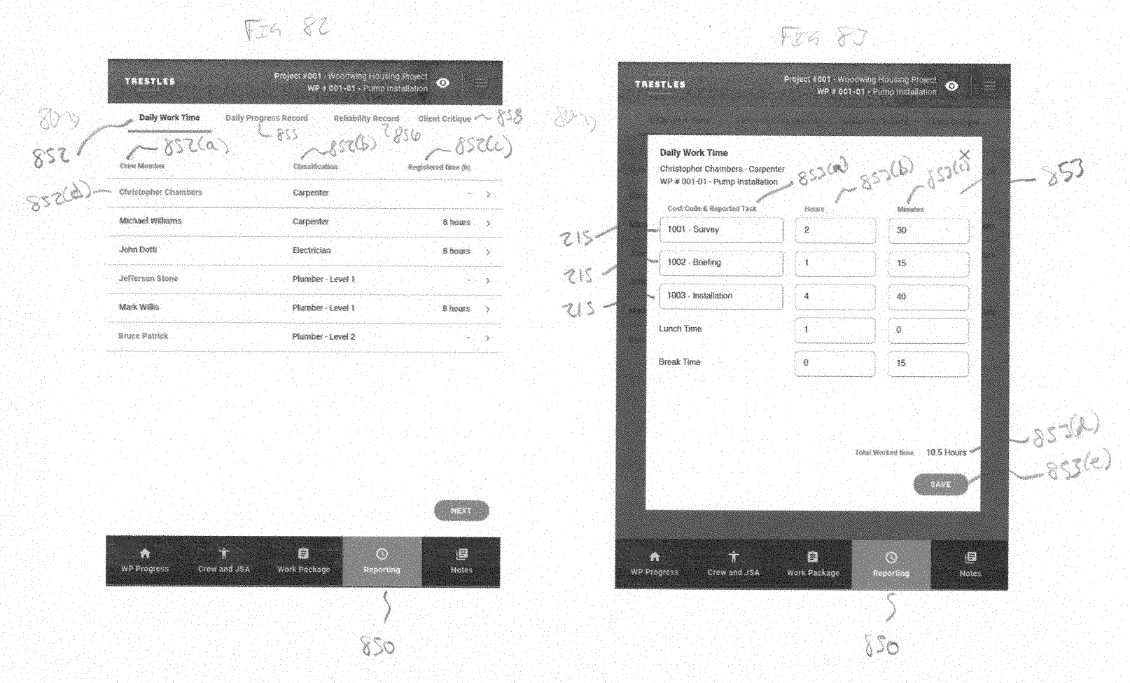

Referring next to FIG. 83, a tablet view of the frontline system 80 shows a daily work time interface 853 that was accessed by a frontline supervisor by selecting the enabled crew member name 852(d) for the crew member Christopher Chambers shown on the daily work time page 852 in FIG. 82. The work time interface 853 has data fields for cost code and reported task 853(a), hours 853(b) and minutes 853(c) for each of the scheduled tasks 215 planned for the shift. The frontline supervisor simply inputs the time spent on each task 215 by the crew member in data fields 853(b) and 853(c). The frontline supervisor may also enter time for lunch and breaks in the daily work time interface 853. After entering the time spent on each task, lunch and break, the frontline system 80 calculates and populates the total worked hours 853(d). The frontline supervisor then simply selects the save button 853(e) and the frontline system 80 will load the inputted data into the TLMS system 10, for use in the back office system 20 as well as for use in the frontline system 80.

Referring next to FIG. 84, a tablet view of the frontline system 80 shows an alternative daily work time interface 854 that was accessed by a frontline supervisor by selecting the enabled crew member name 852(d) for the crew member Christopher Chambers shown on the daily work time page 852 in FIG. 82. The alternative daily work time interface 854 is not broken down per task 215, but simply has data fields for hours 854(a) and minutes 854(b) for total worked time, lunch time and break time. Upon completion of entering time, the frontline supervisor simply selects the save button 854(c).

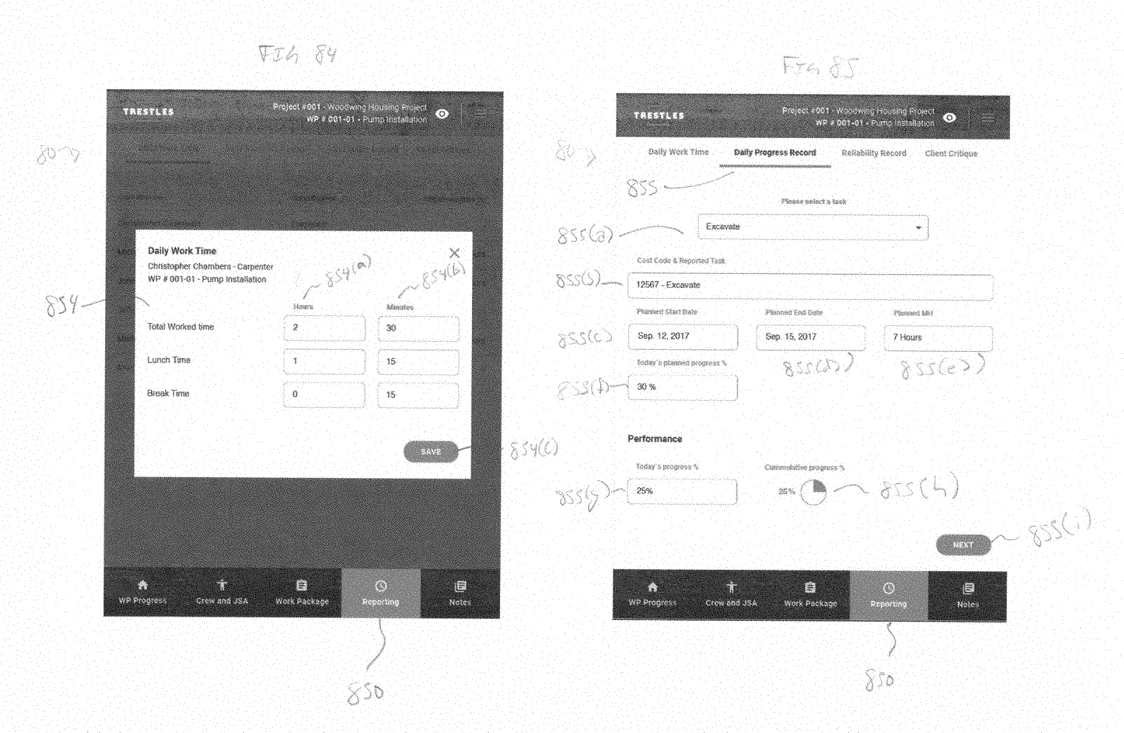

Referring next to FIG. 85, a tablet view of the frontline system 80 shows the daily progress record page 855 having been selected by the user. The graphical interface for the daily progress record page 855 includes fields for task selection 855(a), cost code 855(b), planned start date 855(c), planned end date 855(d), planned man hours 855(e), today's planned progress % 855(f), today's progress 855(g) and cumulative progress 855(h). The frontline supervisor selects a specific task from the 855(a) field. Once selected, pertinent data for that selected task populates fields 855(b), 855(c), 855(d), 855(e), and 855(f) from inputs made for the specific task in the back office system 20 during the project planning 200. These data fields provide an immediate reference to the frontline supervisor as to the details planned for the specific task. The frontline supervisor is required to provided estimated percentage completion on a per task basis per shift and inputs that estimated percentage completion in the today's progress 855(g) data field. The frontline system 80 automatically calculates the cumulative progress for the task and displays the cumulative progress percentage in the cumulative progress 855(f). Upon completion of the input, the frontline supervisor simply selects the next button 855(i) which will save the inputs and direct the frontline supervisor to the next task requiring inputs. The process is repeated until the requisite inputs are performed for each task 215.

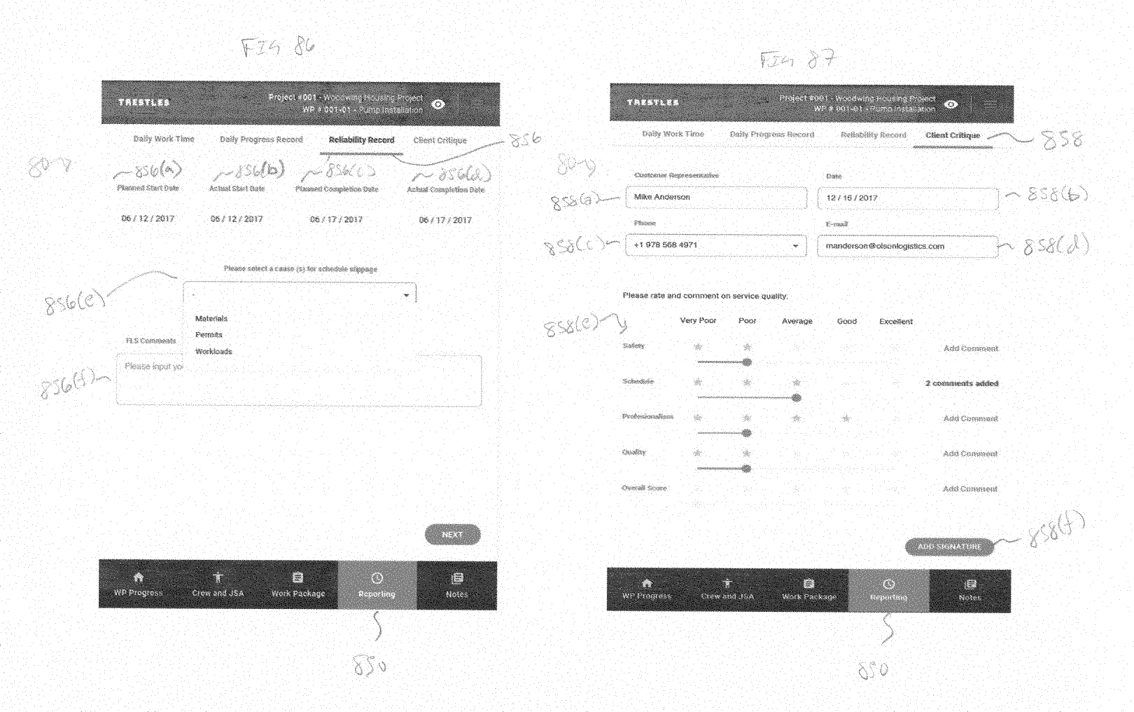

Referring next to FIG. 86, a tablet view of the frontline system 80 shows the reliability record page 856 having been selected by the user. The reliability record page 856 may optionally be enabled upon completion of all tasks 215 in a work package 212. The graphical interface for the reliability record page 856 has data fields for planned start date 856(a), actual start date 856(b), planned completion date 856(c) and actual completion date 856(d), schedule slippage 856(e), and frontline supervisor comments 856(f). The data populated in the planned start date 856(a) and planned completion date 856(c) is sourced from the back office system 20 where it was inputted during project planning 200. The data populated in the actual start date 856(b) and actual end date 856(d) is sourced from the inputs from the frontline supervisor during use of the frontline system 80. In the event that that the work package was not completed as planned, the schedule slippage 856(e) data field is enabled allowing the frontline supervisor to select one or more of the causes of the schedule slippage listed in the schedule slippage 856(e) data field. The schedule slippage reasons list was created in the back office system 20 during the setup and configuration process 100. The frontline supervisor also may input specific comments relating to the work package 212 in the frontline supervisor comments 856(f) data field.

Referring next to FIG. 87, a tablet view of the frontline system 80 shows the client critique page 858 having been selected by the user. The client critique page 858 may optionally be enabled upon completion of all tasks 215 in a work package 212. The graphical interface for the client critique page 858 has data fields for customer representative 858(a), date 858(b), phone 858(c), email 858(d) and client critique interface 858(e). Upon completion of a work package 212, the frontline supervisor simply selects the client critique page 858 and inputs the customer representative information for fields 858(a), 858(b), 858(c) and 858(d) and then simply provides the tablet to the customer representative so that he or she may fill out the client critique interface 858(e). The customer representative, after completing the inputs required in the client critique interface 858(e) simply selects the add signature button 858(f).

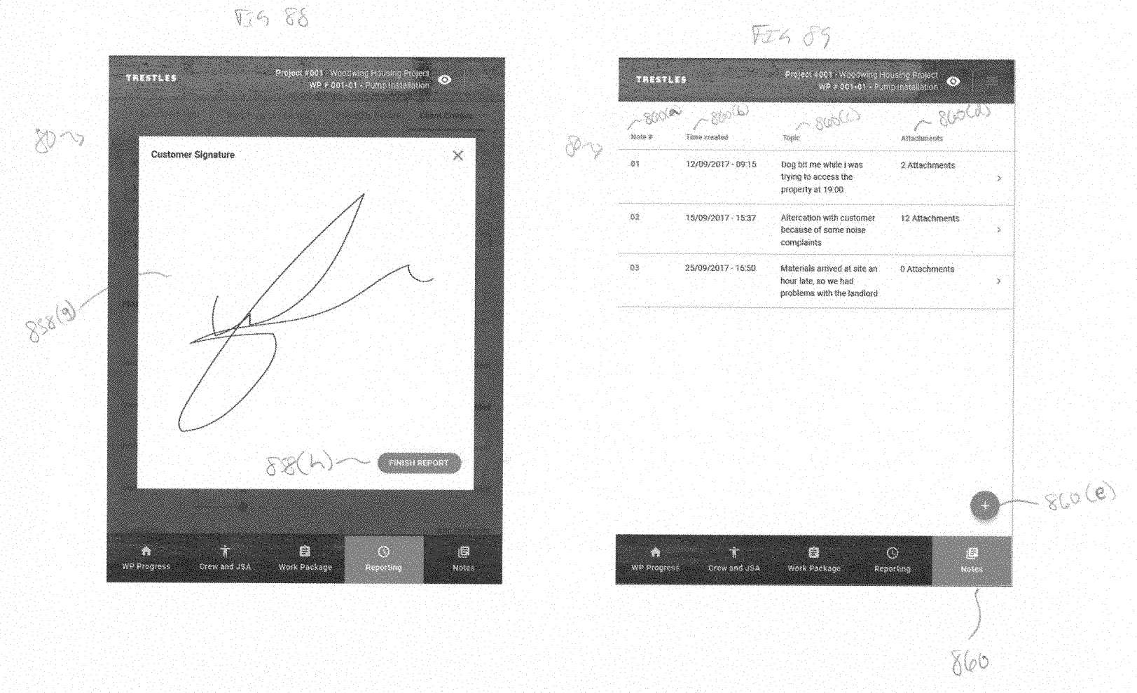

Referring next to FIG. 88, a tablet view of the frontline system 80 shows the customer signature field 858(g) resulting from the selection of the add signature button 858(f) shown in FIG. 87. Upon receipt of the signature from the customer representative on the customer signature field 858(g), the frontline supervisor simply selects the finish report button 858(h), which saves the data inputs on FIGS. 87 and 88 to the TLMS system 10 for use in the back office system 20.

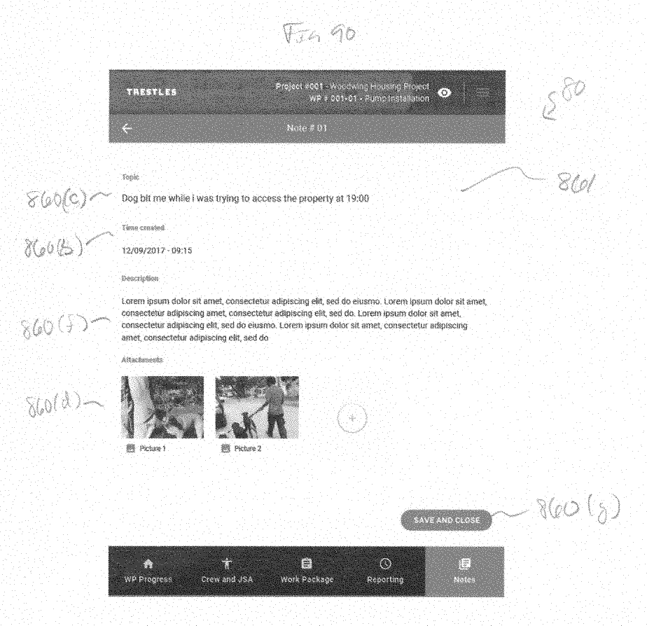

Referring next to FIG. 89, a tablet view of the frontline system 80 shows the notes tab 860 having been selected by the frontline supervisor. The graphical interface for the Notes tab 860 includes fields note # 860(a), time created 860(b), topic 860(c), and attachments 860(d). To create a note at any time during construction of a work package 212, a frontline supervisor simply selects the new note button 860(e).

Referring next to FIG. 90, a tablet view of the frontline system 80 shows notes interface 861 resulting from the selection of the new note button 860(e) shown in FIG. 89. The notes interface 861 allows the frontline supervisor to input data for data fields 860(b), 860(c), 860(d) as well as input a more detailed description in a description 860(f) data field. Once the frontline supervisor is done imputing information in the notes interface 861 he or she simply selects the save and close button 860(g).

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

While there have been shown what are presently considered to be preferred embodiments of the present invention, it will be apparent to those skilled in the art that various changes and modifications can be made herein without departing from the scope and spirit of the invention. Accordingly, the invention is not to be limited as except by the appended claims.

I claim:

1. A construction labor management system, comprising:
a frontline system configured for use by frontline supervisor users in the field during actual project construction;
a central computer system in digital communication with said frontline system;
a back office system in communication with said frontline system and said central computer system, and divided into setup and configuration and project planning;
a user interface within said back office system configured to facilitate creation and setup of a work breakdown structure (WBS) in the system that is specific to the administrator users, project planner users, and project manager users;
a data structure in said central computer system configured to include data corresponding to a plurality of work packages wherein each said work package is further divided into a the lowest level segmentations in the work breakdown structure;
a means for updating said data in said data structure corresponding to progress of completion of said work packages; and
a means for communicating said updated data from said data structure to said frontline supervisor, said administrator users, said project planner users, and said project manager users.
